(19) United States
(12) Patent Application Publication
(10) Pub. No.: US 2026/0148071 A1
(43) Pub. Date: May 28, 2026

(54) SYSTEMS AND METHODS FOR GENERATING ARTIFICIAL INTELLIGENCE (AI) MODELS USING EVOLUTIONARY ALGORITHMS TO SYNTHESIZE AI MODEL ARCHITECTURES

(71) Applicant: Liquid AI, Inc., Cambridge, MA (US)

(72) Inventors: Rom PARNICHKUN, Cambridge, MA (US); Alexander Andre AMINI, Cambridge, MA (US); Armin Wolfram THOMAS, Berlin (DE); Stefano MASSAROLI, Tokyo (JP); Michael POLI, Millbrae, CA (US)

(73) Assignee: Liquid AI, Inc., Cambridge, MA (US)

(21) Appl. No.: 19/275,504

(22) Filed: Jul. 21, 2025

Related U.S. Application Data
(60) Provisional application No. 63/725,878, filed on Nov. 27, 2024.

(51) Int. Cl. G06N 3/086

(52) U.S. Cl. CPC G06N 3/086

(57) ABSTRACT

A method for generating artificial intelligence (AI) models comprises receiving a plurality of AI models, encoding the AI models to generate a population of respective encoded hierarchical numerical representations that each encode computational units of the respective AI model as linear input-varying systems (LIVs) across a backbone, operator structure, and featurization hierarchical level, scoring each of the plurality of AI models to generate one or more respective score metrics, selecting a plurality of pairs of AI models from the received AI models based at least in part on the score metrics, for each pair, generating a respective offspring encoded hierarchical numerical representation, by combining numerical information from the encoded hierarchical numerical representations for each AI model in the respective pair, and for one or more of the offspring encoded hierarchical numerical representations, generating a respective offspring AI model based on the offspring encoded hierarchical numerical representation.

### CROSS-REFERENCE TO RELATED APPLICATIONS

This application claims the benefit of U.S. Provisional Application No. 63/725,878 filed Nov. 27, 2024, the entire contents of which are incorporated herein by reference.

### FIELD

This application relates generally to artificial intelligence (AI) models, and more specifically to systems and methods for generating AI models using evolutionary algorithms to synthesize model architectures.

### BACKGROUND

Most domains of applications for AI have seen a gradual convergence towards similar model architecture designs, based on stacking multi-head attention and gated linear units (Transformers) (Vaswani et al., 2017; Shazeer, 2020; Brown, 2020) or combinations of other basic computational units grounded in signal processing, such as recurrences or convolutions (Martin & Cundy, 2017; Romero et al., 2021; Gu et al., 2022; Smith et al., 2023; Peng et al., 2023; Poli et al., 2023; Massaroli et al., 2023; Yang et al., 2024b).

### SUMMARY

Iterative improvement of model architectures is fundamental to deep learning: Transformers first enabled scaling, and recent advances in model hybridization have pushed the quality-efficiency frontier. However, optimizing architectures remains challenging and expensive. Current automated or manual approaches fall short, largely due to limited progress in the design of search spaces and due to the simplicity of resulting patterns and heuristics. In this work, we propose a new approach for generating AI models using evolutionary algorithm techniques to synthesize model architectures. Our approach combines a novel search space based on the theory of linear input-varying systems, supporting a hierarchical numerical encoding into architecture genomes. Architecture genomes are automatically refined and recombined with gradient-free, evolutionary algorithms to optimize for multiple model quality and efficiency metrics. Using the evolutionary algorithm techniques described herein, we optimize large populations of new architectures, leveraging diverse computational units and interconnection patterns, improving over highly-optimized Transformers and striped hybrid models on the frontier of quality, parameter size, and inference cache for autoregressive language modeling.

According to some embodiments, a method for generating artificial intelligence (AI) models is provided, the method is performed by a system comprising one or more processors and memory storing instructions comprising instructions for performing the method, the method comprising receiving a plurality of AI models, encoding the plurality of AI models to generate a population of respective encoded hierarchical numerical representations of the AI models, wherein each of the plurality of respective encoded hierarchical numerical representations encodes computational units of the respective AI model as linear input-varying systems (LIVs) across a backbone hierarchical level, an operator structure hierarchical level, and a featurization hierarchical level, scoring each of the plurality of AI models to generate one or more respective score metrics for each of the plurality of AI models, selecting a plurality of pairs of AI models from the received plurality of AI models, wherein the selection is based at least in part on the score metrics, for each pair of the plurality of selected pairs of AI models, generating a respective offspring encoded hierarchical numerical representation, by combining numerical information from the encoded hierarchical numerical representations for each AI model in the respective pair, and for one or more of the offspring encoded hierarchical numerical representations, generating a respective offspring AI model based on the offspring encoded hierarchical numerical representation.

In any of these embodiments, wherein, for each AI model in the plurality of AI models the backbone hierarchical level of the respective hierarchical numerical representation comprises a numerical string that encodes characteristics of a backbone of the AI model, the operator structure hierarchical level of the respective hierarchical numerical representation comprises a numerical string that encodes characteristics of one or more operators of the AI model, and the featurization hierarchical level of the respective hierarchical numerical representation comprises a numerical string that encode characteristics of one or more featurizers of the AI model.

In any of these embodiments, wherein some or all of the numerical string of the operator structure hierarchical level corresponds to a single number in the numerical string of the backbone hierarchical level.

In any of these embodiments, wherein some or all of the numerical string of the featurization hierarchical level corresponds to a single number in the numerical string of the operator structure hierarchical level.

In any of these embodiments, wherein the numerical string of the backbone hierarchical level comprises at least one sequence of numbers, wherein the sequence corresponds to an LIV of the backbone of the AI model.

In any of these embodiments, wherein the backbone hierarchical level comprises one or more numerical sequences that encode information about the AI model using at a first position, an integer value representing LIV class information, at a second position, an integer value representing featurizer sharing information, at a third position, an integer value representing a featurizer sharing strategy, at a fourth position, an integer value representing feature group sharing information, and at a fifth position, an integer value representing a feature group sharing strategy.

In any of these embodiments, wherein the operator structure hierarchical level comprises one or more numerical sequences that encode characteristic of an operator of the one or more operators using at a first position, an integer value representing a featurizer class, at a second position, an integer value representing a linear token mixing structure, at a third position, an integer value representing structured sparsity mask information, at a fourth position, an integer value representing optional nonlinearity applied during linear token mixing, and at a fifth position, an integer value representing a channel mixing structure.

In any of these embodiments, wherein the featurizer hierarchical level comprises one or more numerical sequences that encode information about a featurizer of the one or more featurizers using at a first position, an integer value representing a linear token mixing structure, at a second position, an integer value representing structured sparsity mask information, at a third position, an integer value representing optional nonlinearity applied during linear token mixing, at a fourth position, an integer value representing a channel mixing structure, at a fifth position, an integer value representing expansion factor of the feature group channel dimension over the input channel dimension, and at a sixth position, an integer value representing a repeat factor for how many times the feature groups are replicated across the channel dimension.

In any of these embodiments, wherein the one or more score metrics comprise a total number of trainable parameters and/or a cache size.

In any of these embodiments, wherein selecting the plurality of pairs of AI models from the received plurality of AI models comprises executing a tournament selection process.

In any of these embodiments, wherein combining numerical information from encoded hierarchical numerical representations for each AI model in a pair of the selected pairs comprises applying k-point crossover to the encoded hierarchical numerical representations for each AI model in the pair.

In any of these embodiments, the method further comprising, for one or more of the offspring encoded hierarchical numerical representations, mutating at least a portion of the respective offspring encoded hierarchical numerical representation, before generating the respective offspring AI model.

In any of these embodiments, wherein the mutating comprises replacing at least one number of the respective offspring encoded hierarchical numerical representation with a number selected from a set of predefined numbers.

In any of these embodiments, wherein the set of predefined numbers corresponds to a position of the at least one number within the respective offspring encoded hierarchical numerical representation.

In any of these embodiments, the method further comprising detecting an invalid offspring encoded hierarchical numerical representation and repairing the invalid offspring encoded hierarchical numerical representation.

In any of these embodiments, wherein repairing the invalid offspring encoded hierarchical numerical representation comprises re-sampling from a set of predefined numbers to change a number in the encoded hierarchical numerical representation.

In any of these embodiments, wherein the invalid offspring encoded hierarchical numerical representation was generated by combining numerical information from the encoded hierarchical numerical representations for each AI model in the respective pair

In any of these embodiments, wherein the invalid offspring encoded hierarchical numerical representation was generated by mutating at least a portion of the respective offspring encoded hierarchical numerical representation.

According to some embodiments, a system for generating artificial intelligence (AI) models is provided, the system comprising one or more processors and memory storing instructions comprising instructions which, when executed by the one or more processors of the system, cause the system to receive a plurality of AI models, encode the plurality of AI models to generate a population of respective encoded hierarchical numerical representations of the AI models, wherein each of the plurality of respective encoded hierarchical numerical representations encodes computational units of the respective AI model as linear input-varying systems (LIVs) across a backbone hierarchical level, an operator structure hierarchical level, and a featurization hierarchical level, score each of the plurality of AI models to generate one or more respective score metrics for each of the plurality of AI models, select a plurality of pairs of AI models from the received plurality of AI models, wherein the selection is based at least in part on the score metrics, for each pair of the plurality of selected pairs of AI models, generate a respective offspring encoded hierarchical numerical representation, by combining numerical information from the encoded hierarchical numerical representations for each AI model in the respective pair, and for one or more of the offspring encoded hierarchical numerical representations, generate a respective offspring AI model based on the offspring encoded hierarchical numerical representation.

According to some embodiments, a non-transitory computer-readable storage medium storing instructions for generating artificial intelligence (AI) models is provided, wherein the instructions, when executed by one or more processors of a system, cause the system to receive a plurality of AI models, encode the plurality of AI models to generate a population of respective encoded hierarchical numerical representations of the AI models, wherein each of the plurality of respective encoded hierarchical numerical representations encodes computational units of the respective AI model as linear input-varying systems (LIVs) across a backbone hierarchical level, an operator structure hierarchical level, and a featurization hierarchical level, score each of the plurality of AI models to generate one or more respective score metrics for each of the plurality of AI models, select a plurality of pairs of AI models from the received plurality of AI models, wherein the selection is based at least in part on the score metrics, for each pair of the plurality of selected pairs of AI models, generate a respective offspring encoded hierarchical numerical representation, by combining numerical information from the encoded hierarchical numerical representations for each AI model in the respective pair, and for one or more of the offspring encoded hierarchical numerical representations, generate a respective offspring AI model based on the offspring encoded hierarchical numerical representation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention will now be described, by way of example only, with reference to the accompanying drawings, in which:

FIG. 1 illustrates a hierarchical structure of the architecture genome, according to some examples.

FIGS. 2A-2B illustrate operations of an exemplary evolutionary algorithm technique, according to some examples.

FIG. 3 illustrates training perplexity for training runs during the course of evolutionary algorithm techniques of a population across generations, according to some examples.

FIG. 4(i)-FIG. 4(iii) illustrate final populations evolved with the i) Firefly Algorithm (FA), ii) Genetic Algorithm (GA), and iii) Non-dominated Sorting Genetic Algorithm II (NSGA-2), according to some examples.

FIG. 4(iv)-FIG. 4(vi) illustrate backbone synthesis scales synthesized at iv) reduced depth, v) reduced with, and vi) full depth and width, according to some examples.

FIG. 5 illustrates genome scores during performance of evolutionary algorithm techniques, when optimizing for quality, according to some examples.

FIGS. 6A-6C illustrate results of evolutionary algorithm techniques when optimizing for quality, where backbones contained 24 LIVs at a width of 768 dimensions, with populations of 16 genomes that were evolved for 18 generations, according to some examples.

FIG. 7(i)-FIG. 7(iii) illustrate backbones, specifically a i) Transformer++ backbone, ii) StripedHybrid backbone, and iii) synthesized architecture backbone, according to some examples.

FIG. 8 illustrates population of architectures undergoing iterative evolutionary algorithm techniques to minimize number of parameters and maximize quality, according to some examples.

FIG. 9(i) illustrates genome scores during performance of evolutionary algorithm techniques when optimizing for quality and cache size, according to some examples.

FIG. 9(ii) illustrates cache size scaling with increasing input sequence length for the models shown in Table 2, according to some examples.

FIG. 10 illustrates a synthesized architecture backbone optimized for quality and cache, consisting of 48 LIVs with a width of 2048 dimensions, according to some examples.

FIGS. 11A-11D illustrate evolution of backbones optimized for quality and size, averaged per population, for (11A) number of parameters, (11B) number of LIVs, (11C) number of connected LIVs, and (11D) distance between connected LIVs, according to some examples.

FIG. 12(i)-FIG. 12(viii) illustrates a comparison of different hyper-parameter settings for NSGA-2, according to some examples.

FIGS. 13A-14B illustrate genome scores for evolutionary algorithm ablations, according to some examples.

FIGS. 15A-17B illustrate genome scores for a comparison of synthesis scales, according to some examples.

FIGS. 18A-18C illustrate genome scores for quality and size optimization, according to some examples.

FIGS. 19A-19C illustrate genome scores for quality and cache optimization, according to some examples.

FIGS. 20A-20B illustrate a comparison of two evolutionary algorithm techniques, with and without an extension of the backbone genome, according to some examples.

FIG. 21 illustrates a representation of a model architecture referred to as Architecture-1 optimized for quality, according to some examples.

FIG. 22 illustrates a representation of a model architecture referred to as Architecture-2 optimized for quality, according to some examples.

FIG. 23 illustrates a representation of a model architecture referred to as Architecture-3 optimized for quality, according to some examples.

FIG. 24 illustrates a representation of a model architecture referred to as Architecture-4 optimized for quality, according to some examples.

FIG. 25 illustrates a representation of a model architecture referred to as Architecture-5 optimized for quality, according to some examples.

FIG. 26 illustrates a representation of a model architecture referred to as Architecture-6 optimized for quality, according to some examples.

FIG. 27 illustrates a representation of a model architecture referred to as Architecture-7 optimized for quality, according to some examples.

FIG. 28 illustrates a representation of a model architecture referred to as Architecture-8 optimized for quality, according to some examples.

FIG. 29 illustrates Architecture-1 optimized for quality and size, according to some examples.

FIG. 30 illustrates Architecture-2 optimized for quality and size, according to some examples.

FIG. 31 illustrates Architecture-3 optimized for quality and size, according to some examples.

FIG. 32 illustrates Architecture-4 optimized for quality and size, according to some examples.

FIG. 33 illustrates Architecture-5 optimized for quality and size, according to some examples.

FIG. 34 illustrates Architecture-6 optimized for quality and size, according to some examples.

FIG. 35 illustrates Architecture-7 optimized for quality and size, according to some examples.

FIG. 36 illustrates Architecture-8 optimized for quality and size, according to some examples.

FIG. 37 illustrates Architecture-1 optimized for quality and cache, according to some examples.

FIG. 38 illustrates Architecture-2 optimized for quality and cache, according to some examples.

FIG. 39 illustrates Architecture-3 optimized for quality and cache, according to some examples.

FIG. 40 illustrates Architecture-4 optimized for quality and cache, according to some examples.

FIG. 41 illustrates Architecture-5 optimized for quality and cache, according to some examples.

FIG. 42 illustrates Architecture-6 optimized for quality and cache, according to some examples.

FIG. 43 illustrates Architecture-7 optimized for quality and cache, according to some examples.

FIG. 44 illustrates Architecture-8 optimized for quality and cache, according to some examples.

FIGS. 45A-45D illustrate evolution of backbones optimized for quality, averaged per population, for (45A) number of parameters, (45B) number of LIVs, (45C) number of connected LIVs, and (45D) distance between connected LIVs, according to some examples.

FIGS. 46A-46D illustrate evolution of backbones optimized for quality and cache, averaged per population, for (46A) cache, (46B) number of LIVs, (46C) number of connected LIVs, and (46D) distance between connected LIVs, according to some examples.

FIG. 47 illustrates a method of generating offspring AI models, according to some examples.

FIG. 48 illustrates a method of generating offspring AI models based on mutating at least a portion of offspring encoded hierarchical numerical representations, according to some examples.

FIG. 49 illustrates a computing system, according to some examples.

### DETAILED DESCRIPTION

The following description sets forth exemplary systems, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

### INTRODUCTION

Most domains of applications for AI have seen a gradual convergence towards similar model architecture designs, based on stacking multi-head attention and gated linear units (e.g., Transformers) or combinations of other basic computational units grounded in signal processing, such as recurrences or convolutions.

Broadly, there are two prominent paths to improve model architectures: automated and manual. Automated design, leveraging optimization (e.g. evolutionary methods) within a predefined search space, has seen success in highly-targeted domains, such as the refinement of convolutional neural networks for resource-constrained applications. Automated methods have also been utilized to identify candidate improvements to standard computational primitives (e.g., depth-wise convolutions in projections). Nevertheless, to date, automated methods have fallen short of providing a unified framework that provides significant improvements in quality and efficiency across domains and objectives over models using standard generalizable recipes. The homogeneity of architectures applied at scale during the Transformer era highlights this shortcoming.

The main challenge for automated methods lies in curating a search space for computational units and architectures that is both (a) well-conditioned (e.g., populations of model candidates can be trained effectively without numerical instability or unpredictable degradation in performance) and (b) comprehensive (e.g., the design space includes candidates with significantly different properties from existing variants, expanding the range of potential improvements that can be identified).

Despite a wealth of automated approaches for the search and refinement of computational units and composition strategies, the current generation has been obtained mostly through an iterative manual process, guided by intuition and tuning on representative smaller-scale tasks via e.g., synthetics and scaling laws. Manual design has led to a variety of results, most notably in the introduction or improvement of computational units, modifications targeting smaller inference cache, and the discovery of simple interconnection strategies (e.g., striped hybridization, weight sharing, and others). Yet, manual design is limited to finding relatively basic design patterns, compared to the total diversity of possible patterns, and requires a significant investment in resources, expertise, and time.

Given the wide range of possible applications of current AI systems, enabling systematic and automatic optimization of model architectures from the multitude of existing computational units is key to meeting the various demands these applications pose, in terms of efficiency (e.g., model size, inference cache size, memory footprint, etc.) and quality (e.g., perplexity, downstream benchmarks, etc.), and a prerequisite on the path to further, consistent improvements on the quality-efficiency Pareto frontier.

The techniques described herein may address limitations of existing automated architecture optimization methods by introducing an approach for the generation of AI models using evolutionary algorithms to synthesize AI model architecture. The evolutionary algorithm techniques described herein may be based on the combination of a novel hierarchical search space of computational units and their composition, as well as a numerical encoding compatible with evolutionary methods.

The design space for the evolutionary algorithm techniques described herein may be grounded in the theory of linear input-varying systems (LIVs), providing a novel framework to design building blocks in architectures. LIVs may generalize computational units used in deep learning, such as attention variants, linear (e.g., linearity of the state transition) recurrences, convolutions, and other structured operators. Notably, the framework (e.g., LIVs) may enable characterization of model architectures at three hierarchical levels of resolution, which may be (a) featurization (e.g., how the linear computation within the LIV is modulated by the input context), (b) operator structure (e.g., the token and channel mixing structure of the LIV), and (c) backbone (e.g., the composition structure between LIVs). In contrast to previous search spaces (Pham et al., 2018; Liu et al., 2018; Howard et al., 2019; Li et al., 2021; Roberts et al., 2024), the LIV search space may be both comprehensive and well-conditioned because most sampled candidates, such as those described herein, train without instabilities.

Leveraging the modularity of LIVs, the space (e.g., the LIV search space) may be taxonomized and a hierarchical numerical representation of a model backbone, which may be referred to herein as an architecture genome, may be devised. Due to their structure, architecture genomes can be optimized at different levels of the hierarchy. Backbone genomes (e.g., characterizing ordering and interconnection between LIVs) can be automatically refined with evolutionary algorithms based on principles such as evaluation, recombination, and mutation.

The evolutionary algorithm techniques described herein may be evaluated on autoregressive language modeling, which is a domain historically dominated by Transformers and architecture improvements found via manual search. In particular, architectures (e.g., architectures synthesized via the evolutionary algorithm techniques described herein) may be optimized for one or more metrics simultaneously, such as quality (e.g., perplexity during pretraining), quality and size, and quality and inference cache size (e.g., KV cache and fixed state cache). When optimizing for quality and size, 7 out of 8 evaluated architectures, synthesized via the evolutionary algorithm techniques described herein, improve over Transformer++ and striped hybrids of recurrences and attention across downstream evaluation benchmarks, with a reduction of up to 13% in parameter counts (see Table 1 and Table 6). Similarly, when optimizing for quality and cache size, 7 out of 8 evaluated architectures, synthesized via the evolutionary algorithm techniques described herein, achieve up to 37% smaller cache sizes than striped hybrids, and 90% smaller cache sizes than Transformers, while performing at least as well in quality (see Table 1 and Table 6). In some examples, 125M-parameter architectures optimized for quality and cache by the evolutionary algorithm techniques described herein can scale to 1B parameters and perform on par with parameter-matched Transformer++ and striped hybrid architectures, while maintaining the same advantages in cache size reductions. When optimizing solely for quality, all evaluated architectures synthesized via the evolutionary algorithm techniques described herein outperform standard hybrids on downstream benchmarks, achieving improvements twice as large as those of hybrids over Transformers. Furthermore, the evolutionary algorithm techniques described herein may be used to identify recurring architecture motifs emerging during evolution, driving the observed performance gains.

### Foundations of the Search Space

In some examples, the following details how the framework behind the search space is grounded in the theory of linear systems.

The class of data structures relevant for the evolutionary algorithm techniques described herein include sequences of vectors {x₀, x₁, . . . , x₁}, where each element xᵢ is referred to as a token. Each token xᵢ is a real-valued vector in [symbol] ^{d}, represented as

$${x}_{i} = ( {x}_{i}^{0} , {x}_{i}^{1} , … , {x}_{i}^{d - 1} ) .$$

The individual components

$${x}_{i}^{α}$$

or each token are called channels.

The attention operator may provide a valuable starting point to develop a search space for model architectures, as it defines a prototype of what is referred herein as LIV operators. Attention, in its common formulation, can be expressed as a linear operator applied to the input, with the operator's action determined by the input itself:

$${y}_{i}^{α} = {\underbrace{{\sum }_{β ∈ [ d ]} {\sum }_{j ∈ [ l ]} σ ( {q}_{i}^{T} {k}_{j} ) {V}^{α β}}}_{attention operator} {x}_{j}^{β} , ( {q}_{i} , {k}_{i} ) = ( φ ( {x}_{i} ) , ψ ( {x}_{i} ) ) , \qquad Equation 1$$

where σ: [symbol] → [symbol] is a nonlinear function and V∈ [symbol] ^{d×d}. The intermediate quantities q, k, obtained through functions φ, ψ: [symbol] ^{d}→ [symbol] ^{h} of the input tokens and used to construct the linear operator T, may be referred herein as feature groups.

This idea may be extended to include a broader family of LIVs, which may be expressed in their most general form as:

$${y}_{i}^{α} = {\sum }_{j ∈ [ l ]} {\sum }_{β ∈ [ d ]} {T}_{i j}^{α β} ( x ) {x}_{j}^{β} \qquad Equation 2$$

The LIV framework decouples the (potentially) nonlinear and linear computation required to materialize the operator T (x) and apply it to obtain the outputs, y=Tx. LIVs may include and generalize a diverse array of computational units commonly used in model architectures, whose class is defined by the structure of the operator, such as attention, convolutions, linear recurrences, and various forms of other structured layers. Examples of the operator Tᵢⱼ and the associated class include:

Tᵢⱼ=σ(CᵢBᵢ),dense,attention

Tᵢⱼ=CᵢBⱼ,low-rank,linear attention

Tᵢⱼ=CᵢAᵢ₋₁ . . . Aⱼ₊₁Bⱼ,semi-separable,linear recurrence

Tᵢⱼ=CᵢKᵢ₋ⱼBⱼ,scaled Toeplitz,gated convolution

$${T}_{ij} = \{ \begin{matrix}σ ( C ) , & i = j \\ 0 , & otherwise\end{matrix} ,$$

diagonal, memoryless system,
where the structure (e.g., sequence-mixing structure, or the structure of slices T^{αβ} of the operator T (e.g., for convenience, the structure described herein is defined via entries

$${T}_{i j}^{α β} ) )$$

of the operator T induces a decomposition into feature groups, analogously to the attention example (e.g., Equation 1). To highlight the parallels between different LIVs and attention, a shared notation may be adopted for the feature groups. LIV systems may be differentiated by operator structure and featurization.

Featurization may refer to the process with which feature groups are obtained, either via direct parameterization, re-parametrization (e.g., sometimes referred to as implicit parametrization), or via parametric transformations of inputs, such as in attention (e.g., linear projections).

Regarding structure (e.g., operator structure), the linear operators of LIVs may be taxonomized by decoupling the analysis of token-mixing and channel-mixing structure. Described herein, structure may be defined by looking at two different slices of the operator. For instance, a slice, T^{αβ}∈ [symbol] ^{l×1}, may highlight the token-mixing structure for each tuple of input and output channels (e.g., the linear contribution of the βth input channel x^{β}∈ [symbol] ^{l} to the αth output channel y^{α}∈ [symbol] ^{l}). The choice of token-mixing structure may determine the class of matrix multiplication algorithms that can be utilized to apply the operator to the input (e.g., Fast Fourier Transform based convolution if Toeplitz, or parallel prefix scan if semi-separable). Alternatively, a slice, Tᵢⱼ∈ [symbol] ^{d×d}, may reveal the channel-mixing structure of T (e.g., the (linear) contribution of the jth input token xⱼ of the input sequence to the ith output token yᵢ). In practice, the most common choice of channel-mixing structure is by far the diagonal one, as used in attention and most variants of linear recurrences. (Diagonal as the common choice of channel-mixing structure is brought to an extreme by multi-headed architectures that only present number-of-heads distinct values on the diagonal). Diagonal Tᵢⱼ blocks may enable maximum parallelization of the LIV operators as the linear computation reduces to d independent matrix multiplications. The aforementioned logic may be used to define the structure present in the featurizer itself. The structure of the featurizer and operator may, or may not, be the same.

The flexibility of LIV allows a wide range of neural network operators and layers to be defined and described in a shared hierarchical format. An evolutionary algorithms technique may be used to apply systematic neural architecture search in LIV operators to find an optimized neural architecture given quality, memory, and latency criteria for deployment. A semi-automated procedure may be used to determine specific ratios of each operator in each model and the structure of their featurizers (e.g., based on automated architecture synthesis using evolutionary algorithms techniques, such as the evolutionary algorithm techniques described herein, or a modified version thereof).

In some embodiments, a search technique may be applied to operator types including one or more of (but in some embodiments not limited to): grouped query attention (GQA), SwiGLU, convolutional Hyena-SE, and Mixture-of-Experts (MoEs). Below is an overview of each operator's structure, their composition into model backbones, and their implementation.

Grouped query attention (GQA), in some embodiments, represents a variant of attention operator, e.g., a variant of the standard attention operator, using a featurizer with a dense channel mixing and diagonal token mixing structure with 3 feature groups (Q, K, V), a low-rank token-mixing structure, a softmax non-linearity, and a diagonal channel-mixing structure. In contrast to standard attention, GQA represents K and V in lower dimension and leverages repetition when computing the attention operator (see above).

Convolutional Hyena-SE, in some embodiments, is characterized by a featurizer with diagonal channel mixing structure and Toeplitz token mixing structure (using a short convolution filter) applied to feature groups (e.g., to all feature groups) in addition to an explicitly parametrized feature group for short convolution, a Toeplitz token mixing structure, no non-linearity, and a diagonal channel mixing structure.

SwiGLU, in some embodiments, is characterized by a featurizer with dense channel mixing structure and diagonal token mixing structure with two feature groups, a diagonal token mixing structure, swish non-linearity, and dense channel mixing structure.

Mixture-of-Experts (MoE), in some embodiments, represents a sparse parallel extension of SwiGLU, composed of a set of SwiGLU operators (the experts), and a trainable gating network that selects a sparse combination of the experts to process each input token.

In some embodiments, the models disclosed herein were developed to provide the fastest generative AI experience on embedded SoCs and to minimize or eliminate drawbacks and compromise. In some embodiments, models such as those disclosed herein (including models that achieve one or more of the goals described above) may be developed using evolutionary algorithm techniques, such as those described herein.

To evaluate language modeling capabilities as part of an evolutionary algorithm technique, an evolutionary algorithm technique may be used that moves beyond traditional validation loss and perplexity metrics. Additionally, or alternatively, a comprehensive suite (e.g., over 50) of internal evaluations may be applied to assess diverse capabilities, including knowledge recall, multi-hop reasoning, understanding of low-resource languages, instruction following, and tool use.

Similarly, a direct approach may be taken to measuring architectural efficiency as part of an evolutionary algorithm technique, additionally or alternatively to using KV cache size as a proxy. Actual tests may be run to measure and optimize peak memory usage and prefill+decode speed on one or more exemplary devices, for example on Qualcomm Snapdragon embedded SoC CPUs.

An architecture backbone can be decomposed into a set of LIVs with different composition rules. Beyond sequential stacking of LIVs, as is common in standard deep architectures, other composition rules realized via the featurization may be introduced. For instance, composition rules realized via the featurization may include featurizer sharing (e.g., where the same featurizer weights are shared between different LIVs of a backbone) and feature group sharing (e.g., where different LIVs share the same feature groups).

As an example, let T, S denote the operators at two different depths m, n (m<n) of the composition, respectively. If, for example, both LIV operators are chosen with similar low-rank (e.g., linear attention) structure, Tᵢⱼ=Cᵢ Bⱼ, Sᵢⱼ=Eᵢ Fⱼ, and the dimensions of the feature groups are compatible (e.g., Cᵢ, Eᵢ∈ [symbol] ^{d×h} and Bᵢ, Fᵢ ∈ [symbol] ^{h×d}), then both featurizer and feature group sharing techniques can be applied. For instance, if the parametric featurizer of Cᵢ and Eᵢ has the same form Cᵢ=φ(xᵢ;⋅), Eᵢ=φ(xᵢ;⋅), then the same set of parameters θ can be shared between them:

$${T}_{i j} = φ ( {x}_{i}^{( m )} ; θ ) {B}_{j} {\to }_{featurizer sharing} {S}_{i j} = φ ( {x}^{( n )} ; θ ) {F}_{j}$$

where x^{(m)}, x⁽ⁿ⁾ denote the input to the mth and nth LIV system, respectively. Similarly, one of the feature groups of the mth LIV system can be re-used in the nth LIV system (e.g., Bⱼ):

$${T}_{i j} = {C}_{i} {B}_{j} {\to }_{featurizer sharing} {S}_{i j} = {E}_{i} {B}_{j}$$

A prominent example of feature group sharing is the sharing of key-value caches between attention operators. Such as described herein, beyond featurizer interconnections, other strategies of operator composition (e.g., flexible residual streams), may be used.

Describing Operators and Backbones with Architecture Genomes

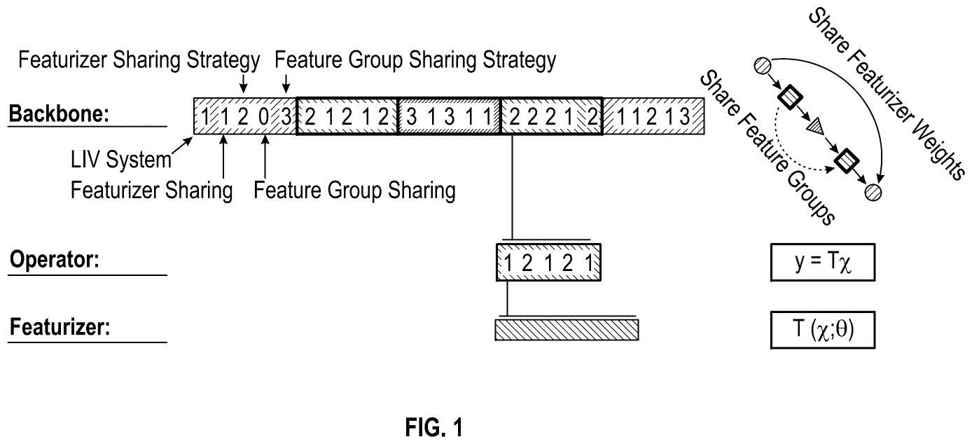

The design space of LIVs and their compositions may serve as the foundation for the evolutionary algorithm techniques as disclosed herein. The three hierarchical levels of the LIV description (e.g., featurization, structure, and composition) may be mapped into a numerical representation suitable for optimization, which may be referred to herein as the architecture genome. Each level of the hierarchy can be summarized into a single integer, yielding a numerical representation that can be optimized at different levels of granularity (see FIG. 1). FIG. 1 illustrates an exemplary hierarchical structure of an architecture genome. Each sequence at lower levels may be summarized into a single value at higher levels, which may enable each sequence to be treated as a discrete variable. This property (e.g., summarizing each level of the hierarchy as a single integer) may be leveraged when optimizing backbones directly.

The highest abstraction level of the architecture genome may be the backbone genome, which may characterize the composition of LIVs in the backbone. Under the LIV framework, LIVs can be connected with featurizer and feature group sharing. Specifically, the backbone genome may include a set of integer-valued sequences, such as a set of integer-valued sequences of length five, in which each integer-valued sequence represents an LIV of the backbone. Each of the integer-valued sequences may be associated with properties of an LIV represented by an integer-valued sequence of length five. For instance, an integer-valued sequence of length five may include five integers which respectively represent the following properties: 1) LIV class, 2) featurizer sharing, 3) featurization sharing strategy, 4) feature group sharing, and 5) feature group sharing strategy.

The LIV class property of an LIV may be an integer summary of lower levels of the architecture genome (e.g., operator and featurizer genomes). The featurizer sharing property of an LIV may determine the weight-sharing structure between featurizers of LIVs at different depth in the backbone. For instance, LIVs with the same value for the featurizer sharing property share featurizer weights (e.g., such as described by the featurization sharing strategy). The featurization sharing strategy property of an LIV may be associated with how featurizer sharing is implemented for the LIV class. For instance, featurizer weights can be shared partially. As an example, the featurizer weights responsible for computing B(x) may be shared and the featurizer weights for computing C(x) may not be shared (or vice versa). The feature group sharing property of an LIV may describe that LIVs with the same index share feature groups directly, instead of featurizer weights. For example, LIVs may share feature groups directly by using the same B(x) and C(x). The feature group sharing strategy property of an LIV may describe which feature groups, of all available feature groups of the LIV class, are shared.

Each integer-valued sequence (e.g., segment) may be repeated in the order at which the encoded operators occur in the backbone (see FIG. 1). Outside of the compositions defined by the backbone genome, LIVs may be sequentially stacked using pre-norm residuals (i.e., y=T(norm (x)) norm(x)+x).

An exemplary genome backbone with 4 LIVs is 21211-31112-21221-32112. In this exemplary genome backbone, the first LIV (e.g., 21211) and third LIV (e.g., 21221) belong to the same LIV class “2” and are part of the same featurizer sharing group “1”, thus the first LIV and third LIV share featurizer weights according to the indexed featurizer sharing strategy “2” (e.g., only sharing the weights responsible for the first feature group). The second LIV (e.g., 31112) and fourth LIV (e.g., 32112) belong to LIV class “3”, they do not share any featurizer weights (e.g., they have different featurizer sharing indices, “1” and “2”), and instead share feature groups directly, with feature group sharing strategy “2” (e.g., sharing all groups).

In the backbone genome described herein, certain information about LIVs may be summarized into a single integer and/or into a string of integers, e.g., indicating the specific featurizer and structure of the LIV. Unrolling this encoding reveals an additional level, the operator genome, which identifies a specific LIV by a plurality of integers, such as illustrated in FIG. 1. For instance, the operator genome may identify an LIV by five integers. The first integer may represent a featurization, indicating a specific featurizer class. The second integer may represent a linear token-mixing structure of an LIV (T^{αβ}). The third integer may represent possible structured sparsity masks (e.g., banded) for token-mixing. The fourth integer may represent any nonlinearity applied to the token-mixing structure. The fifth integer may represent an LIV's channel-mixing structure (Tᵢⱼ).

The featurizer class (e.g., corresponding to the first integer representing featurization) can be similarly unrolled (see FIG. 1) into a featurizer genome. In the evolutionary algorithm techniques described herein, each featurizer genome may be a sequence that, for each feature group, describes: token and channel mixing structure (akin to the operator genome); expansion factor, characterizing the ratio of the feature group channel dimension over the input channel dimension, e.g., encoded as one integer; repeat factor, characterizing how many times the feature groups are replicated across the channel dimension), e.g., encoded as one integer.

### Synthesizing Architectures by Evolving Genomes

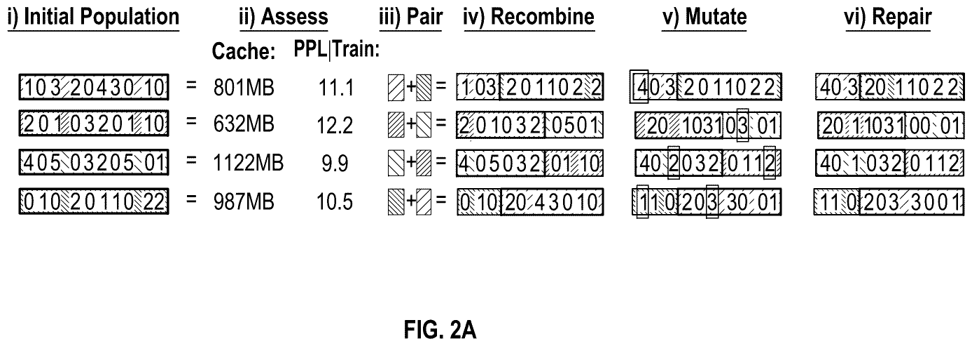

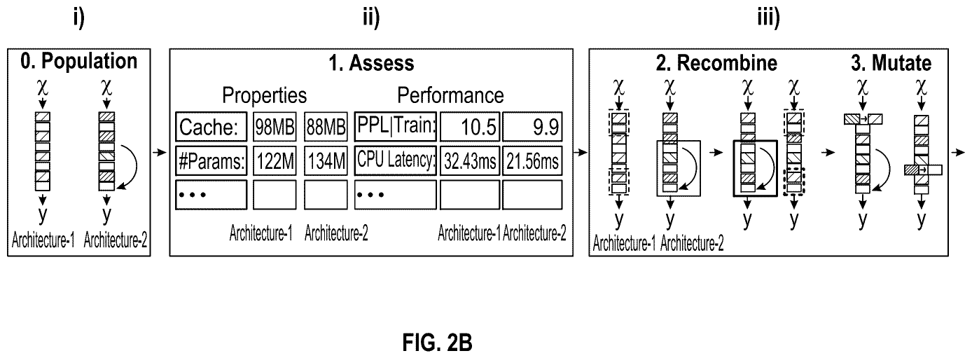

The architecture genome may be a hierarchical numerical representation that encodes a specific LIV backbone, suitable for gradient-free optimization. The architecture genome can be optimized via evolutionary methods. To enable the application of evolutionary optimization methods to the architecture genome, methods are used to iteratively evolve an initial population of genomes. FIG. 2A and FIG. 2B illustrate exemplary operations of evolutionary algorithm techniques described herein.

The evolutionary algorithm techniques may include evaluating the quality of each genome in the initial population (see FIG. 2A(i) and FIG. 2B (i)). Evaluating the quality of each genome in the initial population may involve realizing the model encoded in each genome and scoring it against objective functions of interest, such as by training and assessing the model's performance or through a static analysis for efficiency objectives, such as the total number of trainable parameters in the model (see FIG. 2A(ii) and FIG. 2B(ii)). Notably, the evolutionary algorithm techniques described herein can incorporate multiple and diverse objectives.

After assessing the quality of each genome, the evolutionary algorithm techniques may include selecting parent genomes for generating the next generation of offspring through tournament selection (see FIG. 2A(iii)). Parents may be chosen by randomly selecting a set of k genomes from the population and then picking the one with the highest quality, in which highest quality may be based on criteria such as predictive accuracy or the lowest parameter count. The evolutionary algorithm techniques described herein may take into account solution diversity in the selection process to maintain variety within the population.

The evolutionary algorithm techniques may include generating new candidate solutions by applying k-point crossover to the selected parent genomes (see FIG. 2A(iv) and FIG. 2B (iii)). Genetic material from two parents may be exchanged between k randomly chosen points, resulting in offspring that inherit traits from both parents. Random sampling in the evolutionary algorithm techniques described herein may be performed with a uniform probability across all valid options.

Finally, the evolutionary algorithm techniques may include introducing random mutations to the offspring (scc FIG. 2A(v) and FIG. 2B (iii)). These mutations may maintain diversity in the population and promote exploration of the search space. In the evolutionary algorithm techniques described herein, random mutations may be implemented as alterations to the numbers in a genome, where values may be randomly replaced by others from a predefined set of possible choices. The possible choices may vary depending on the genome position of a value randomly selected to be replaced. To ensure that all genomes encode models capable of being trained stably and showing smooth quality improvements, the evolutionary algorithm techniques described herein may enforce constraints on these random mutations.

For instance, to ensure compatibility with evolutionary optimization, it may be desirable for the architecture genome to remain robust to random edits such as recombination, mutation, or initialization. The backbone genome may be composed of 5-number segments. When mutating the first entry (e.g., LIV class), mutation may be restricted to valid LIV classes. For the second and fourth entries (e.g., featurizer and feature group sharing, respectively), only LIVs within the same class can connect. The third and fifth entries may be mutated by randomly sampling valid sharing strategies for the corresponding LIV class. If mutations or recombinations result in invalid configurations, such as incompatible sharing strategies, the invalid configurations may be detected and repaired (see FIG. 2A(vi)) by either removing the invalid connection for the second and fourth entries of the operator genome, or re-sampling the respective genome value from the set of valid choices for the first, third, and fifth entries.

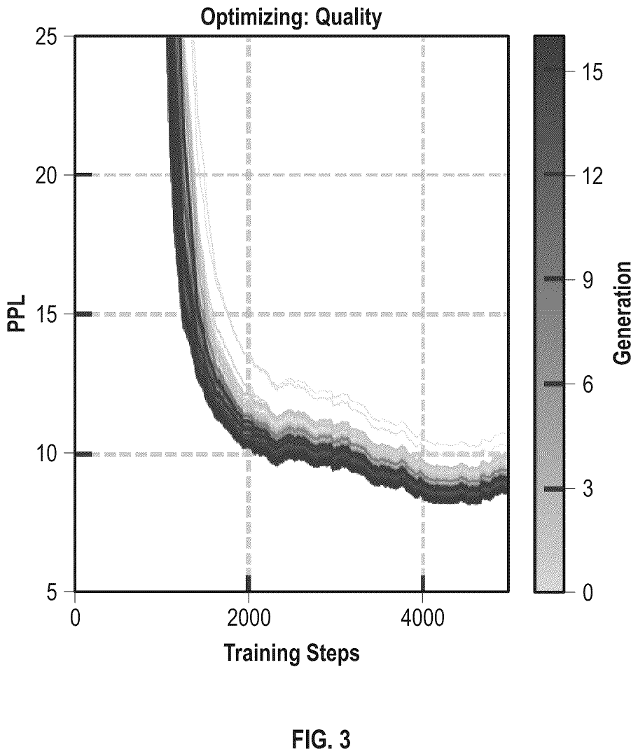

Combining the LIV search space, genome encoding, and guidelines for mutation and recombination, may lead to stable training runs for candidates obtained during the course of the evolutionary algorithm techniques, such as shown in FIG. 3. FIG. 3 illustrates training perplexity for training runs during the course of the evolutionary algorithm techniques of a population (e.g., PPL) across generations.

While the LIV search space is general in the context of sequence modeling primitives, it does not include all classes of functions that can be embedded in a backbone, potentially missing options for further optimization. Since the evolutionary algorithm techniques described herein can target any objective, the evolutionary algorithm techniques may be optimized via integration within scaling laws protocols. Additionally, or alternatively, efficiently computed metrics that correlate with performance at scale (e.g., average accuracy on curated synthetic tasks) may be optimized.

In some embodiments, the evolutionary algorithm techniques described herein may optimize fixed-length genomes, which may limit architectures to fixed depth and width. In some embodiments, optimizing variable-depth and variable-width architectures may be challenging due to the hierarchical and modular design space. Shallower genomes may be computationally cheaper and converge faster, but may lack the complexity that is desirable for difficult tasks. Deeper genomes may offer greater representational power but expand the search space, and may risk suboptimal convergence due to overfitting or inefficient sampling. In some embodiments, the evolutionary algorithm techniques described herein may address these challenges with adaptive mechanisms such as depth-aware sampling and/or dynamic penalties to improve scalability.

The evolutionary algorithm techniques described herein may streamline the search by treating the genome as a unified entity, enabling efficient exploration, which may be beneficial for rapid iteration or when there are limited resources (e.g., computing resources, such as memory, processing power, etc.). However, in some embodiments, this approach may not fully exploit the hierarchical design space, potentially overlooking dependencies or key subspaces across genome levels. In contrast, in some embodiments, a multi-stage optimization strategy may systematically refine each hierarchical level (e.g., featurization, operator structure, and backbone) using tailored evolutionary algorithms. The multi-stage optimization strategy may improve convergence, especially in complex task settings, by leveraging the genome's modularity and addressing interactions incrementally, although in some embodiments it may increase algorithmic complexity and computational costs.

Modifying the architecture genome (e.g., the numerical encoding enabled by the LIV framework) may enable exploration of model architectures with substantial differences at multiple levels, including in the type of LIVs the model architectures are composed of, as well as their ordering and interconnection. Recall that the architecture genome is structured hierarchically: at the highest level (e.g., highest hierarchical level), the backbone genome may specify the composition of LIVs in the backbone and each LIV may be represented by a single integer and/or by a series of integers. In some embodiments, a single integer indicates a LIV class and summarizes the highest-level information about the LIV, while additional integers (e.g., in positions 2-4 in a five-integer sequence, indicate additional information about the LIV. Expanding this encoding may reveal the operator genome, which identifies the LIV. At the operator genome hierarchical level, the specific featurizer of the LIV may be similarly encoded as a single integer, which can be further expanded into the featurizer genome, which specifies the particular featurizer used by the LIV.

Below is an overview of the specific integer values that may be included in the hierarchical levels (e.g., backbone genome, operator genome, featurizer genome) and the corresponding meanings relevant for the architecture genome. It should be understood that the below examples of integer values and their corresponding meanings are for illustrative purposes and not intended to be limiting. For instance, the pool of options can be readily expanded, provided the results compile to valid operators and backbones within the LIV framework.

The formulation of the backbone genome (without extensions such as residual composition described herein) may include sequences of integers, such as sequences of five integers, where each sequence corresponds to one of the LIVs contained in the backbone characterizing (a) the individual operator and (b) composition rules with other LIVs.

For each integer in the genome, described below are options that may be considered. While a specific set of choices are presented here, the pool of options can be readily expanded, provided the results compile to valid operators and backbones within the LIV framework.

A first integer of a sequence included in the backbone genome may specify the LIV class and may take on any of the following values: values 1-4, indicating Softmax attention variants (SA) 1-4; values 5-6, indicating Recurrences (Rec) 1-2; values 7-8, indicating Gated convolutions (GConv) 1-2; value 9, indicating Gated memoryless unit (GMemless); or values 10-17, indicating Differential variants of LIV classes 1-8 (e.g., akin to the “Differential Transformer” (Ye et al., 2024)).

A second integer of a sequence included in the backbone genome may define the weight-sharing structure of the LIVs' featurizers. For instance, all LIVs within a backbone that share featurizer weights will have the same value in this position. The mapping of integer values to the weight-sharing structure may thereby depend on the number of occurrences of each LIV class (N) in the backbone. For instance, if all LIVs of the same class share featurizer weights, then they may all be assigned a value of 1 at this position. Conversely, if none of the LIVs of the same class share featurizer weights, then each LIV may be assigned a unique integer value from 1 to N.

A third integer of a sequence included in the backbone genome may define the strategy for sharing featurizer weights. Examples of featurizer sharing strategies may include 1) no weights are shared, or 2) all weights are shared. As such, the possible values of the third integer may be 1 and 2.

A fourth integer of a sequence included in the backbone genome may establish the feature group sharing structure of the LIVs. For instance, similar to the featurizer weight-sharing structure (e.g., second integer), all LIVs within a backbone that share feature groups will have the same value at this position. The assignment of integer values to feature group sharing may follow the same logic described herein for the second integer.

A fifth integer of a sequence included in the backbone genome may specify the strategy used for sharing feature groups. Since feature groups are unique to each LIV class, the possible values for this integer may vary depending on the LIV class. The range of possible values for the fifth integer may be between 1 (e.g., indicating no shared feature groups) and N+1, where N represents the number of unique feature groups in the given LIV class. For example, in the case of softmax attention, the possible values may be 1 (e.g., no shared feature groups), 2 (e.g., shared key cache), 3 (e.g., shared value cache), and 4 (e.g., shared key and value cache).

An exemplary genome is 11111 91111 12121 92121. This genome consists of four LIVs arranged in an interleaved order. The first and third LIVs belong to the SA-1 class, and the second and fourth LIVs belong to the GMemless class. None of the LIVs share featurizer weights or feature groups, as each occurrence of a LIV class has distinct integer values for featurizer sharing (e.g., second integer) and feature group sharing (e.g., fourth integer). Both the featurizer sharing strategy (e.g., third integer) and feature group sharing strategy (e.g., fifth integer) are set to 1, indicating no sharing.

Another exemplary genome is 11111 91111 51111 92121. This genome represents a variation of the genome shown above, where the third LIV has been switched from class SA-1 to class Rec-1. Similar to the aforementioned exemplary genome, none of the LIVs share feature groups of featurizer weights.

Another exemplary genome is 11111 91111 51111 92121 11221 91131. This genome is comprised of six LIVs. The first and fifth LIV belong to the SA-1 class; the second, fourth, and sixth LIV belong to the GMemless class; and the third LIV belongs to the Rec-1 class. Notably, the two SA-1 LIVs share the weights of their featurizers, as both have a value of 1 at the second integer position and a value of 2 at the third integer position.

The operator genome may specify a particular LIV and may be represented by a set of integer values, such as five integer values. For instance, a first integer of a sequence of the operator genome may summarize the LIV's featurizer; a second, third, and fourth integer may characterize the token-mixing structure of the LIV; and a fifth integer may characterize the channel-mixing structure.

Specifically, the first integer of a sequence of the operator genome may specify the featurizer class. Examples of a featurizer class include:
1. Dense channel mixing structure with diagonal token mixing structure on all feature groups (3 groups e.g., in SA-1).
2. Dense channel mixing structure with Toeplitz token mixing structure on all feature groups (3 groups e.g., in SA-2).
3. Variant of featurizer class described by 1, where a repeat factor of 4 is applied to the last two feature groups (e.g., used for SA-3).
4. Variant of featurizer class described by 1, where a repeat factor of 2 is applied to the last two feature groups (e.g., used for SA-4).
5. Dense channel mixing and Toeplitz token mixing structure. An expansion factor of 16 is applied to the last two feature groups (e.g., used for Rec-1).
6. Dense channel mixing and Toeplitz token mixing structure. An expansion factor of 2 is applied to the last two feature groups (e.g., used for Rec-2).
7. Diagonal channel mixing structure with Toeplitz token mixing structure for all feature groups. One of the groups is explicitly parametrized (e.g., short convolutions of length 3 used for GConv-1).
8. Variant of featurizer class described by 5, where the short convolution kernel feature group is replaced with an implicitly parametrized feature group (e.g., long convolutions used in GConv-2).
9. Dense channel mixing structure with diagonal token mixing structure with 2 feature groups (e.g., used for GMemless). Variant of featurizer class described by 1 with one fewer feature group.

As such, the possible values for the first integer may be 1-9.

The second integer of a sequence of the operator genome may characterize the linear token-mixing structure of the LIV, before any final nonlinearity. The second integer may be any of the following values:
1. Diagonal (e.g., GMemless)
2. Low rank (e.g., SA)
3. Scaled Toeplitz (e.g., GConv)
4. Sequentially semi-separable (e.g., Rec)

The token-mixing structure may determine the class of matrix multiplication algorithms that can be used to apply the operator to the input. For instance, if the LIV is sequentially semi-separable, it supports an O(l) algorithm implemented as a linear recurrence.

The third integer of a sequence of the operator genome may determine whether any structured sparsity mask is applied to the token-mixing structure. The third integer may be any of the following values:
1. No sparsity
2. Banded (e.g., as used for short convolutions)

In some examples, models trained are causal, and as such upper-triangular sparsity masks may be introduced when beneficial (e.g., in LIVs wrapped by nonlinearities).

The fourth integer of a sequence of the operator genome may describe whether and how any final nonlinearity is applied to the token-mixing structure. The fourth integer may be any of the following set of static and normalization non-linearities:
1. None
2. Softmax
3. ReLU
4. Swish

The fifth integer of a sequence of the operator genome may describe the LIV channel mixing structure. The fifth integer may be any of the following values:
1. Diagonal
2. Dense

Exemplary operator genomes for various LIV classes are described below. It should be understood that the below examples of operator genomes are for illustrative purposes and not intended to be limiting.

SA-1: An operator genome 12121 may refer to the standard attention operator using a featurizer with a dense channel mixing and diagonal token mixing structure with 3 feature groups, a low-rank token-mixing structure, no sparsity mask, a softmax non-linearity, and a diagonal channel-mixing structure.

SA-2: An operator genome 22121 may represent a variant of SA-1 whose featurizer has a dense channel mixing and Toeplitz token mixing structure. This variant may be realized in practice by adding depth-wise convolutions to the featurizer.

SA-3: An operator genome 32121 may represent a variant of SA-1, where a repeat factor of 4 is applied to the last two feature groups. This variant may be akin to variants of multi-query (MQA) and grouped-query attention (GQA).

SA-4: An operator genome, 42121 may represent a variant of SA-3 with a lower repeat factor of 2 for the last two feature groups.

Rec-1: An operator genome 54111 may be characterized by a featurizer with Toeplitz token mixing structure and dense channel mixing structure with five feature groups, where an expansion factor of 16 is applied to the last two feature groups, with a semi-separable token mixing structure, no sparsity, no non-linearity, and a diagonal channel mixing structure. Rec-1 may be representative of a variety of modern input-varying linear recurrent layers.

Rec-2: An operator genome 64111 may be the same as Rec-1, with the exception of an expansion factor of 2 for the last two feature groups.

GConv-1: An operator genome 73111 may be characterized by a featurizer with diagonal channel mixing structure and Toeplitz token mixing structure (using a short convolution filter) applied to all feature groups, in addition to an explicitly parametrized feature group for short convolution, a Toeplitz token mixing structure, no sparsity, no non-linearity, and a diagonal channel mixing structure.

GConv-2: An operator genome 83111 may have the same structure as GConv-1, except for the use of an implicitly parametrized feature group for long convolutions. GConv-2 may represent modern operators in the gated long convolution family.

GMemless: An operator genome 91142 may be characterized by a featurizer with dense channel mixing structure and diagonal token mixing structure with two feature groups, a diagonal token mixing structure, no sparsity, swish non-linearity, and dense channel mixing structure. GConv-1 may thereby represent a SwiGLU.

In addition, differential variants of LIV classes 1-8 (SA, Rec, and GConv) may be included, where two identical LIVs are applied in parallel, outputting their difference, similar to the “Differential Transformer.”

In some embodiments, the featurizer genome may be composed of sequences of integers, such as sequences of six integers, one sequence per feature group of the featurizer. The first four integers may be akin to integers 2-5 of the operator genome, respectively summarizing the LIV featurizer, indicating the linear token-mixing structure, indicating whether and/or how any sparsity is applied, indicating whether and/or how any nonlinearity is applied, and indicating the channel mixing structure. The fifth integer of the sequence of the featurizer genome may indicate an expansion factor of the feature group channel dimension over the input channel dimension. The sixth integer of the sequence of the featurizer genome may indicate a repeat factor for how many times the feature groups are replicated across the channel dimension. In some examples, the featurizer genome may be restricted to a maximum of 5 feature groups (e.g., 35 integers in total). If the featurizer takes in less than 5 feature groups, then the sequences of all excess feature groups may be set to 0.

In some embodiments, backbone topologies may be constrained to a pre-norm residual structure, where the output y^{m} of LIV T^{m} at backbone depth m is defined as: y^{m}=T(norm (y^{m-1})) norm (y^{m-1})+y^{m-1}. In some embodiments, the backbone genome can be extended to support more flexible residual streams. This can be achieved by introducing a sixth entry to each subsection of the backbone genome, corresponding to its respective LIV. Recall that the backbone genome consists of sequences of five integers, where each sequence encodes the characteristics of an LIV and its integration within the composition structure. If two LIVs, at depths m and n (where m<n), share the same value at this new genome position, the residual stream may be extended, such that yⁿ=T(norm(u)) norm(u)+u, where u=yⁿ⁻¹+y^{m}.

In some embodiments, composition strategies via residuals and inputs to LIVs may be used, and/or improved featurizer interconnections may be used, e.g., sharing inputs to the system, the featurizer, and the residual stream itself.

### Example 1

Experiments were conducted to test whether the evolutionary algorithm techniques described herein are suitable for synthesizing architectures tailored to diverse objectives, such as predictive quality and efficiency. Unless otherwise stated, the evolutionary algorithm techniques presented were performed at 125M-parameter model scale, where backbones contained 24 LIVs at a width of 768 dimensions, with populations of 16 genomes that were evolved for 18 generations. During each performance of the evolutionary algorithm techniques described herein, the depth and width of the backbone were fixed. Experiments were performed in autoregressive language modeling on 4096 token sequences from the RedPajama dataset (Weber et al., 2024).

During the performance of the evolutionary algorithm techniques described herein, models were trained from scratch for 1.3B tokens using AdamW (Loshchilov et al., 2017) with a peak learning rate of 0.0008, a batch size of 0.25M tokens, and a cosine learning rate schedule with a 130M-token linear warmup (see Table 3). The resulting synthesized backbones were evaluated by training them from scratch for 5B tokens under the same setup but with an extended warmup of 400M tokens (see Table 4). Additionally, select 1B-parameter models (48 LIVs at a width of 2048) were trained for 40B tokens, increasing the batch size to 0.75M tokens and the warmup to 2.6B tokens (see Table 5).

A two-stage evaluation process was used. During performance of the evolutionary algorithm techniques described herein, performance metrics were computed on a 500M-token evaluation set from RedPajama. In particular, two different randomly-drawn evaluation datasets were used for ablation and main experiments. Post-evolution, the 8 models with the lowest perplexity among those with lower parameter counts (e.g., for quality and quality-size optimizations) or smaller cache size (e.g., quality-cache optimization) than baseline models were selected. These models were trained further and evaluated on downstream tasks: HellaSwag (Zellers et al., 2019), ARC-c (Clark et al., 2018), Winogrande (Sakaguchi et al., 2019), PiQA (Bisk et al., 2020), and SciQ (Welbl et al., 2017), and ARC-c (Clark et al., 2018) for 1B-parameter models.

To improve initialization during the evolutionary algorithm techniques described herein, genomes of common backbone types were incorporated. Unless otherwise stated, initial populations included simple hybrid backbones without special interconnections, combining memoryless LIVs (e.g., SwiGLU (Shazeer, 2020)) with baseline LIVs, such as convolutions, recurrences, or attention. Other backbones were randomly initialized with random LIV class choices and compositions. As the focus was on backbone optimization, the pool of LIV classes was limited to a subset of systems encodable through the operator and featurizer genomes, including token-mixing structures as explained herein. This included common dense channel-mixing featurizers (e.g., linear projections), more advanced Toeplitz token-mixing featurizers, and/or “differential” variants of all LIV classes except memoryless ones, which use two identical, parallel LIVs and output their difference.

Three gradient-free evolutionary algorithms, Firefly Algorithm (FA) (Yang, 2009), Genetic Algorithm (GA) (Bremermann et al., 1966), and NSGA-2 (Deb et al., 2002), were compared for optimizing architecture genomes toward quality and parameter count. Each algorithm evolved a population of 16 genomes (8 LIVs, 768 dimensions) over 8 iterations. FA and GA optimized a single objective, using the sum of normalized loss L and parameter count P: U(L)+U(P), where

$$U ( x ) = \frac{x - min ( X )}{max ( X ) - min ( X )} for x ∈ X .$$

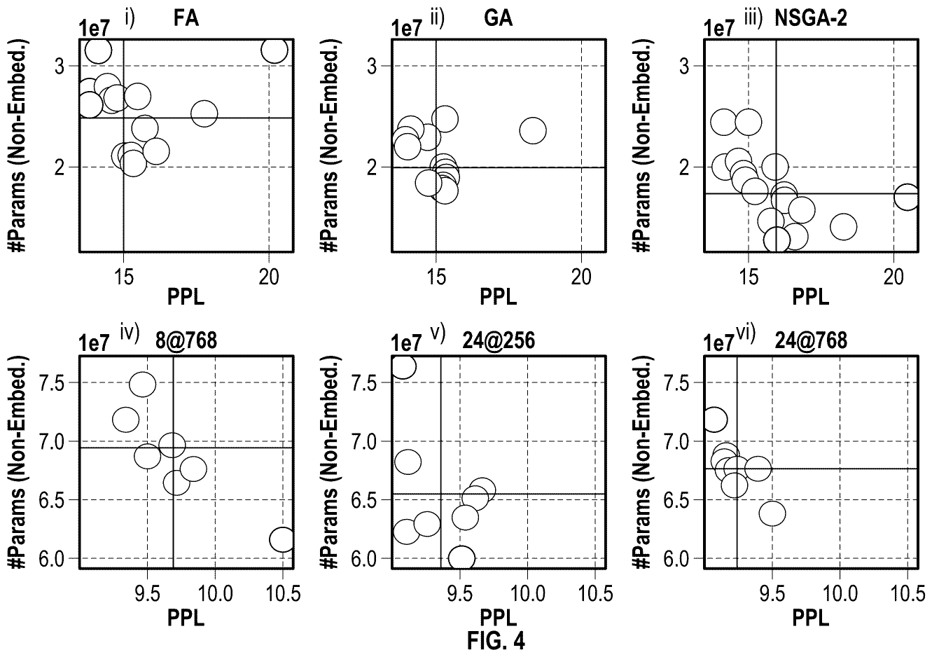

Results showed that GA and NSGA-2 outperformed FA by achieving lower parameter counts while maintaining comparable predictive quality. GA slightly surpassed NSGA-2 in performance but produced larger models, whereas NSGA-2 achieved greater solution diversity (FIG. 4). FIGS. 4(i)-(iii) illustrate the final populations evolved with the i) FA, ii) GA, and iii) NSGA-2 evolutionary algorithms. FIGS. 4(iv)-(vi) illustrate backbone synthesis scales, particularly iv) synthesized at reduced depth (“motif”, 8 LIVs at 768), v) reduced width (24 LIVs at 256), and vi) full depth and width (24 LIVs at 768). With regards to FIG. 4, the models were scaled to the same LIV count and width via stacking or width extension. NSGA-2 was thus used in subsequent experiments. Hyperparameter tuning of NSGA-2 indicated optimal performance with a population size of 16, a 10% mutation probability, and 2 crossover points. The two best-performing genomes per population were carried over to prevent performance regression.

Automated architecture optimization in language modeling faces the challenge of high compute costs for training and evaluating large-scale models. Two approaches were explored to reduce the high compute costs: (a) optimizing smaller backbone motifs (e.g., groups of fewer LIVs in deeper models) and stacking them to build deeper models; and (b) optimizing full-depth backbones at reduced widths. For both approaches, 16 genomes were evolved over 12 iterations and were optimized for parameter count and quality. The resulting models were compared to models synthesized at full width and depth under identical settings. From each evolution, eight backbones were selected, smaller in parameter count than Transformer++ and StripedMamba baselines and with the lowest evaluation perplexity. The selected backbones were scaled to the same LIV count and width (e.g., via motif stacking or width extension) and were trained for 5B tokens before downstream evaluation. As illustrated in FIG. 4(v)-(vi), synthesizing backbones at full width and depth yielded consistent improvements, while reduced-width synthesis achieved similar results with fewer successful candidates. Motif synthesis underperformed both approaches (see FIG. 4(iv)).

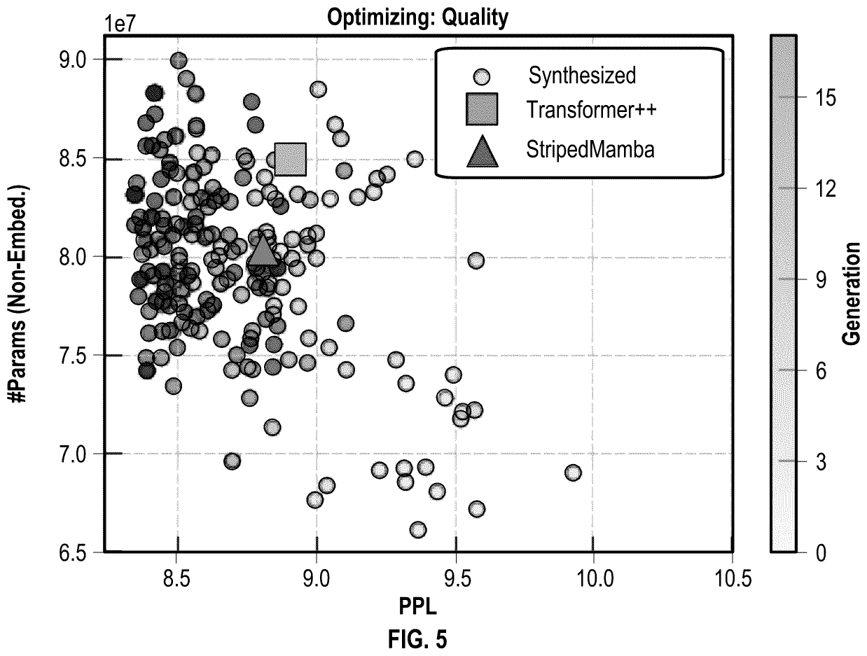

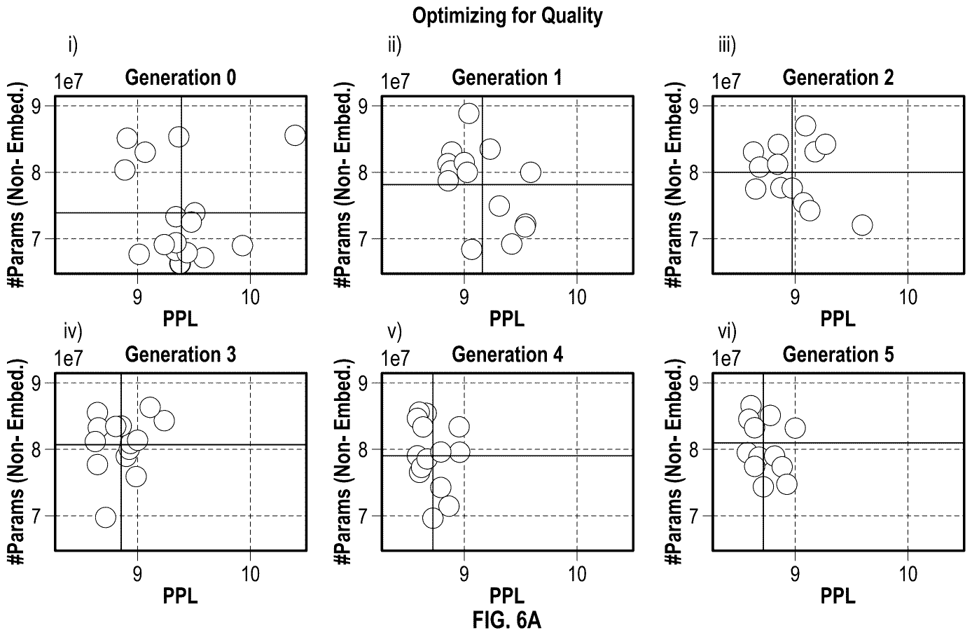

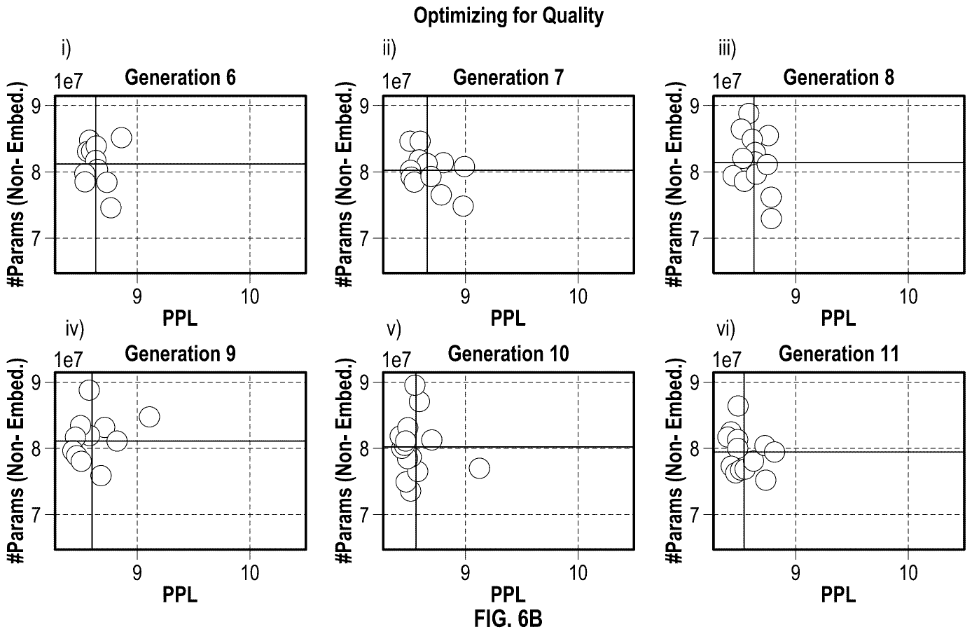

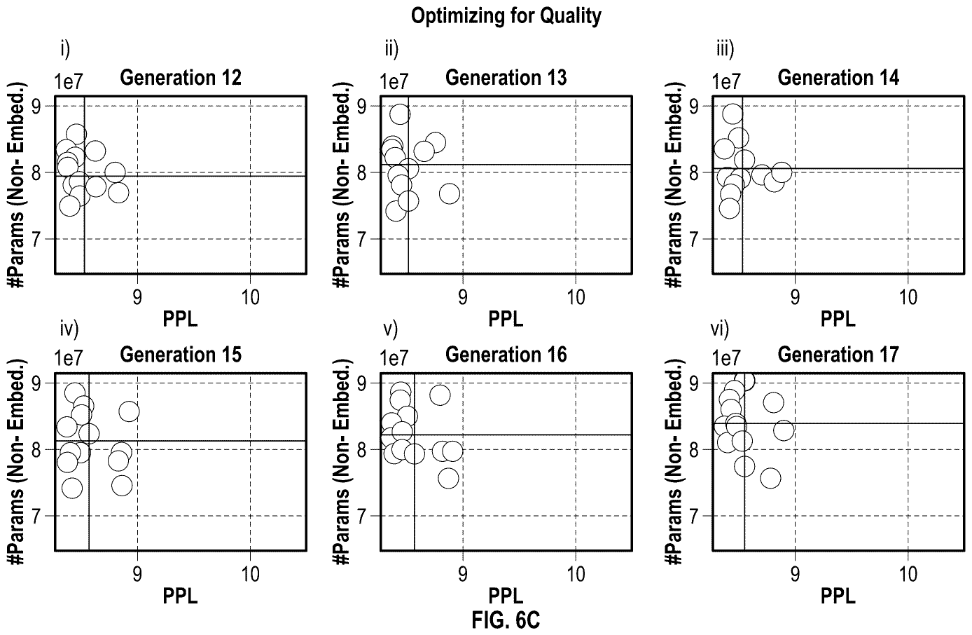

The evolutionary algorithm techniques described herein were applied to synthesize high-quality backbones for language modeling by evolving a population using perplexity as the only objective. When optimizing for quality, the evolutionary algorithm techniques described herein achieved a reduction of the average quality of an initial population by 1.0 PPL point without changes to model depth and width (see FIG. 5 and FIGS. 6A-6C). FIG. 5 illustrates genome scores during the evolutionary algorithm techniques described herein, when optimizing for quality. FIGS. 6A-6C illustrate results of the evolutionary algorithm techniques described herein when optimizing for quality (e.g., direct quality optimization), where backbones contained 24 LIVs at a width of 768 dimensions, with populations of 16 genomes that were evolved for 18 generations.

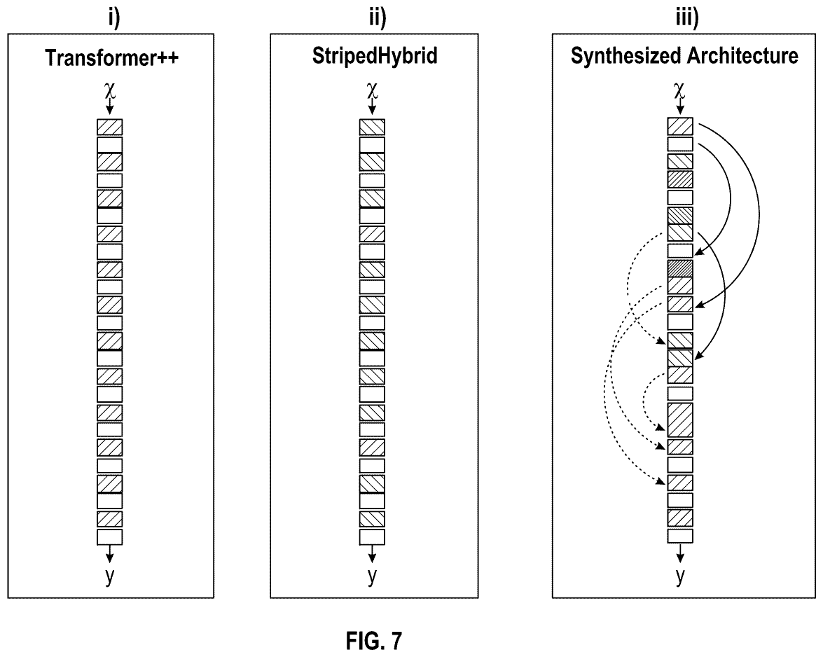

Architecture backbones that were optimized for quality outperformed parameter-matched Transformer++ and StripedMamba backbones in RedPajama eval. PPL as well as on HellaSwag, ARC-Easy, Winogrande, PiQA, and SciQ. Improvements of architecture backbones over standard hybrids on benchmark averages was two times larger than the improvement of hybrids over Transformers (see Table 1 and Table 6). FIG. 7(i) illustrates an exemplary Transformer++ backbone, FIG. 7(ii) illustrates an exemplary StripedHybrid backbone, and FIG. 7(iii) illustrates an exemplary synthesized architecture backbone.

TABLE 1
Evaluation of backbones optimized for quality (rows 4-7), quality and size (rows
8-11), and quality and cache (rows 12-15). LM-Eval-Harness was used for testing.
Transformer++ and StripedMamba baselines were trained on the same data
as the architecture backbones. Size indicates trainable parameter count without
embeddings. The bolded numbers indicate the architectures with the best performance,
and the underlined numbers indicate the architectures with the second-best performance.

| | | Cache | | Hella. | | | | | |
|---|---|---|---|---|---|---|---|---|---|
| Backbone/ | | (bytes \| | RedPj. | acc. | ARC-e | Wino. | PiQA | SciQ | |
| Optimized for | Size | 4K) | ppl ↓ | norm. ↑ | acc. ↑ | acc. ↑ | acc. ↑ | acc. ↑ | Avg. ↑ |
| Transformer++ | 85M | 150MB | 7.3 | 28.9 | 38.8 | 51.2 | 61.2 | 64.1 | 48.8 |
| StripedMamba | 80M | 25MB | 7.2 | 28.6 | 39.3 | 51.1 | 60.9 | 67.4 | 49.5 |
| Architecture- | 79M | 100MB | 7.0 | 29.8 | 39.3 | 51.2 | 62.2 | 72.5 | 51.0 |
| 1/Quality | | | | | | | | | |
| Architecture- | 80M | 82MB | 7.1 | 29.2 | 40.5 | 51.1 | 61.6 | 72.4 | 51.0 |
| 2/Quality | | | | | | | | | |
| Architecture- | 78M | 120MB | 7.1 | 29.7 | 40.0 | 50.9 | 62.0 | 71.2 | 51.0 |
| 3/Quality | | | | | | | | | |
| Architecture- | 79M | 94MB | 7.1 | 29.3 | 39.7 | 51.0 | 61.5 | 72.6 | 50.8 |
| 4/Quality | | | | | | | | | |
| Architecture- | 74M | 63MB | 7.2 | 28.9 | 39.3 | 51.0 | 61.8 | 67.6 | 49.7 |
| 1/Q. + Size | | | | | | | | | |
| Architecture- | 74M | 64MB | 7.2 | 28.7 | 37.5 | 52.8 | 61.0 | 68.9 | 49.8 |
| 2/Q. + Size | | | | | | | | | |
| Architecture- | 70M | 151MB | 7.2 | 29.2 | 39.5 | 51.9 | 61.5 | 69.4 | 50.3 |
| 3/Q. + Size | | | | | | | | | |
| Architecture- | 70M | 114MB | 7.2 | 29.2 | 40.0 | 52.7 | 61.4 | 68.9 | 50.4 |
| 4/Q. + Size | | | | | | | | | |
| Architecture- | 77M | 16MB | 7.2 | 28.9 | 40.0 | 51.3 | 61.0 | 66.4 | 49.5 |
| 1/Q. + Cache | | | | | | | | | |
| Architecture- | 83M | 22MB | 7.2 | 28.7 | 40.1 | 50.3 | 62.2 | 66.0 | 49.5 |
| 2/Q. + Cache | | | | | | | | | |
| Architecture- | 75M | 23MB | 7.2 | 28.9 | 40.6 | 50.2 | 61.3 | 67.2 | 49.6 |
| 3/Q. + Cache | | | | | | | | | |
| Architecture- | 78M | 22MB | 7.2 | 29.1 | 39.9 | 53.0 | 62.2 | 66.7 | 50.2 |
| 4/Q. + Cache | | | | | | | | | |

TABLE 2
Evaluation of a 1B architecture backbone (48 LIVs, 2048 width) optimized for quality and
cache (LM-Eval-Harness). Results are compared to parameter-matched Transformer++
and StripedMamba baselines trained on 40B RedPajama tokens. Size excludes embedding layers.

| | | Cache | | ARC-c | Hella. | | | | | |
|---|---|---|---|---|---|---|---|---|---|---|
| | | (bytes \| | RedPj. | acc. | acc. | ARC-e | Wino. | PiQA | SciQ | |
| Backbone | Size | 4K) | ppl ↓ | norm. ↑ | norm. ↑ | acc. ↑ | acc. ↑ | acc. ↑ | acc. ↑ | Avg. ↑ |
| Transf.++ | 1.2B | 805MB | 5.9 | 27.3 | 49.3 | 58.9 | 51.3 | 71.2 | 86.3 | 57.4 |
| StripedMb. | 1.1B | 136MB | 5.7 | 58.3 | 52.8 | 59.8 | 51.4 | 72.9 | 86.0 | 59.0 |
| Architecture- | 1.1B | 86MB | 5.7 | 27.9 | 52.6 | 60.8 | 53.9 | 71.8 | 87.0 | 59.0 |
| 1B | | | | | | | | | | |

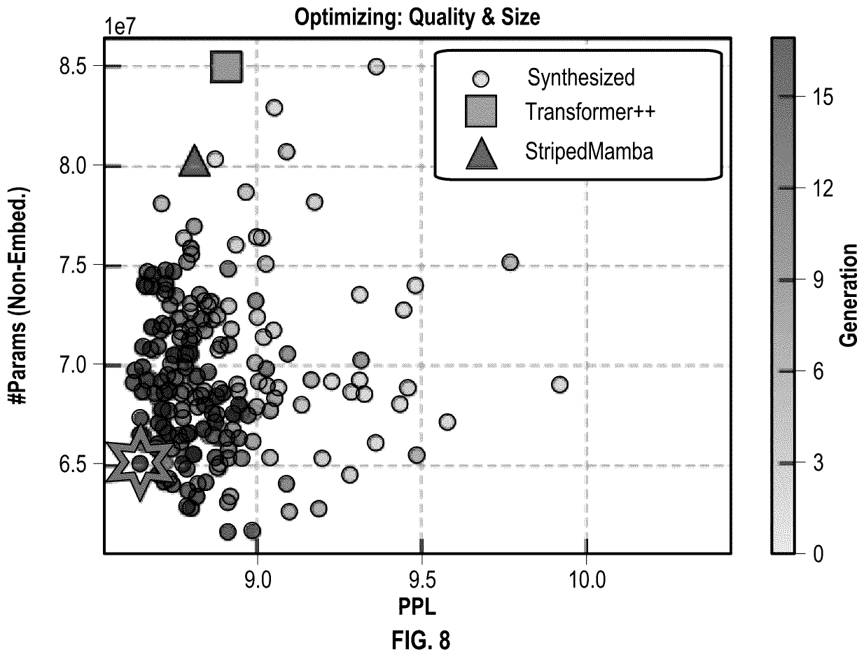

It was observed that evolutionary algorithm techniques described herein can synthesize high-quality language models. Next, it was assessed whether the evolutionary algorithm techniques described herein can likewise synthesize language models of high quality and smaller parameter counts. To this end, a population was evolved using evaluation perplexity and parameter count as objectives. Optimizing for quality and size, the evolutionary algorithm techniques described herein improved an initial population by 0.5 PPL points at an average reduction of 10% in trainable parameter count, such as shown in FIG. 8. FIG. 8 illustrates population of architectures undergoing iterative evolutionary algorithm techniques to minimize number of parameters and maximize quality. The performance of representative synthesized backbones were also evaluated when training them longer.

It was found that architecture backbones that were optimized for quality and size outperformed Transformer++ and matched StripedMamba backbones in RedPajama eval. PPL. The architecture backbones that were optimized for quality and size also surpassed Transformer++ and StripedMamba on Hellaswag, ARC-Easy, Winogrande, PiQA, and SciQ, with a reduction in parameter count by 13% and 8% respectively (see Table 1 and Table 6).

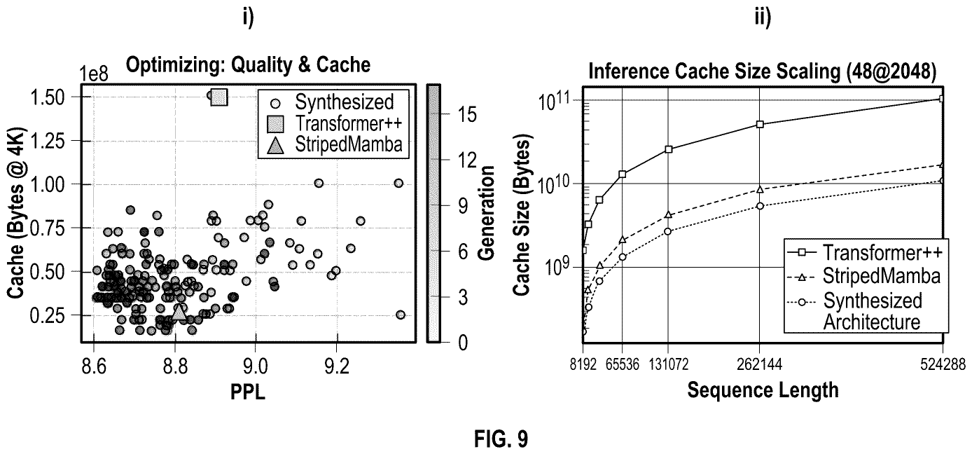

High inference costs limit the widespread use of language models. To address this, it was tested whether the evolutionary algorithm techniques described herein can synthesize architectures with reduced inference cache size without sacrificing predictive quality. By optimizing for perplexity and cache size (see FIG. 9(i)), the evolutionary algorithm techniques described herein improved an initial population by 0.4 PPL points and a 40% cache size reduction. FIG. 9(i) illustrates genome scores during the evolutionary algorithm techniques described herein when optimizing for quality and cache size. Cache size was computed at a fixed sequence length of 4096 tokens. FIG. 9(ii) illustrates cache size scaling with increasing input sequence length for the models shown in Table 2.

It was found that architecture backbones that were optimized for quality and cache size outperformed Transformer++ and matched StripedMamba in RedPajama perplexity. The architecture backbones that were optimized for quality and cache size surpassed both Transformer++ and StripedMamba on HellaSwag, ARC-Easy, Winogrande, and PiQA, with cache size reductions of 90% and 36%, respectively, at a sequence length of 4096 tokens (see Table 1 and Table 6).

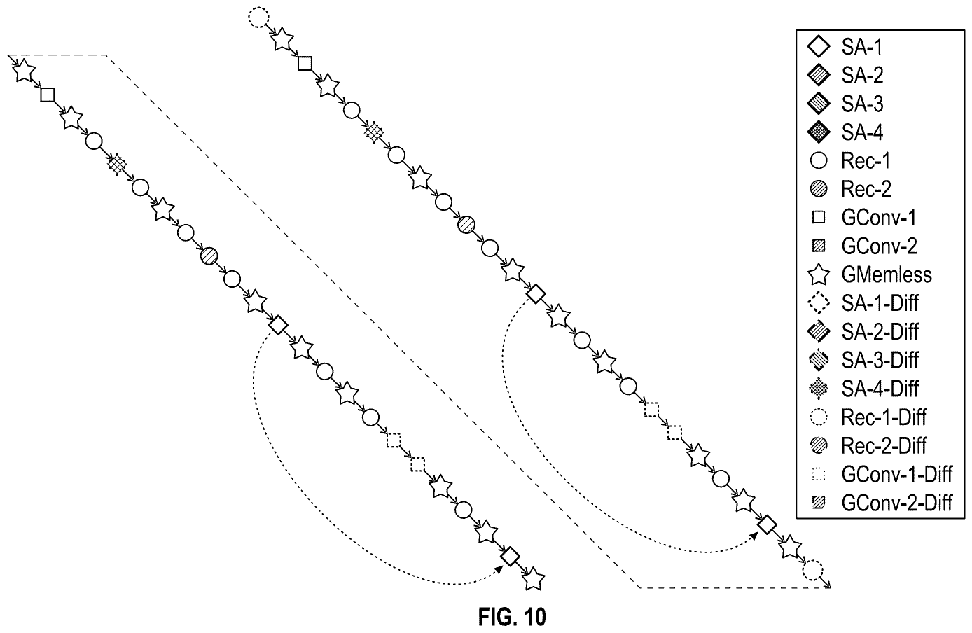

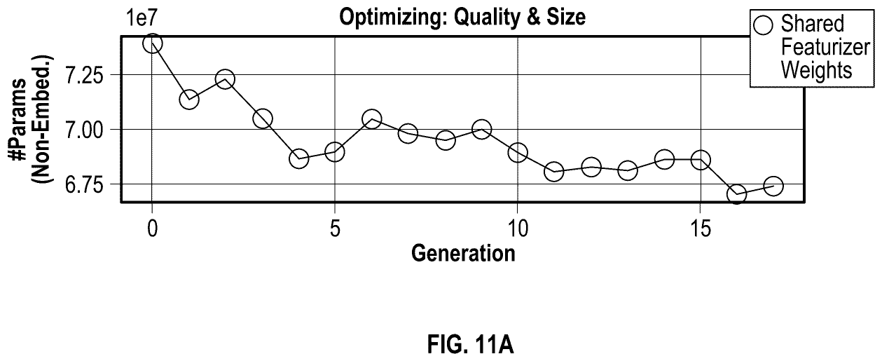

Previous experiments had shown that architecture synthesis at smaller scales using the evolutionary algorithm techniques described herein yielded suboptimal results (see FIG. 4). Nevertheless, when scaling a 24-LIV backbone at 768 dimensions, optimized for quality and cache size, to 48 LIVs at 2048 dimensions, through stacking and width extension, it was found that it matches the performance of a parameter-matched StripedMamba baseline and outperformed a parameter-matched Transformer++ baseline when all were trained for 40B tokens. Scaling a synthesized architecture backbone from 125M to 1B parameters (see FIG. 10) outperformed a parameter-matched Transformer++ baseline and matched a StripedMamba baseline in RedPajama evaluation perplexity and performance on ARC-Challenge, HellaSwag, Winogrande, PiQA, and SciQ, while reducing cache size by 90% and 37%, respectively (see Table 2). FIG. 10 illustrates a synthesized architecture backbone optimized for quality and cache, consisting of 48 LIVs with a width of 2048 dimensions (see Table 2). This backbone was generated by duplicating a backbone from the evolutionary algorithm techniques described herein for quality and cache and increasing its width from 768 to 2048 dimensions. The dashed lines of FIG. 10 illustrate feature group sharing. Overall, synthesized architecture backbones outperformed Transformer++ and StripedMamba baselines with hit rates of 8/8, 7/8, and 7/8 when optimizing for quality, quality and size, and quality and cache, respectively (see Tables 1 and 6).

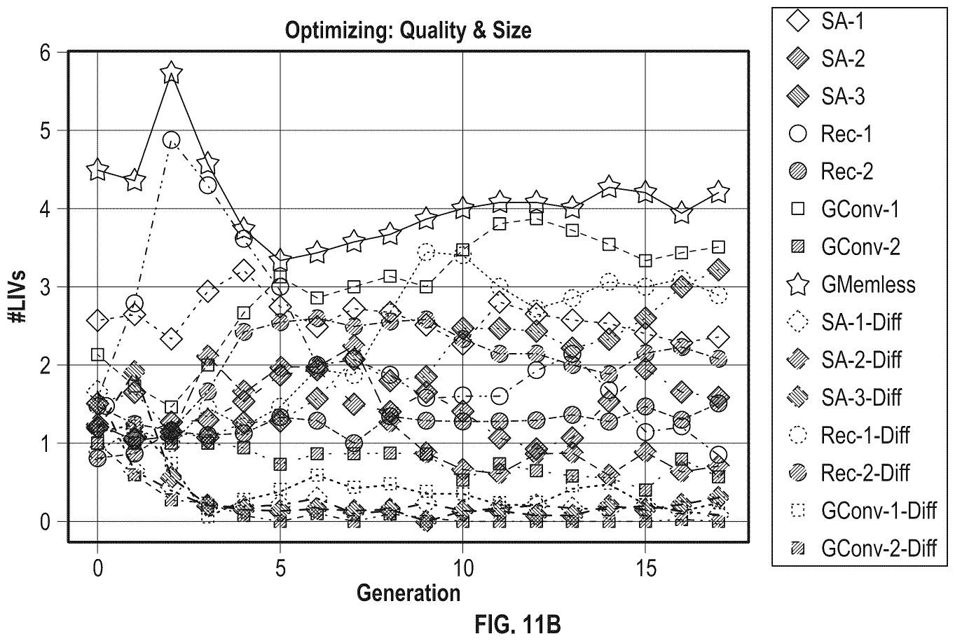

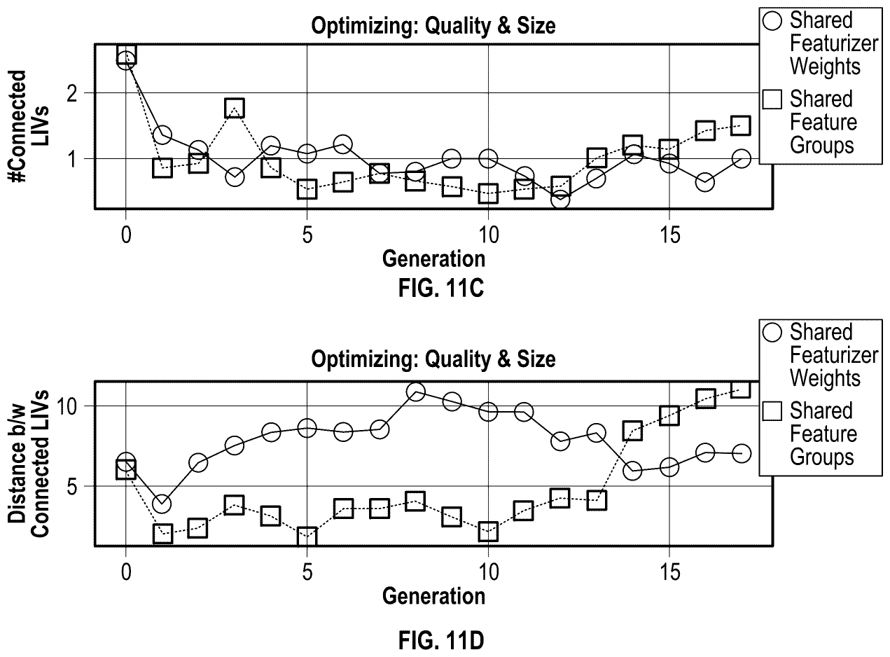

The evolutionary algorithm techniques described herein may be well-suited for the synthesis of backbones optimized for various objectives. In addition, the evolutionary algorithm techniques described herein may provide a tool for the automated discovery of backbone motifs that drive performance improvements, as it evolves populations towards using those combinations and compositions of LIVs that perform best. FIGS. 11A-11D demonstrate this for the evolution targeting model quality and size. FIGS. 11A-11D illustrate evolution of backbones optimized for quality and size, averaged per population. Particularly, FIG. 11A illustrates generation versus number of parameters, FIG. 11B illustrates generation versus number of LIVs, FIG. 11C illustrates generation versus number of connected LIVs, and FIG. 11D illustrates generation versus distance between connected LIVs. Distances measures the number of other LIVs between two connected LIVs. It was observed that the evolutionary algorithm techniques described herein may favor gated short convolutions (GConv-1), grouped query (Ainslie et al., 2023) attention variants (SA-3), and differential variants of input-varying recurrences (Rec-1-Diff), as well as SwiGLUs (Shazeer, 2020) (GMemless).

Tables 3, 4, and 5 illustrate the training settings used during experiments of the evolutionary algorithm techniques described herein and when evaluating the resulting synthesized backbones.

TABLE 3
Training setting during the evolutionary
algorithm techniques described herein.

| Optimizer | AdamW |
|---|---|
| Optimizer Momentum | β₁, β₂ = 0.9, 0.95 |
| Batch Size | 0.25M Tokens |
| Training Steps | 5000 |
| Learning Rate Schedule | Cosine Decay |
| Linear Learning Rate Warm-Up | 500 Steps |
| Base Learning Rate | 0.0008 |
| Weight Decay | 0.1 |
| Dropout | None |
| Gradient Clipping | 1.0 |

TABLE 4
Training settings for evaluation of synthesized backbones.

| Optimizer | AdamW |
|---|---|
| Optimizer Momentum | β₁, β₂ = 0.9, 0.95 |
| Batch Size | 0.25M Tokens |
| Training Steps | 20000 |
| Learning Rate Schedule | Cosine Decay |
| Linear Learning Rate Warm-Up | 1500 Steps |
| Base Learning Rate | 0.0008 |
| Weight Decay | 0.1 |
| Dropout | None |
| Gradient Clipping | 1.0 |

TABLE 5
Training setting for models with 48 LIVs at
a width of 2048 dimensions (see Table 2).

| Optimizer | AdamW |
|---|---|
| Optimizer Momentum | β₁, β₂ = 0.9, 0.95 |
| Batch Size | 0.75M Tokens |
| Training Steps | 50000 |
| Learning Rate Schedule | Cosine Decay |
| Linear Learning Rate Warm-Up | 3500 Steps |
| Base Learning Rate | 0.0008 |
| Weight Decay | 0.1 |
| Dropout | None |
| Gradient Clipping | 1.0 |

All baseline models were trained using the training settings described in Table 4. The baseline models were each trained at two depths and widths to match the parameter counts of our synthesized models (see Tables 1 and 2): 24 operators at 768 dimensions and 48 operators at 2048 dimensions.

The Transformer++ described herein with regards to experiments conducted was a Transformer (Vaswani et al., 2017) with an improved architecture, namely rotary positional encodings (Su et al., 2024), SwiGLU MLP (Shazeer, 2020), RMSNorm instead of LayerNorm, and no linear bias term. The Transformer++ used a head dimension of 64, which resulted in 12 and 32 heads for models with 768 and 2048 width, respectively.

The StripedMamba described herein with regards to experiments conducted was a striped hybrid backbone (Poli et al., 2024) that combines Mamba (Gu & Dao, 2023), SwiGLU MLP (Shazeer, 2020), and self-attention (Vaswani et al., 2017) operators. The 24-operator backbone of the StripedMamba was composed of interleaved Mamba and SwiGLU operators, except operators 6 and 18, which are softmax attention. The Mamba operators had a state size of 32, and the attention operators had a head dimension of 64. The 48 operator StripedMamba backbone was obtained by stacking two 24 operator backbones in depth and increasing the overall width to 2048.

Below, an overview is presented of the three variants of gradient-free evolutionary optimization algorithms applied in this work. These algorithms were adapted to be compatible with the architecture genome. Before discussing their individual differences, several core operations shared across the variants will first be described.

Such as described in reference to FIGS. 2A and 2B, tournament selection may select parent candidates by randomly sampling a subset of individuals from the population and choosing the highest-performing individual from this subset. Tournament selection may promote the propagation of strong candidates while preserving diversity because of its inherent randomness.

Such as described in reference to FIGS. 2A and 2B, k-point crossover may recombine the genomes of two parents by exchanging segments of genetic material at k randomly selected points, thus creating offspring that inherit a mix of traits from both parents.

Elitism may balance exploration and exploitation by preserving a subset of the top-performing individuals from the current population and carrying them over directly to the next generation. Elitism may ensure that high-quality solutions are not lost and may accelerate convergence, while reducing the risk of premature convergence to suboptimal regions of the solution space.

Such as described in reference to FIGS. 2A and 2B, mutation may maintain population diversity by introducing randomness through random alterations to a genome, which may help the algorithm (e.g., evolutionary algorithm) explore new regions of the solution space.

The FA is inspired by fireflies' attraction to brighter (e.g., fitter) individuals based on their light intensity. FA may assign a light intensity,

$$a = \frac{1}{1 + s} ,$$

to each genome that is inversely related to the genome's fitness score s. In each iteration, FA may pair genome i with genome j via tournament selection. If aⱼ>aᵢ, then FA may update gⁱ to resemble g^{j} through two steps: (1) computing attraction strength β=β₀ (1−e^{-γ(1-r)}), where β₀ is baseline attraction, γ is the light absorption coefficient, and r is the similarity ratio of matching LIVs, and (2) replacing LIV

$${g}_{k}^{i}$$

with

$${g}_{k}^{j}$$

with probability (e.g., attraction strength) β. If aᵢ≥aⱼ, then gⁱ may remain with unchanged. Finally, gⁱ may undergo mutation.

The GA, in each iteration, may generate new genomes by (i) selecting two parents via tournament selection, (ii) recombining the selected parents using k-point crossover, and (iii) mutating the recombined genomes.

NSGA-2 may extend GA for multi-objective optimization by maintaining a diverse set of Pareto-optimal solutions through non-dominated sorting and crowding distances. NSGA-2 may first segregate genomes into fronts, in which the first front may include the most optimal, non-dominated solutions. Genome gⁱ may dominate g^{j} if it outperforms g^{j} in at least one objective without being worse in others. Within each front, genomes may be sorted by objective scores, such as predictive quality, and assigned crowding distances. Crowding distance in multi-objective optimization may be a measure of the density of solutions surrounding a particular solution and may be calculated as the sum of the normalized distances between adjacent solutions across all objectives:

$${d}_{i} = {\sum }_{m = 1}^{M} ( \frac{{f}_{m}^{i + 1} - {f}_{m}^{i - 1}}{{f}_{m}^{max} - {f}_{m}^{min}} ) ,$$

where dᵢ is the crowding distance for solution i and fₘ is the objective value in the mth objective. Boundary solutions, with extreme objective scores, may receive infinite crowding distances to ensure preservation, while non-boundary solutions may be assigned crowding distances based on differences from adjacent neighbors. Selection then may favor genomes with higher front rank and crowding distance.

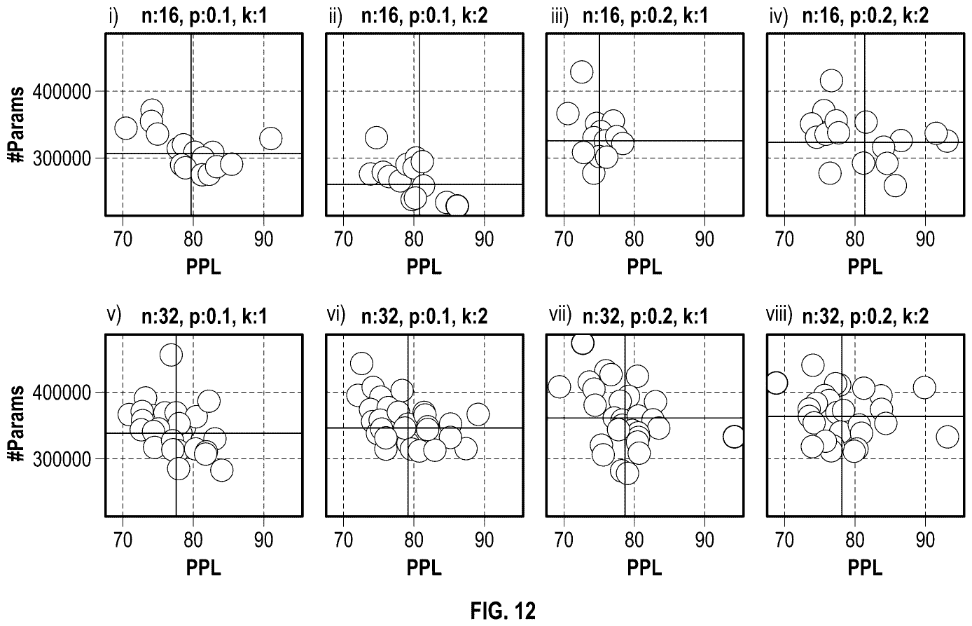

It was found that NSGA-2 performed the best in our comparison. The optimal hyper-parameter settings for NSGA-2 were also investigated, specifically population size n, mutation probability p, and number of crossover points k. To do this, two population sizes (16 and 32) were evolved, optimizing for quality and parameter count, while varying the number of crossover points (1 or 2) and mutation probabilities (10% or 20%) (see FIG. 12). FIG. 12 illustrates a comparison of different hyper-parameter settings for NSGA-2. Specifically, FIG. 12 illustrates number of parameters versus population for (i) n=16, p=0.1, and k=1, (ii) n=16, p=0.1, and k=2, (iii) n=16, p=0.2, and k=1, (iv) n=16, p=0.2, and k=2, (v) n=32, p=0.1, and k=1, (vi) n=32, p=0.1, and k=2, (vii) n=32, p=0.2, and k=1, and (viii) n=32, p=0.2, and k=2. Note, the y-axis label for FIG. 12 (i) applies to FIGS. 12(ii)-FIG. 12(iv), and the y-axis label for FIG. 12 (v) applies to FIGS. 12(vi)-FIG. 12(viii). To keep to overall number of sampled genomes constant, populations containing 16 genomes were evolved for 8 iterations and populations containing 32 genomes were evolved for 4 iterations. The genomes contained 24 LIVs at a width of 64 dimensions. Results indicated that NSGA-2 performed best with a population size of 16, 2 crossover points, and a 10% mutation probability (see FIG. 12).

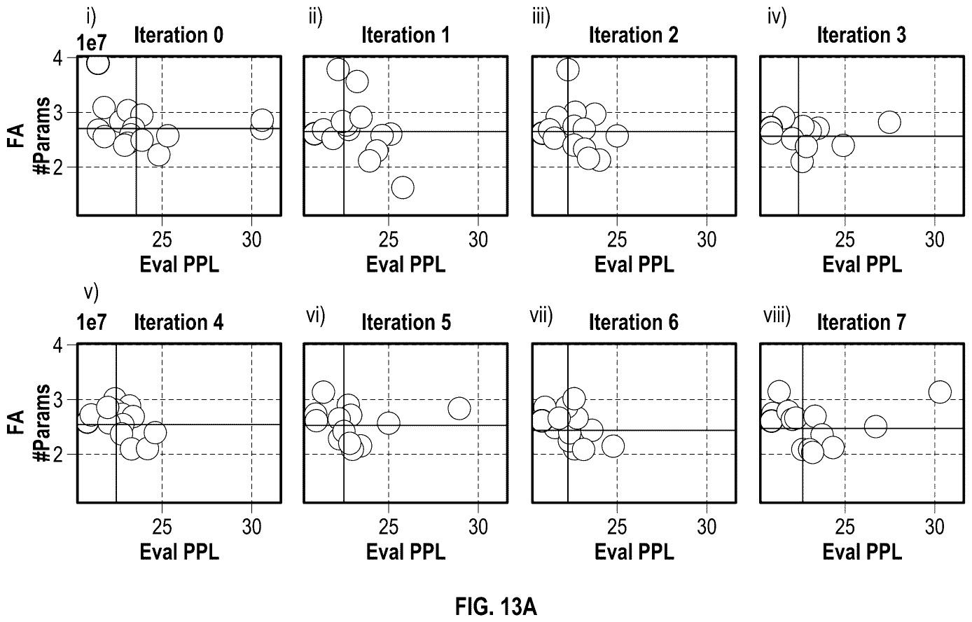

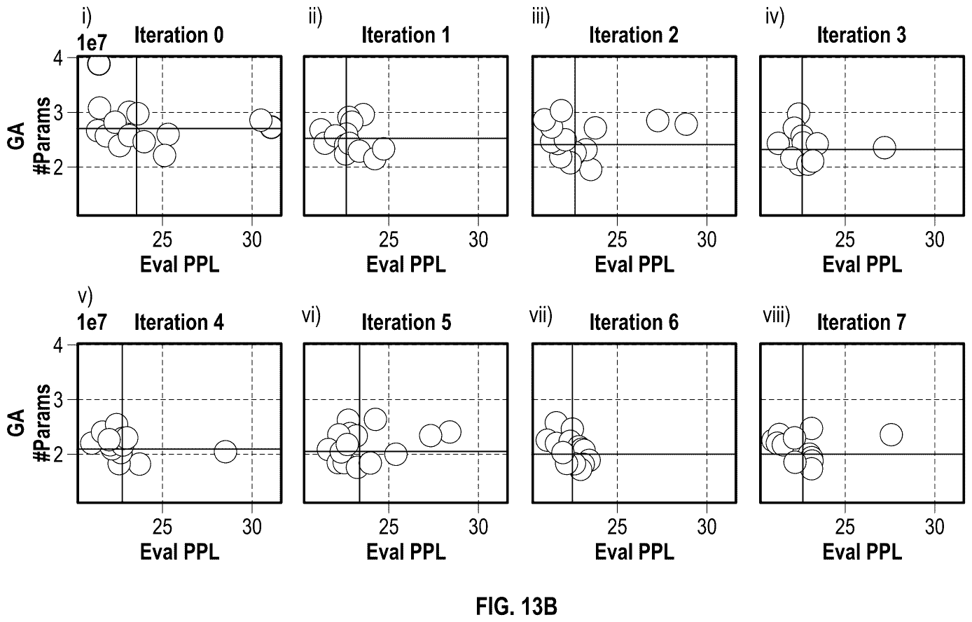

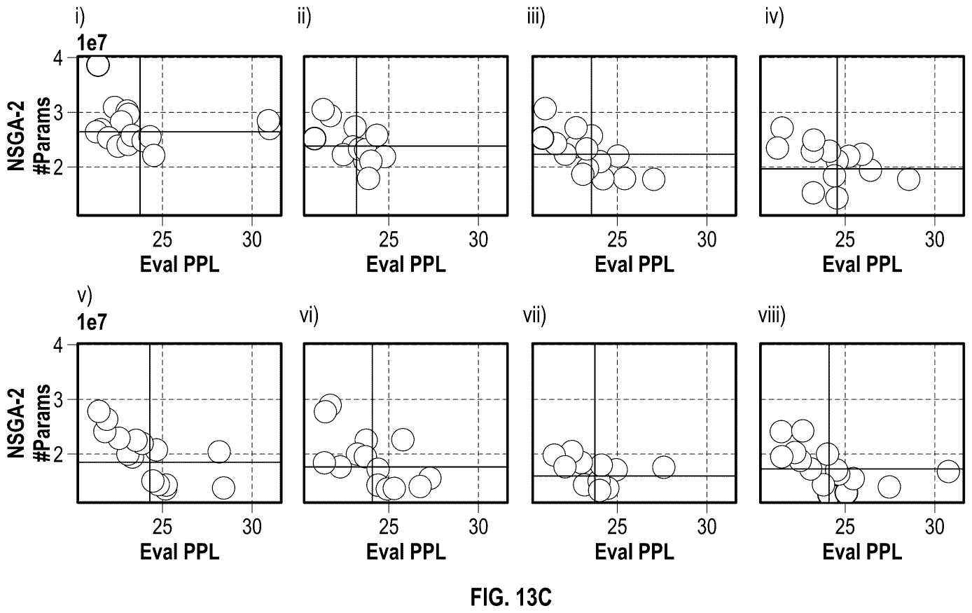

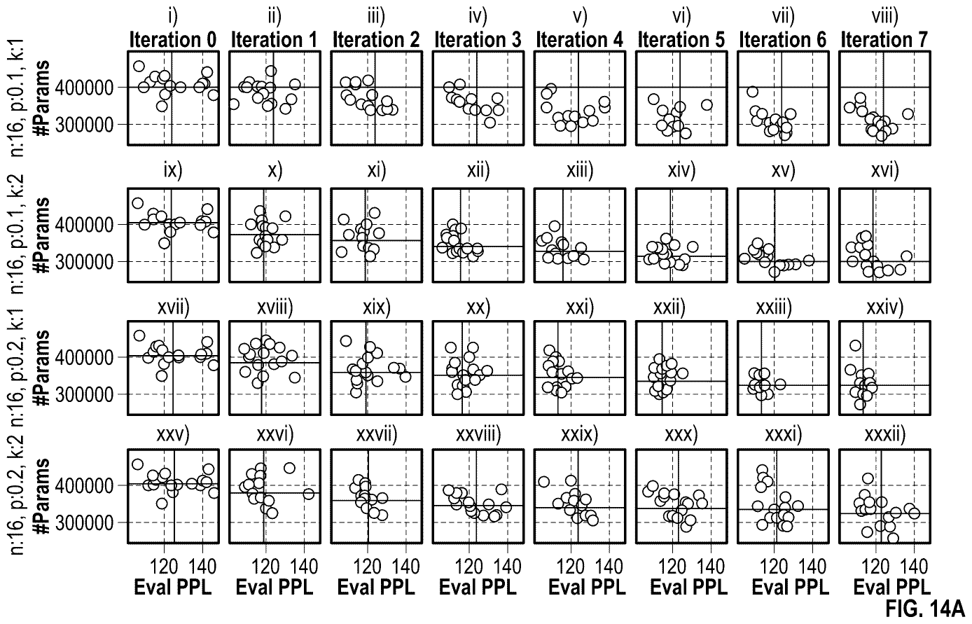

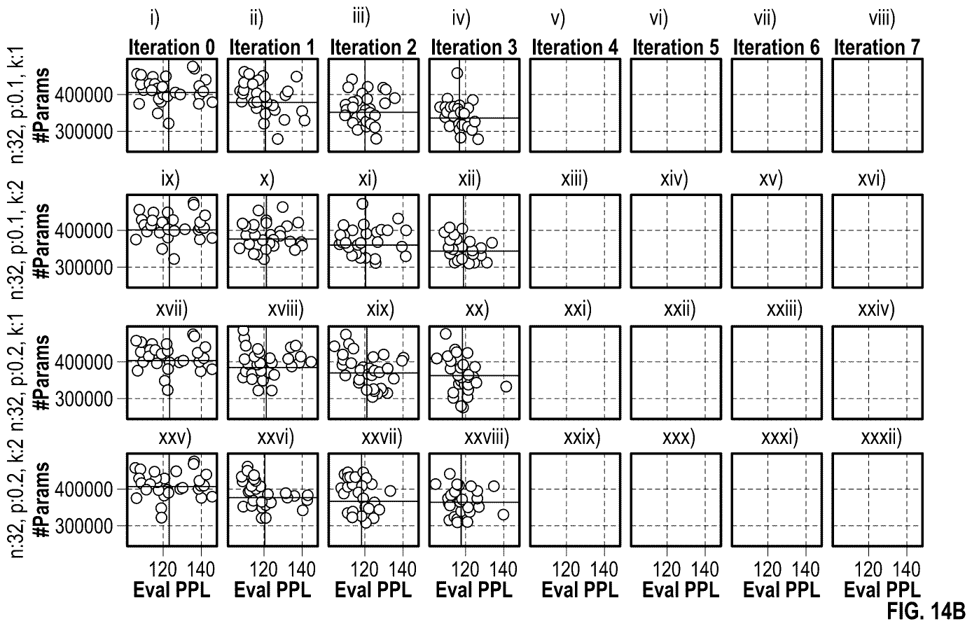

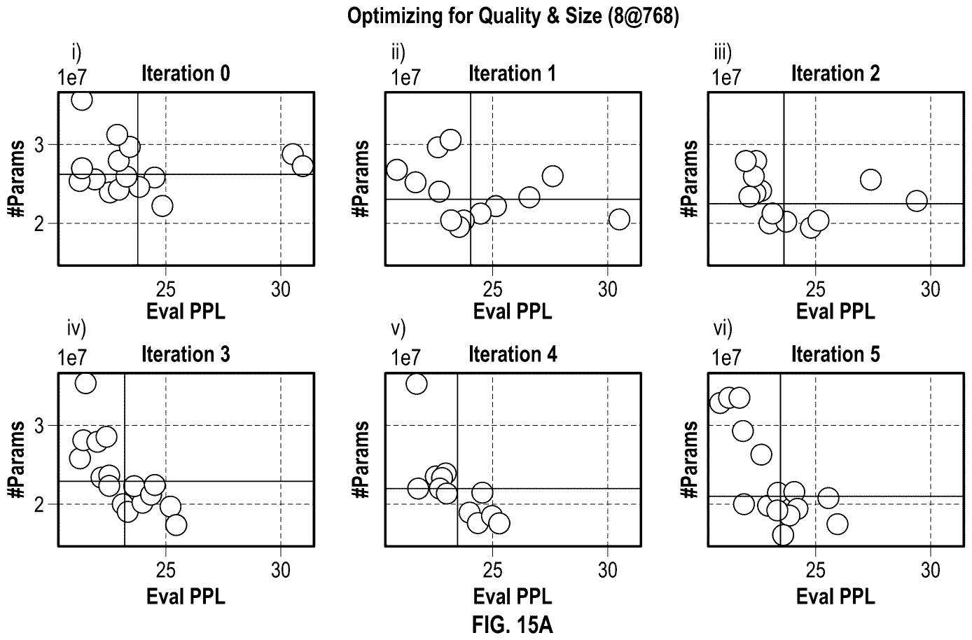

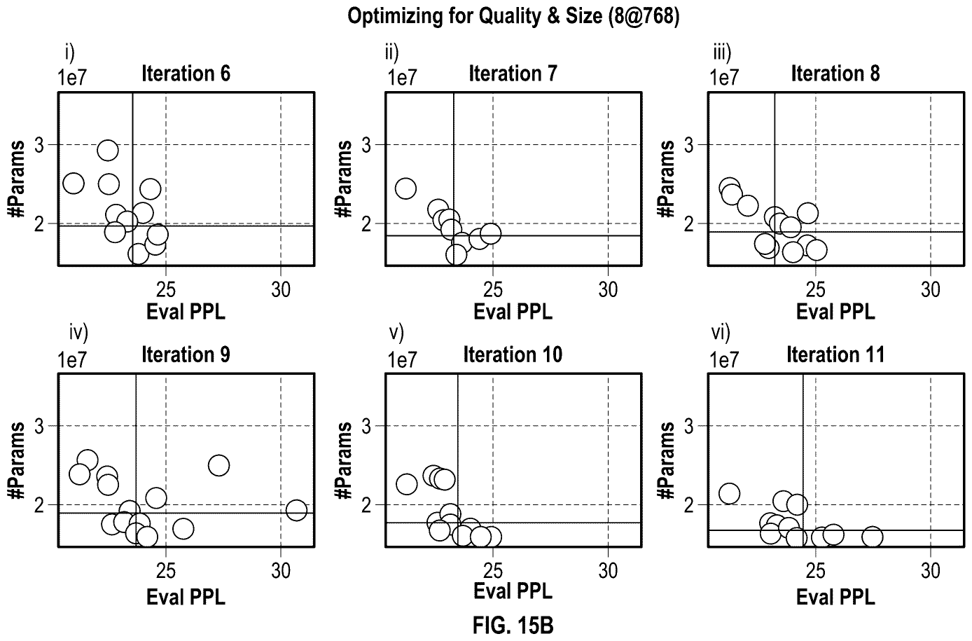

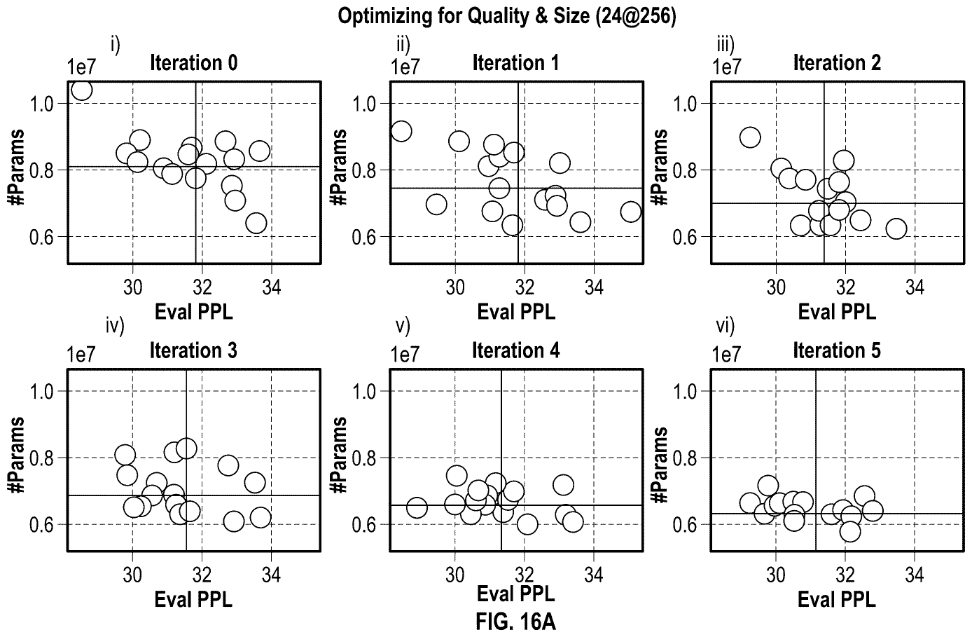

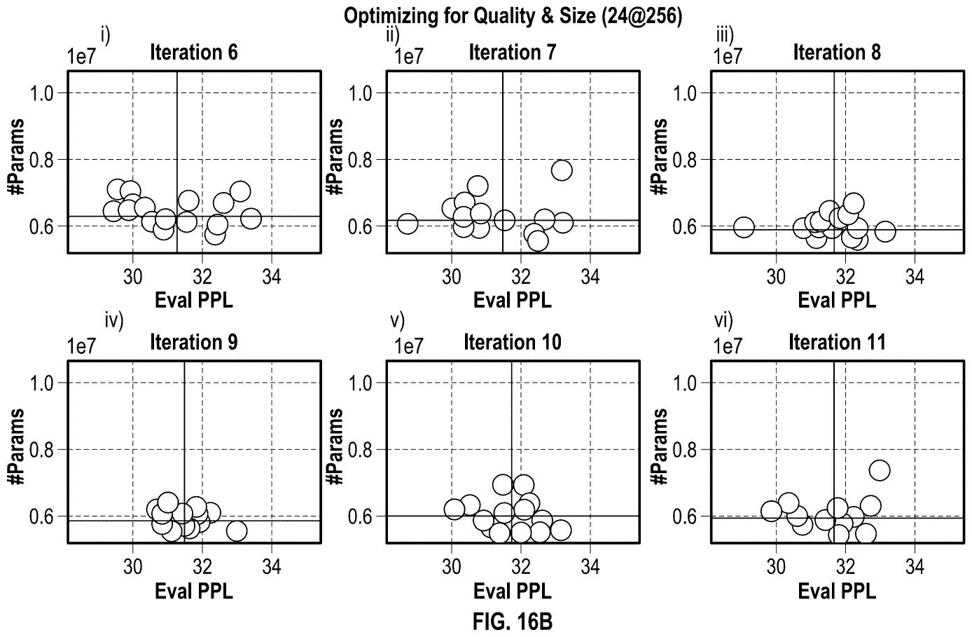

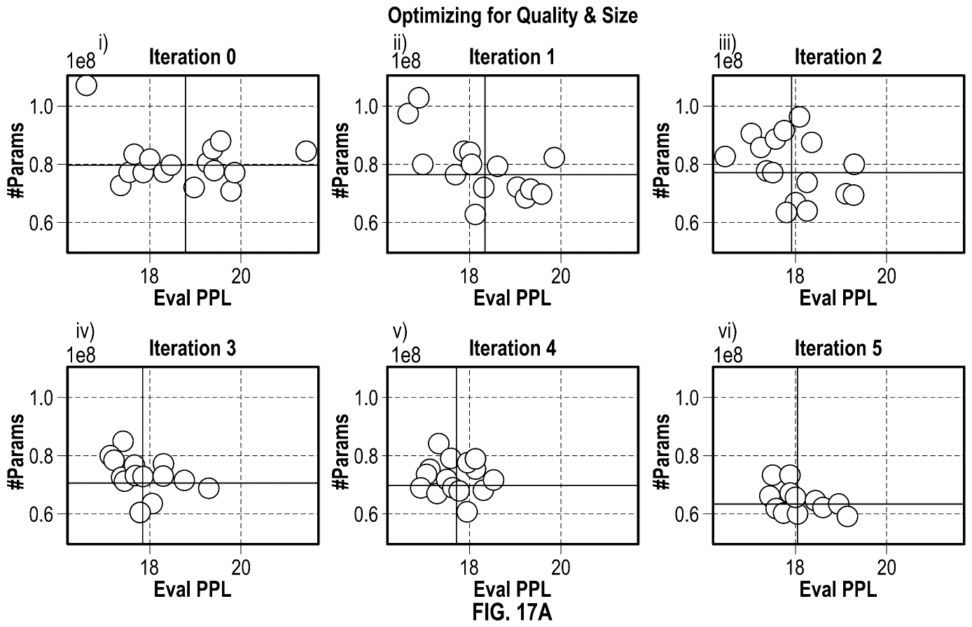

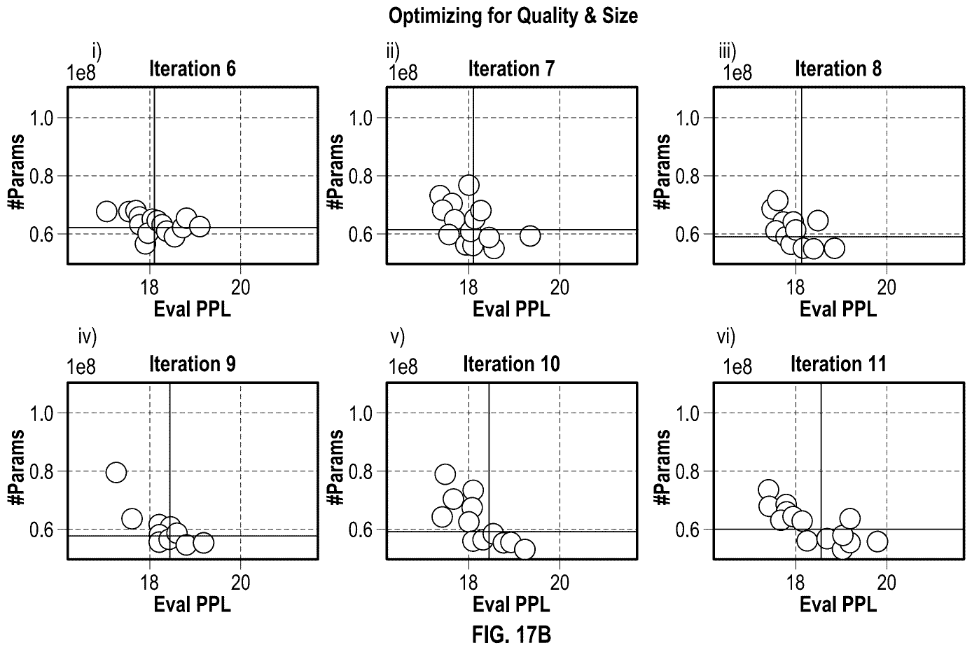

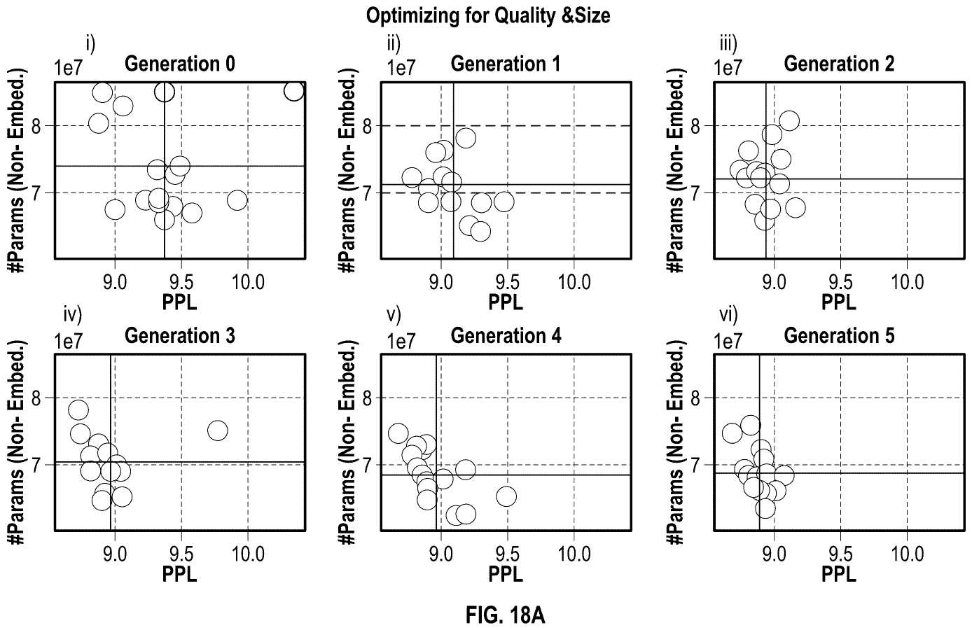

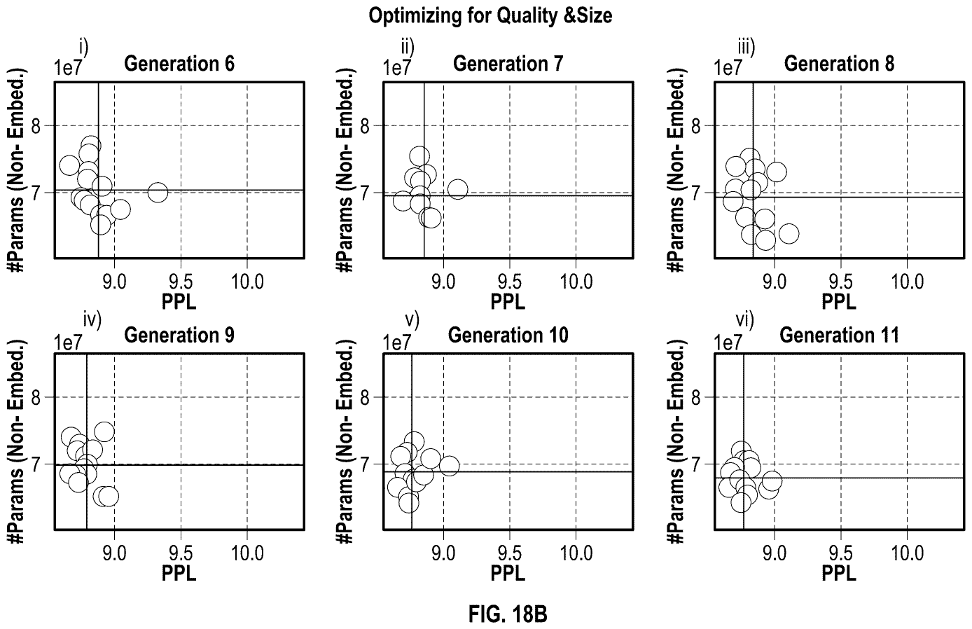

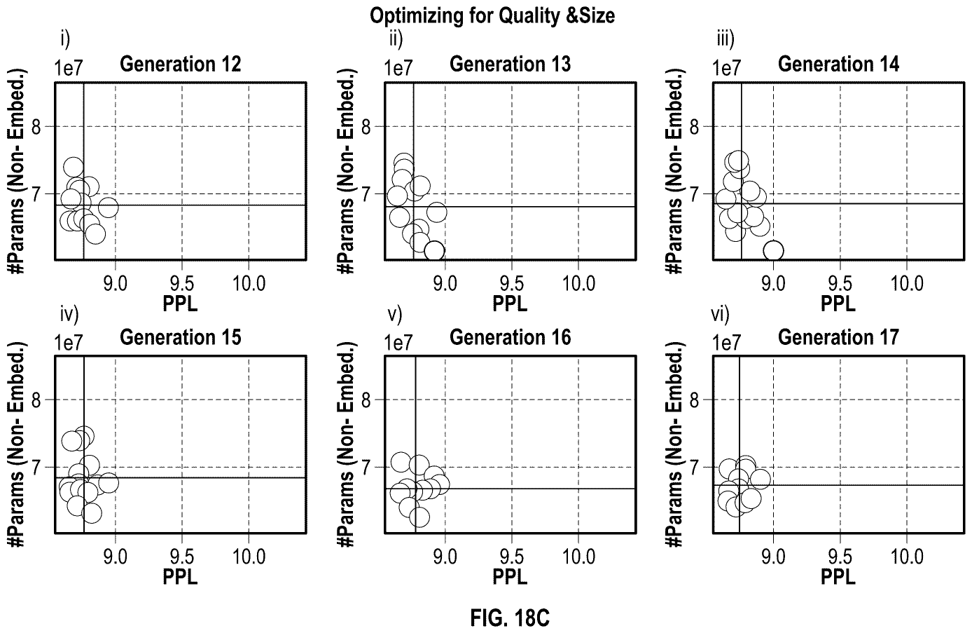

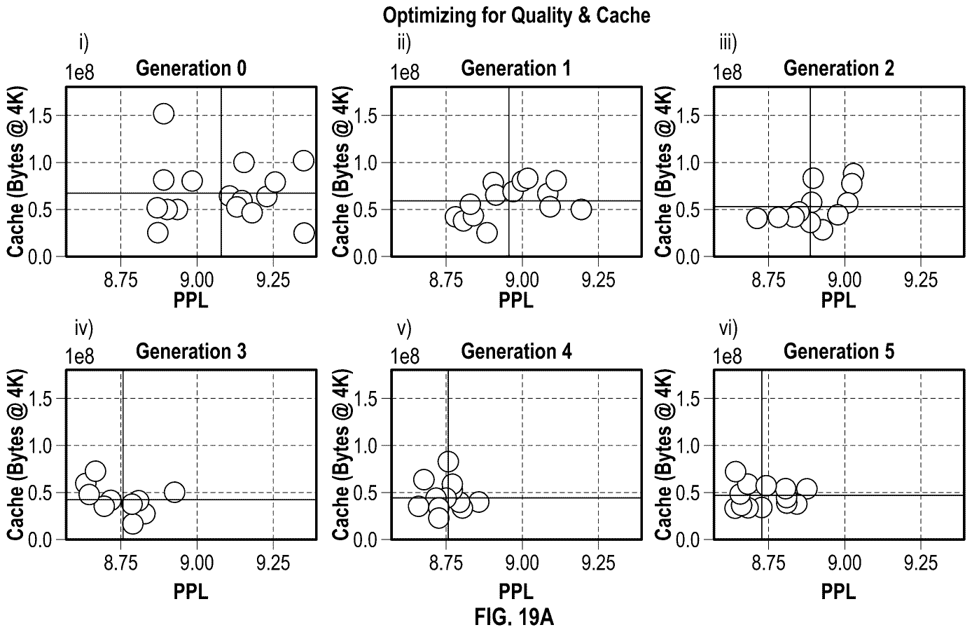

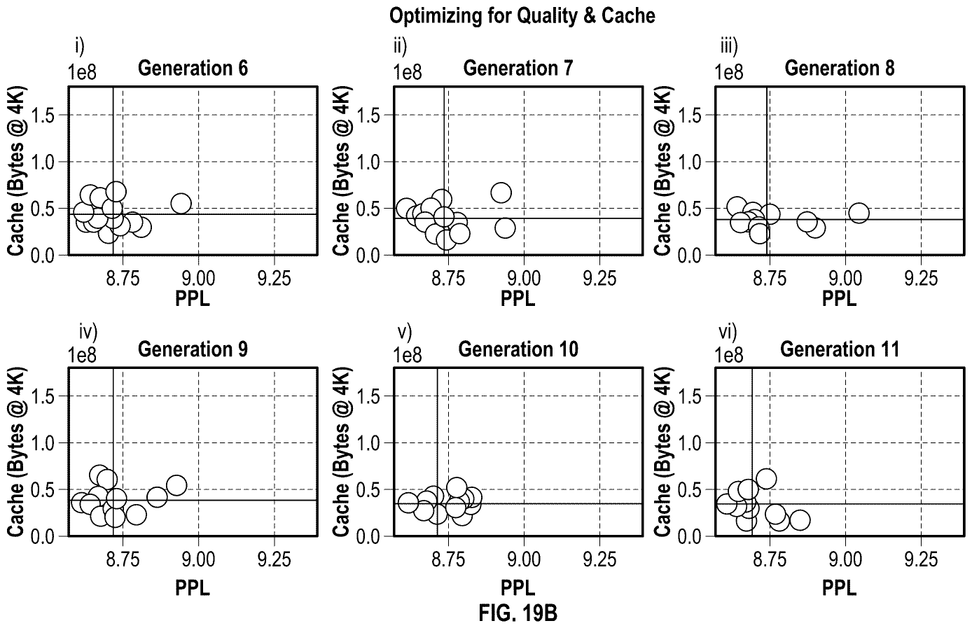

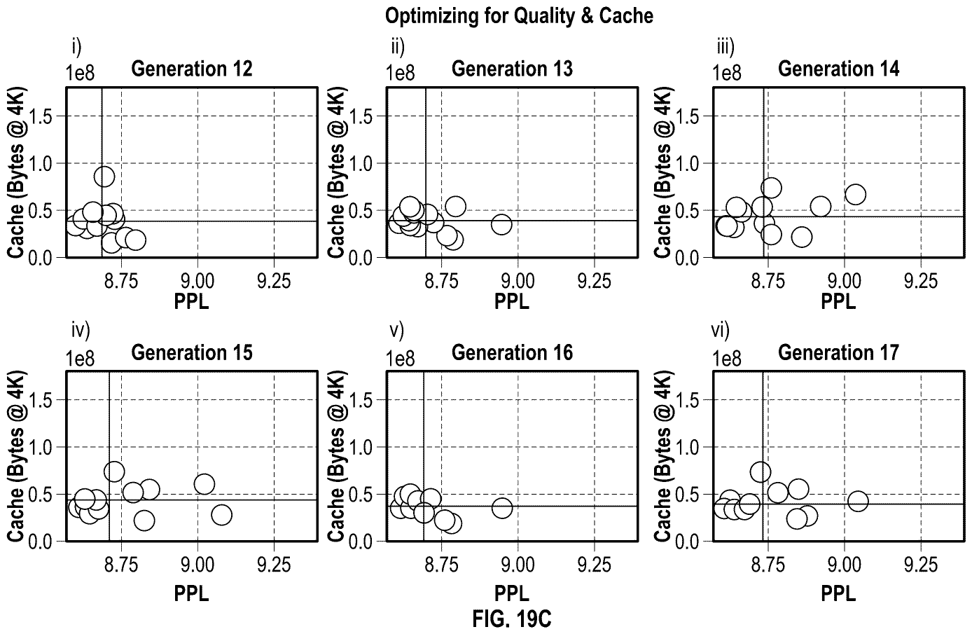

The following figures illustrate genome scores for the evolutionary algorithm techniques described herein under a variety of conditions or with regards to various experiments. FIGS. 13A-13C and 14A-14B illustrate genome scores for evolutionary algorithm ablations, according to some examples. Specifically, FIG. 13A illustrates genome scores for FA, FIG. 13B illustrates genome scores for GA, and FIG. 13C illustrates genome scores for NSGA-2. Note, the y-axis label of FIG. 13A(i) applies to FIGS. 13A(ii)-13A(iv), and the y-axis label of FIG. 13A(v) applies to FIGS. 13A(vi)-13A(viii). Similarly, the y-axis label of FIG. 13B (i) applies to FIGS. 13B(ii)-13B(iv), and the y-axis label of FIG. 13B(v) applies to FIGS. 13B(vi)-13B(viii). The y-axis label of FIG. 13C (i) applies to FIGS. 13C (ii)-13C (iv), and the y-axis label of FIG. 13C (v) applies to FIGS. 13C (vi)-13C (viii). FIGS. 14A-14B illustrate genome scores for various hyper-parameter settings of NSGA-2. Note, the y-axis label of FIG. 14A(i) applies to FIGS. 14A(ii)-14A(viii), the y-axis label of FIG. 14A(ix) applies to FIGS. 14A (x)-14A (xvi), the y-axis label of FIG. 14A (xvii) applies to FIGS. 14A (xviii)-14A (xxiv), and the y-axis label of FIG. 14A (xxv) applies to FIGS. 14A (xxvi)-14A (xxxii). Similarly, the y-axis label of FIG. 14B (i) applies to FIGS. 14B (ii)-14B (viii), the y-axis label of FIG. 14B (ix) applies to FIGS. 14B(x)-14B(xvi), the y-axis label of FIG. 14B(xvii) applies to FIGS. 14B(xviii)-14B(xxiv), and the y-axis label of FIG. 14B(xxv) applies to FIGS. 14B(xxvi)-14B(xxxii). FIGS. 15A-17B illustrate genome scores for a comparison of synthesis scales, according to some examples. Specifically, FIGS. 15A-15B illustrate genome scores, when optimizing for quality and size, for backbones that include 8 LIVs at a width of 768 dimensions. Note, the y-axis label of FIG. 15A(i) applies to FIGS. 15A(ii)-15A(iii), and the y-axis label of FIG. 15A(iv) applies to FIGS. 15A(v)-15A(vi). FIGS. 16A-16B illustrate genome scores, when optimizing for quality and size, for backbones that include 24 LIVs at a width of 256 dimensions. FIGS. 17A-17B illustrate genome scores, when optimizing for quality and size. FIGS. 18A-18C illustrate genome scores for quality and size optimization, according to some examples. FIGS. 19A-19C illustrate genome scores for quality and cache optimization, according to some examples.

Backbone topologies were constrained to a pre-norm residual structure, where the output y^{m} of LIV T^{m} at backbone depth m is defined as: y^{m}=T (norm (y^{m-1})) norm (y^{m-1})+y^{m-1}.

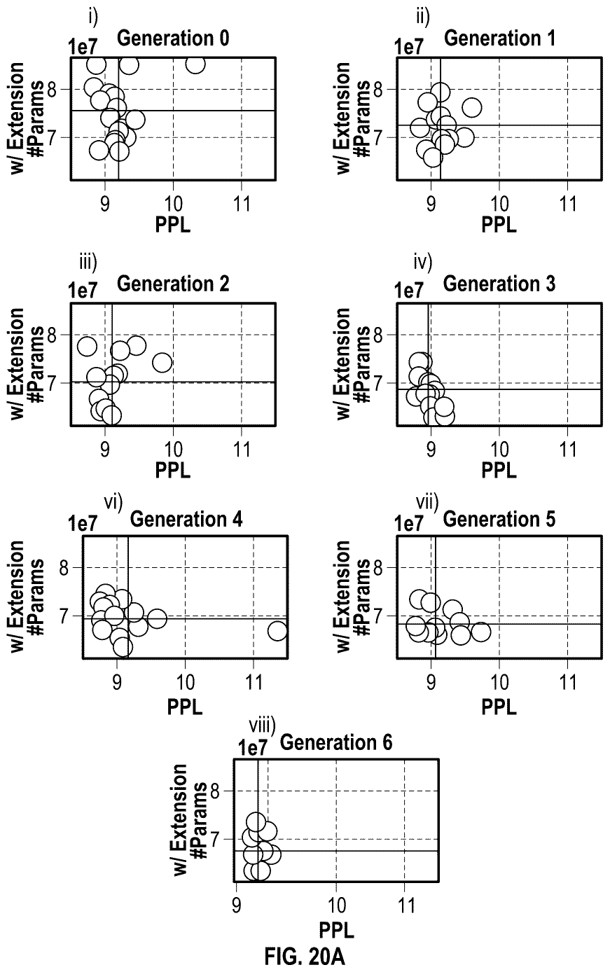

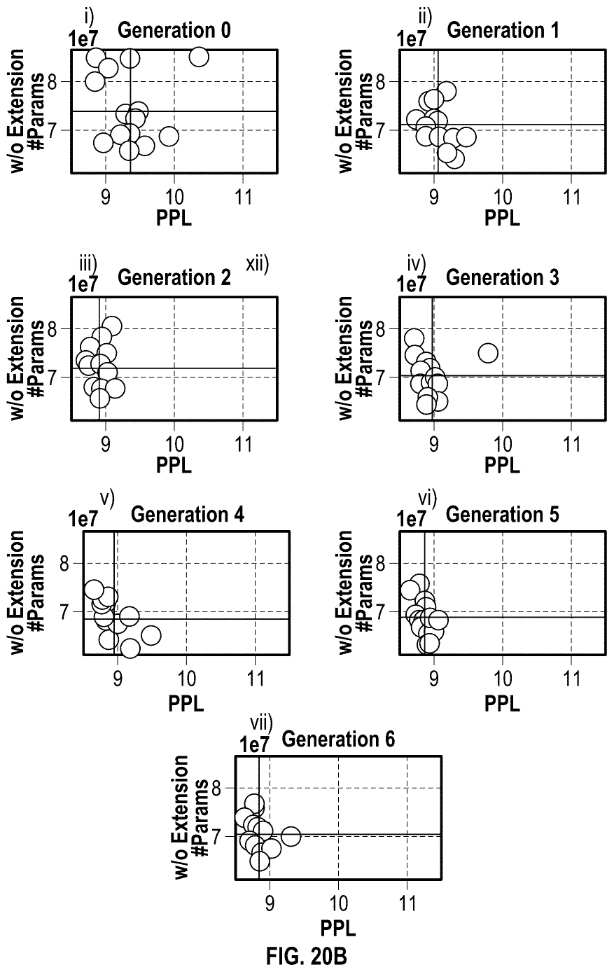

The extended backbone genome was evaluated in an ablation study by comparing the outcomes of two evolutionary algorithm techniques: one incorporating this extension and the other using the standard backbone genome. In both conditions, a population of 16 genomes was evolved for 7 generations, and each genome consisted of 24 LIVs with a width of 768 dimensions. The results indicated that the extension allows the evolutionary algorithm techniques described herein to synthesize architectures of even smaller parameter counts while maintaining the same level of quality (see FIG. 20A-FIG. 20B). FIGS. 20A-20B illustrate a comparison of two evolutionary algorithm techniques, without (FIG. 20A) and with (FIG. 20A) an extension of the backbone genome allowing for more flexible residual connections.

Table 6 illustrates an overview of the evaluation performances of the remaining 4 synthesized backbones that were selected from each evaluation and trained for longer (for comparison, see Table 1).

TABLE 6
Evaluation of backbones optimized for quality (lower half) and quality and size (upper
half). We test on LM-Eval-Harness, reporting parameter-matched Transformer++
and StripedMamba baselines trained on the same data. Size indicates trainable parameter
count, excluding embeddings layers. All models were trained for 5B tokens from RedPajama.
The bolded numbers indicate the architectures with the best performance, and the underlined
numbers indicate the architectures with the second-best performance.

| | | Cache | | Hella. | | | | | |
|---|---|---|---|---|---|---|---|---|---|
| Backbone/ | | (bytes \| | RedPj. | acc. | ARC-e | Wino. | PiQA | SciQ | |
| Optimized for | Size | 4K) | ppl ↓ | norm. ↑ | acc. ↑ | acc. ↑ | acc. ↑ | acc. ↑ | Avg. ↑ |
| Transformer++ | 85M | 150MB | 7.3 | 28.9 | 38.8 | 51.2 | 61.2 | 64.1 | 48.8 |
| StripedMamba | 80M | 25MB | 7.2 | 28.6 | 39.3 | 51.1 | 60.9 | 67.4 | 49.5 |
| Architecture- | 78M | 94MB | 7.1 | 29.2 | 39.1 | 52.1 | 62.1 | 72.7 | 51.0 |
| 5/Quality | | | | | | | | | |
| Architecture- | 79M | 94MB | 7.1 | 29.0 | 39.9 | 50.9 | 61.7 | 71.1 | 50.5 |
| 6/Quality | | | | | | | | | |
| Architecture- | 79M | 107MB | 7.1 | 29.3 | 38.2 | 51.5 | 61.6 | 70.2 | 50.2 |
| 7/Quality | | | | | | | | | |
| Architecture- | 79M | 94MB | 7.1 | 29.1 | 40.6 | 50.8 | 62.0 | 70.3 | 50.6 |
| 8/Quality | | | | | | | | | |
| Architecture- | 78M | 64MB | 7.2 | 29.2 | 40.0 | 52.7 | 61.0 | 67.8 | 50.1 |
| 5/Q. + Size | | | | | | | | | |
| Architecture- | 73M | 104MB | 7.2 | 27.7 | 39.5 | 53.1 | 61.6 | 69.4 | 50.3 |
| 6/Q. + Size | | | | | | | | | |
| Architecture- | 69M | 170MB | 7.2 | 27.8 | 39.2 | 49.9 | 61.2 | 69.5 | 49.5 |
| 7/Q. + Size | | | | | | | | | |
| Architecture- | 72M | 92MB | 7.2 | 27.5 | 39.2 | 51.7 | 61.8 | 64.1 | 48.9 |
| 8/Q. + Size | | | | | | | | | |
| Architecture- | 79M | 22MB | 7.2 | 28.9 | 40.0 | 50.2 | 61.1 | 69.1 | 49.9 |
| 5/Q. + Cache | | | | | | | | | |
| Architecture- | 68M | 25MB | 7.2 | 29.1 | 40.0 | 51.3 | 60.9 | 68.7 | 50.0 |
| 6/Q. + Cache | | | | | | | | | |
| Architecture- | 75M | 22MB | 7.3 | 28.6 | 39.4 | 52.6 | 61.0 | 66.6 | 49.6 |
| 7/Q. + Cache | | | | | | | | | |
| Architecture- | 74M | 16MB | 7.3 | 28.8 | 38.8 | 51.2 | 61.0 | 67.0 | 49.4 |
| 8/Q. + Cache | | | | | | | | | |

### Visualization and Analysis of Architecture Backbones

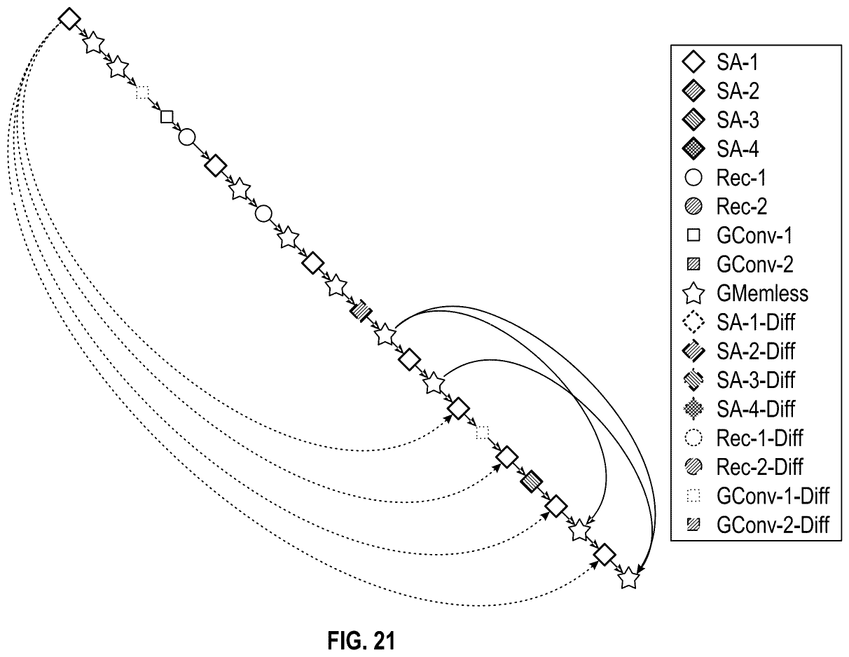

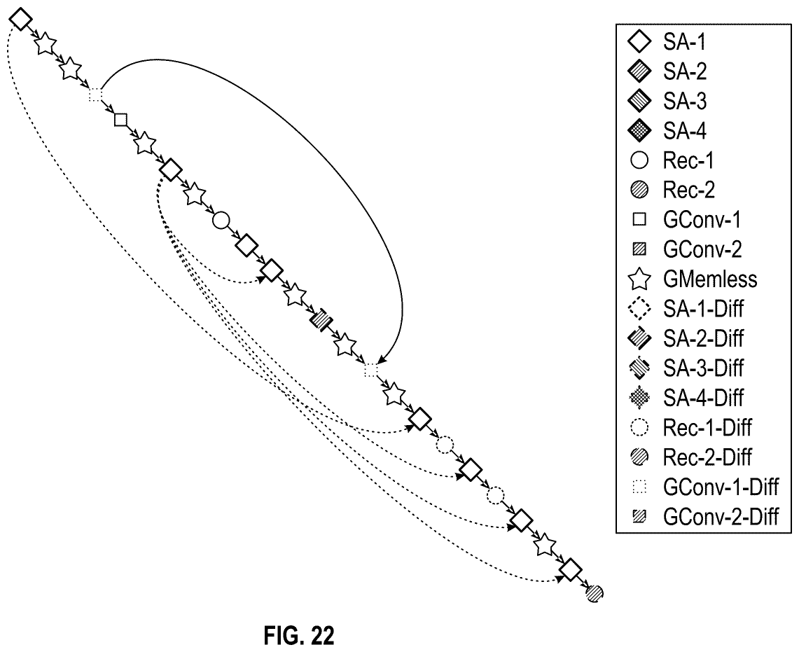

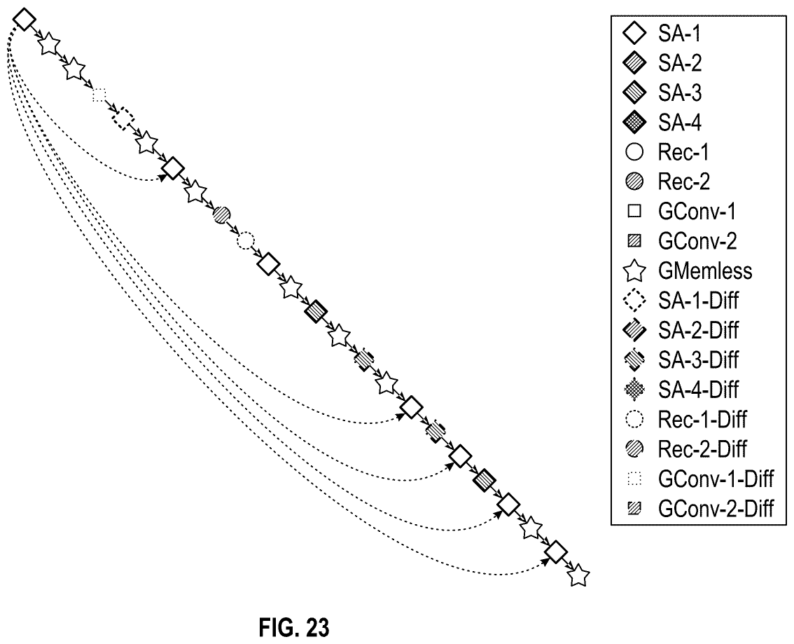

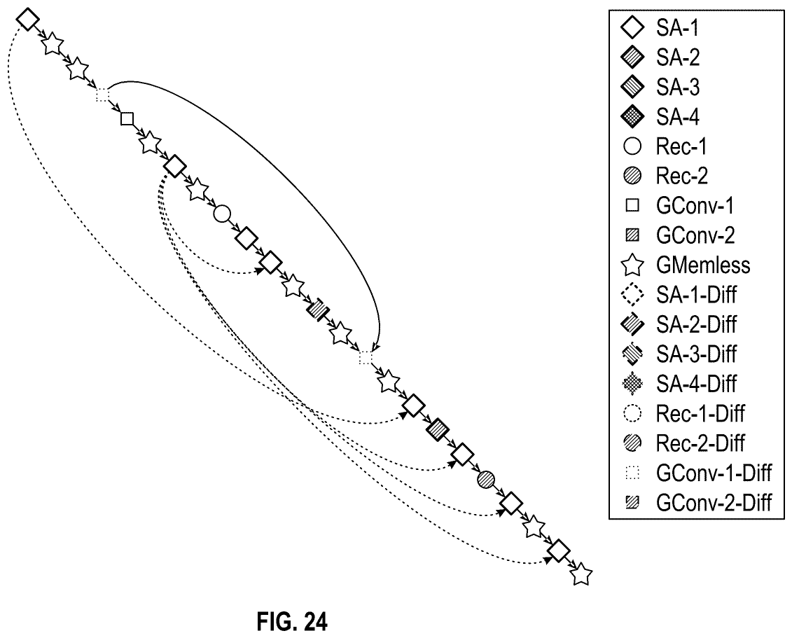

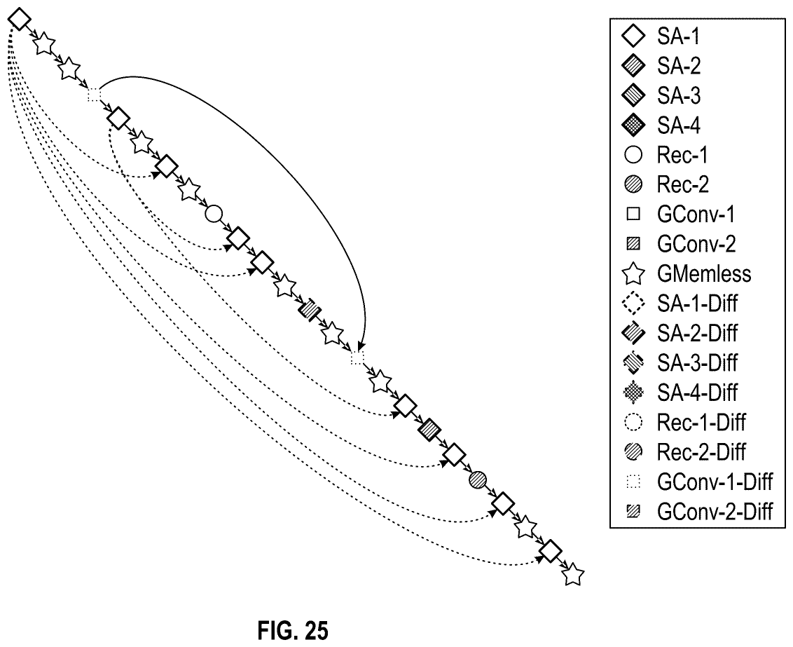

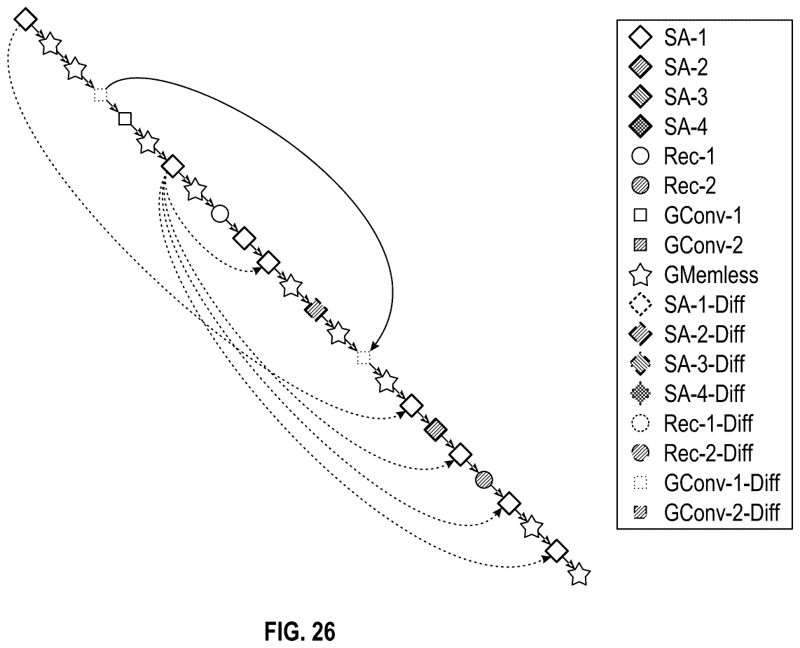

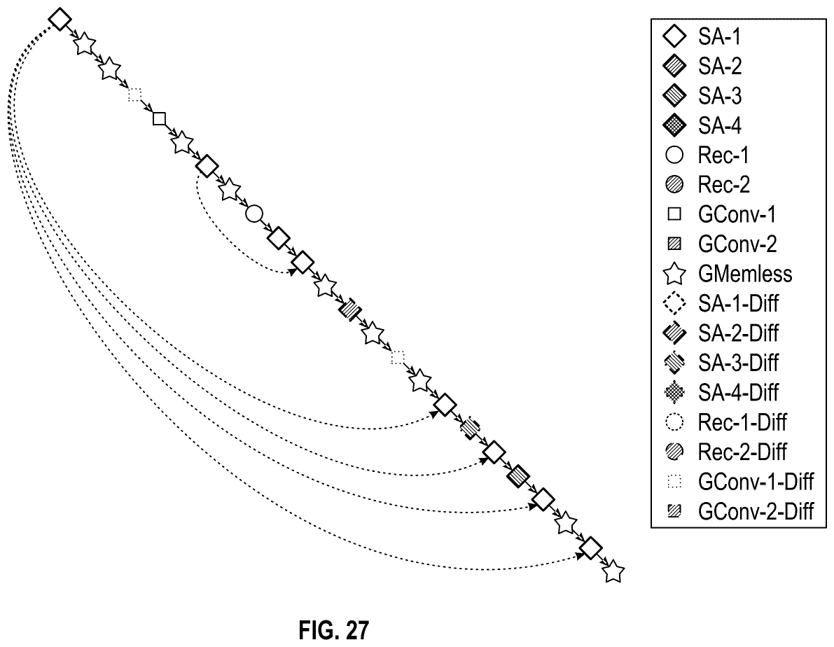

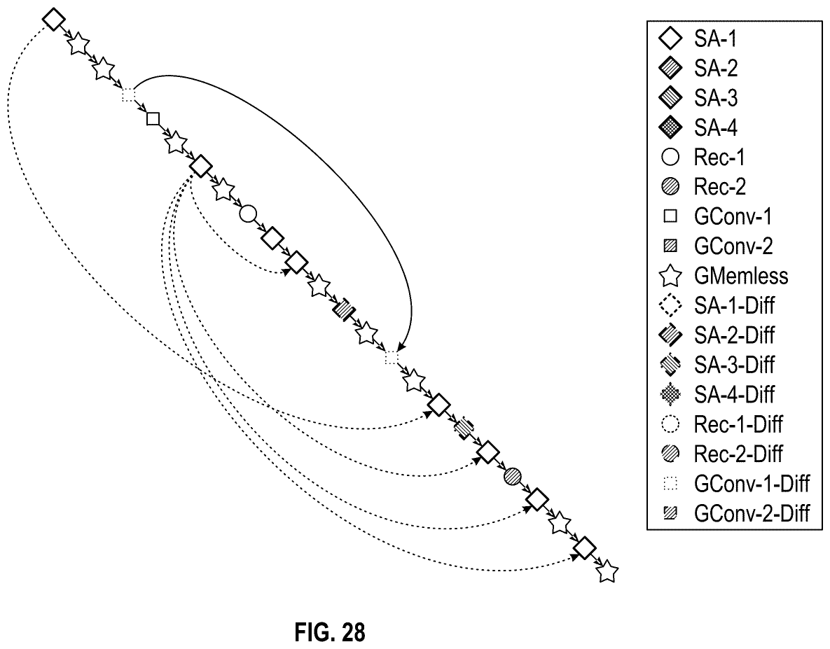

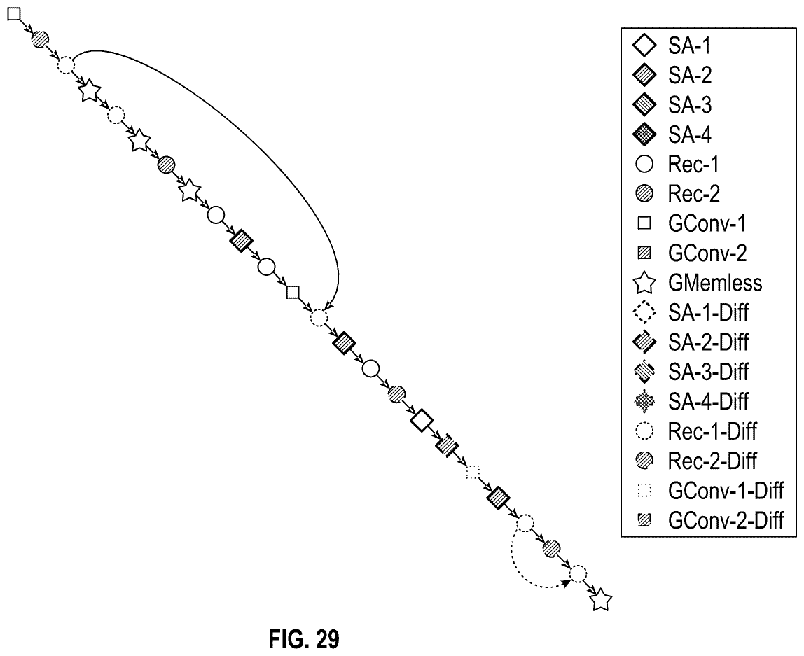

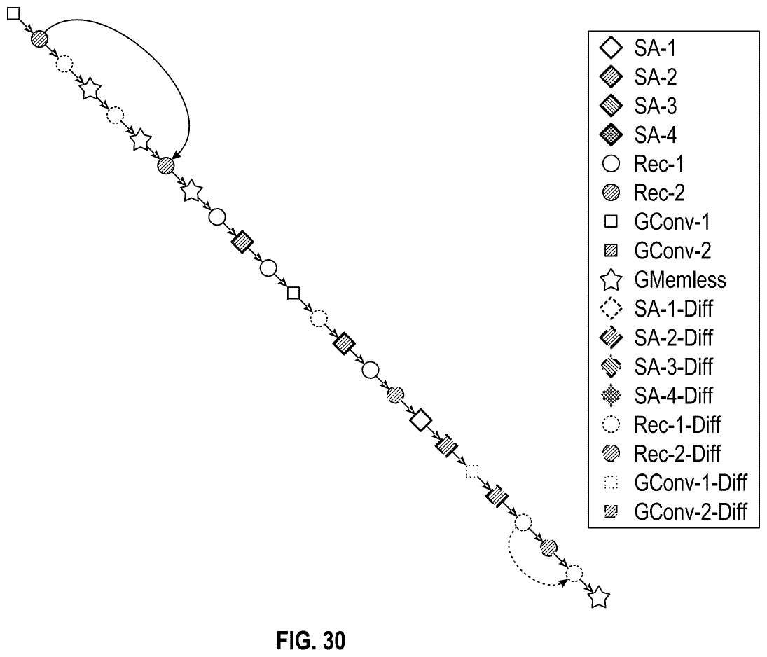

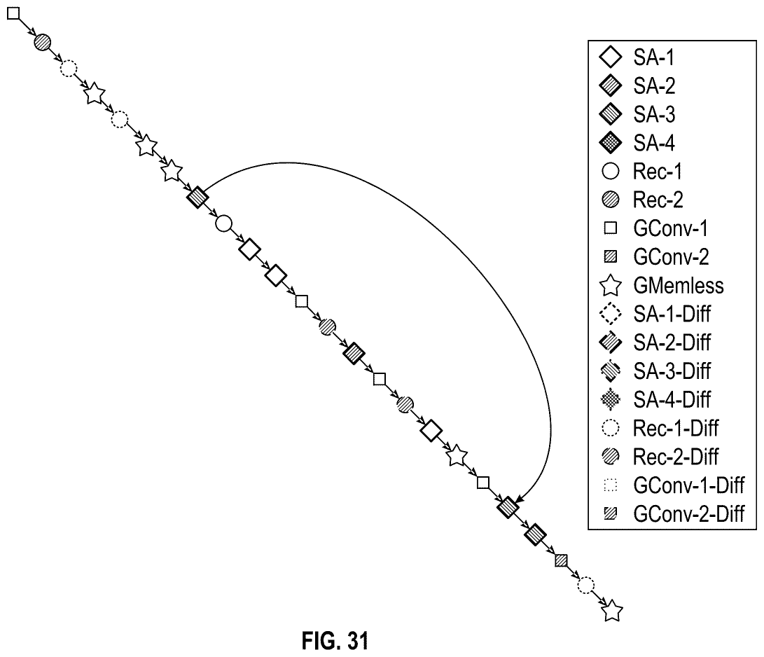

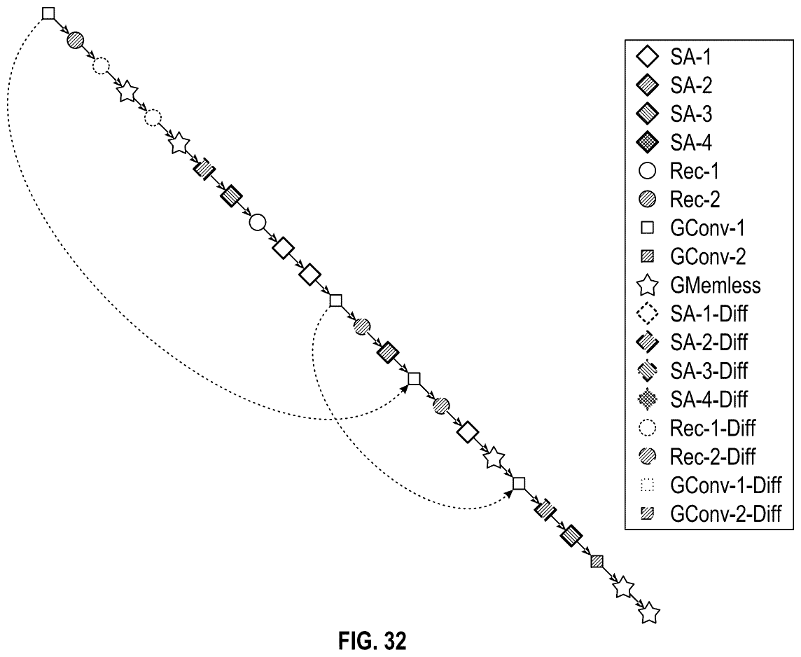

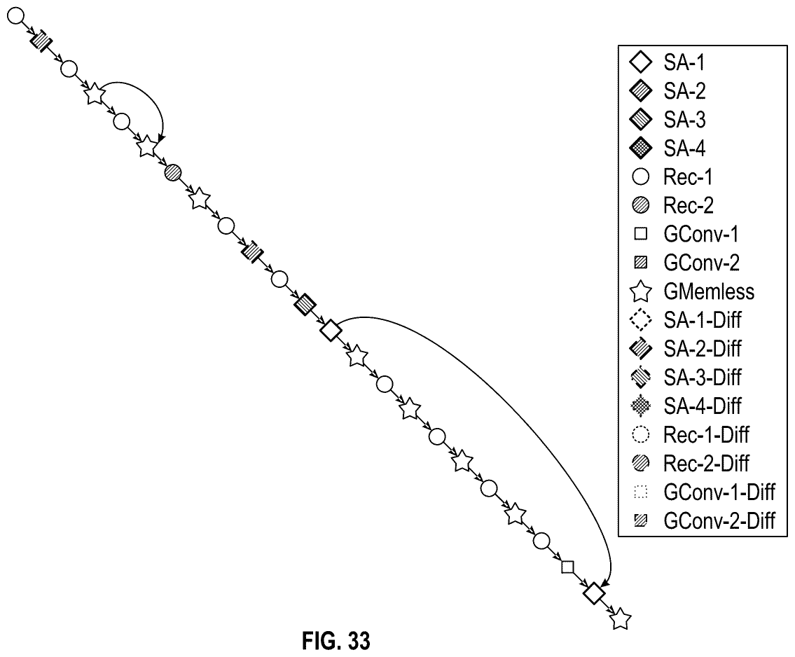

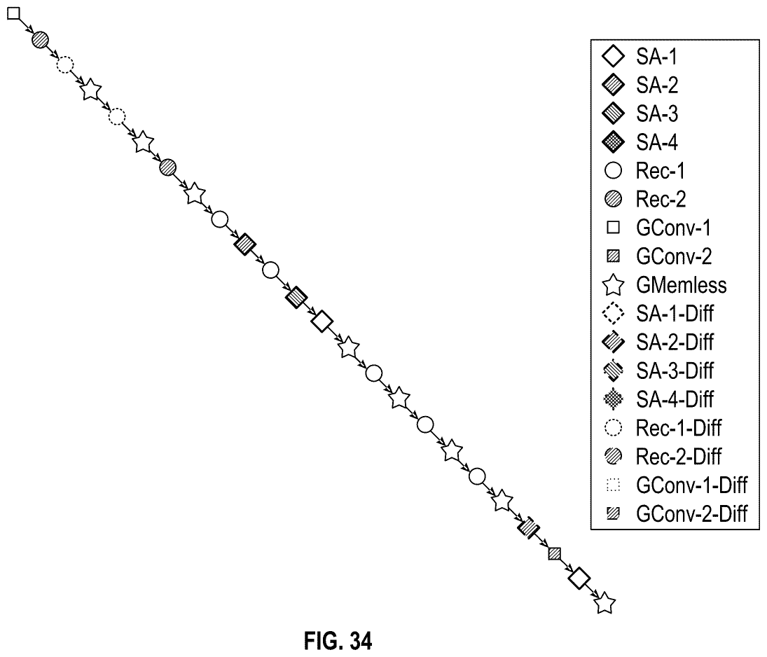

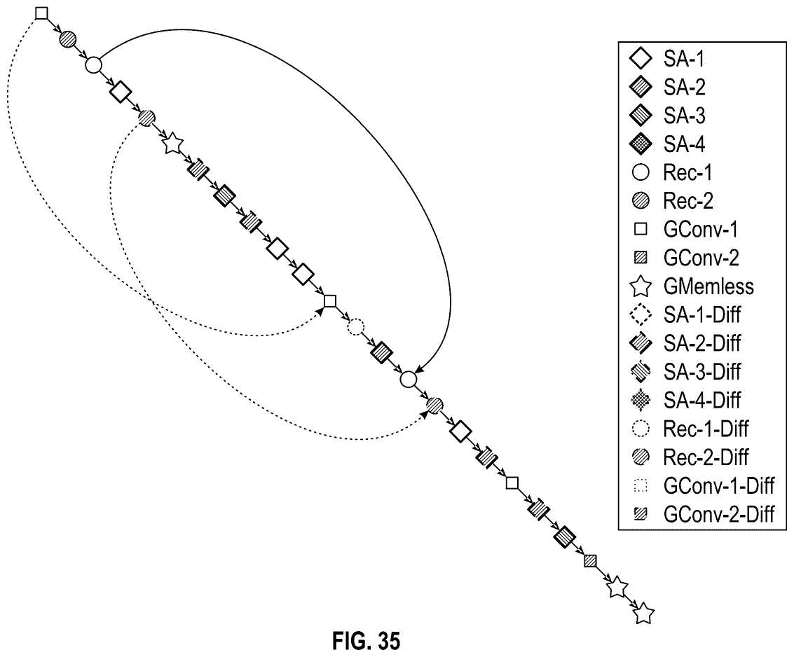

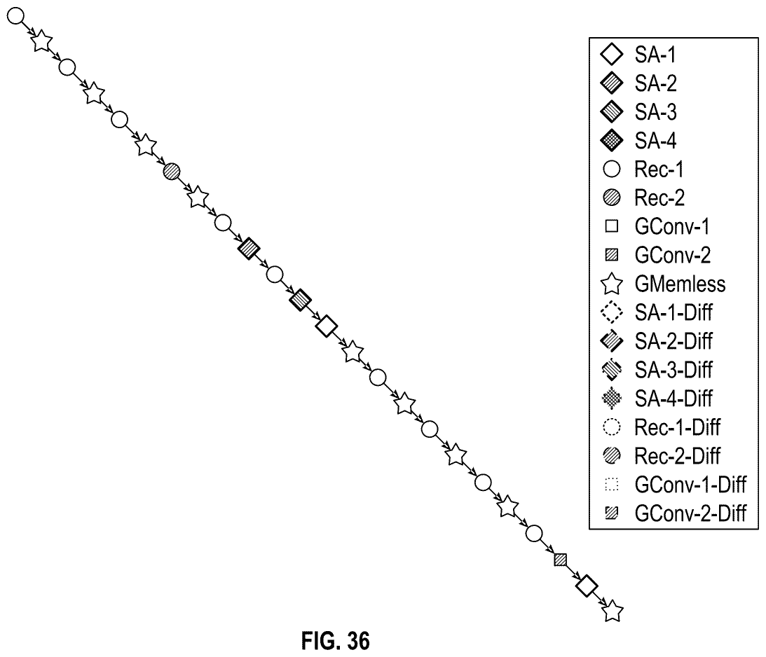

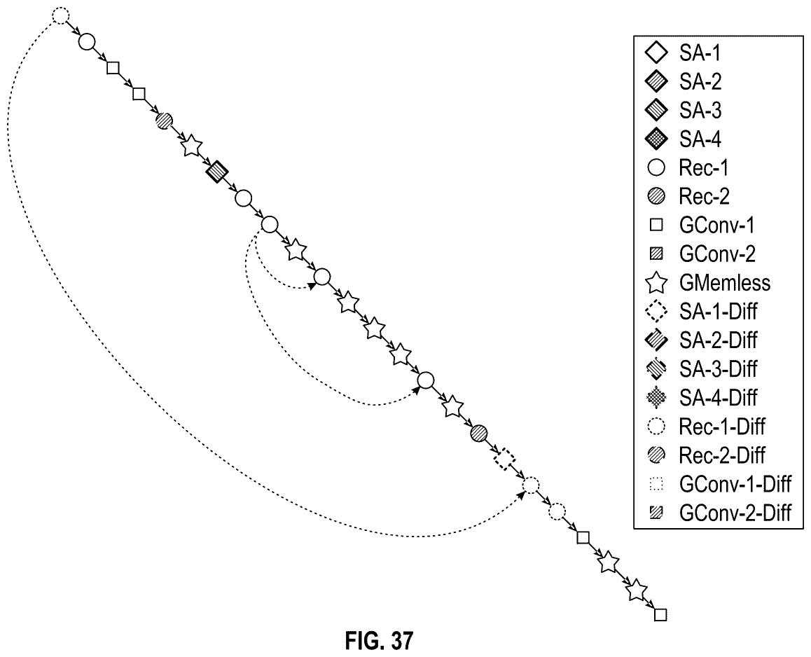

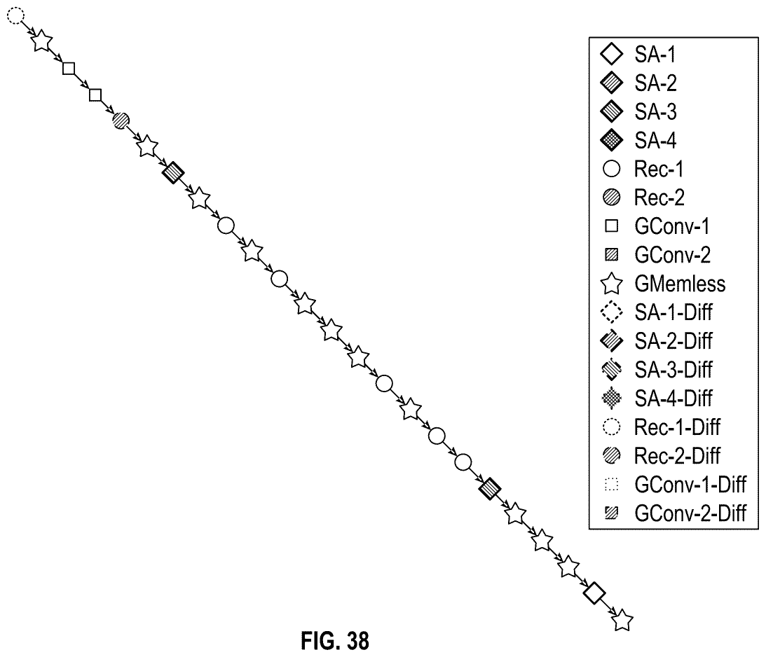

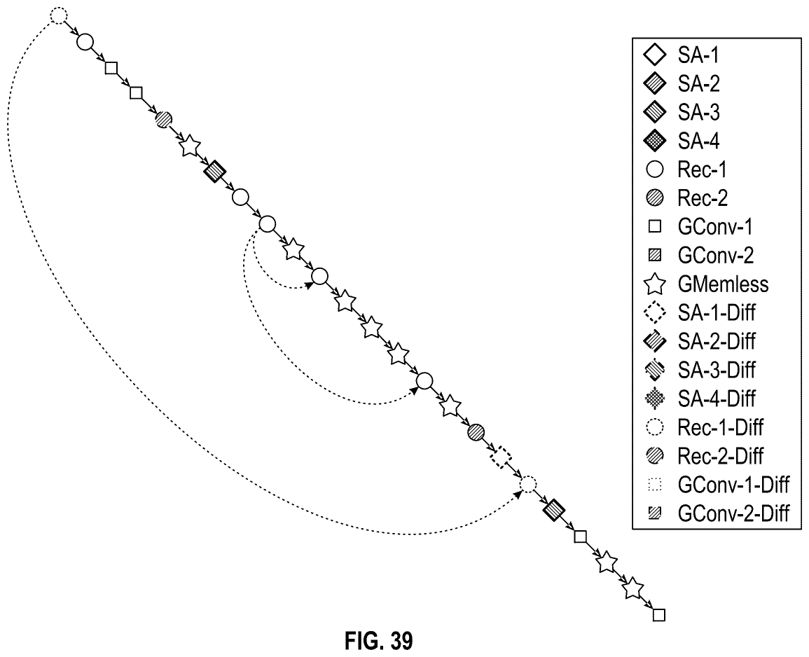

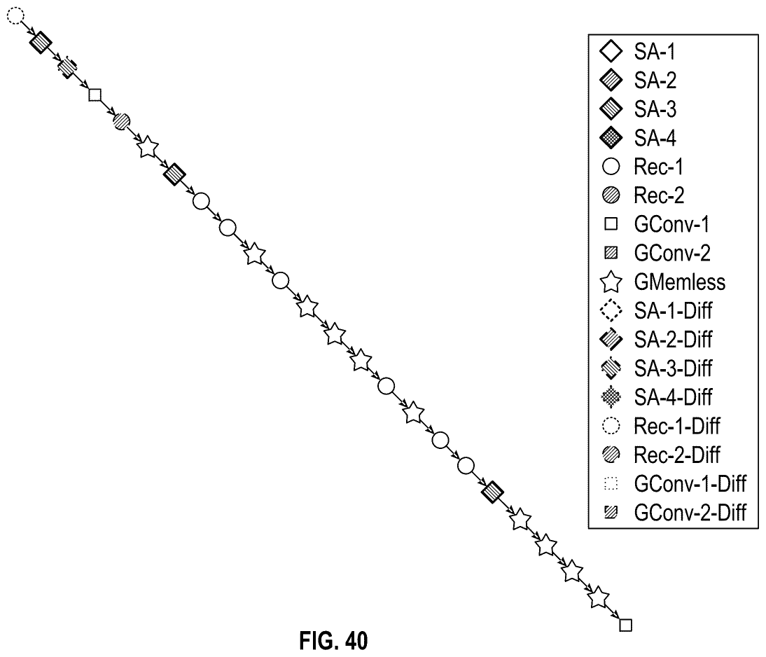

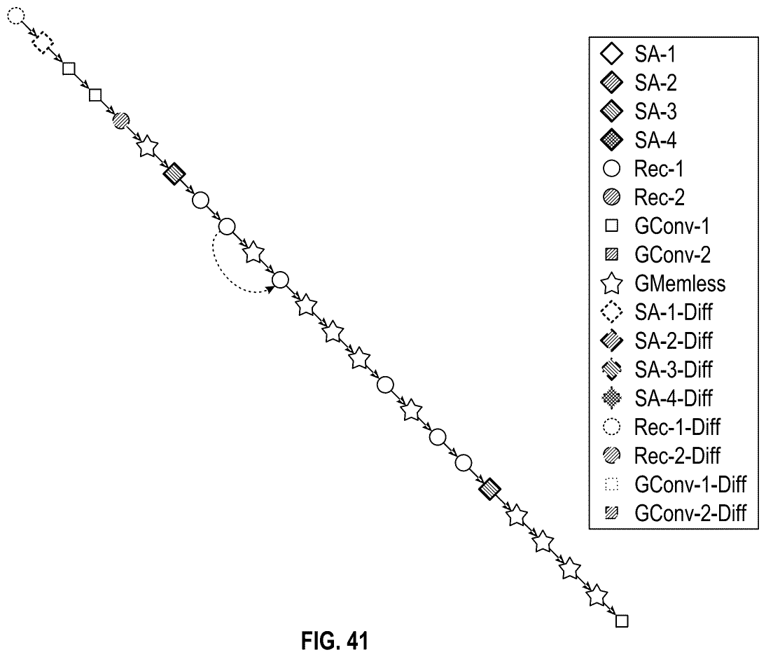

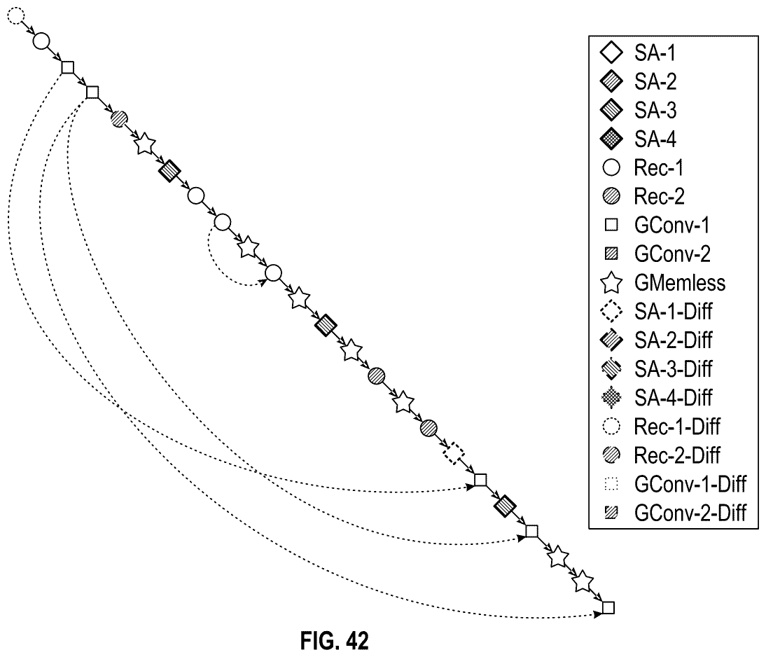

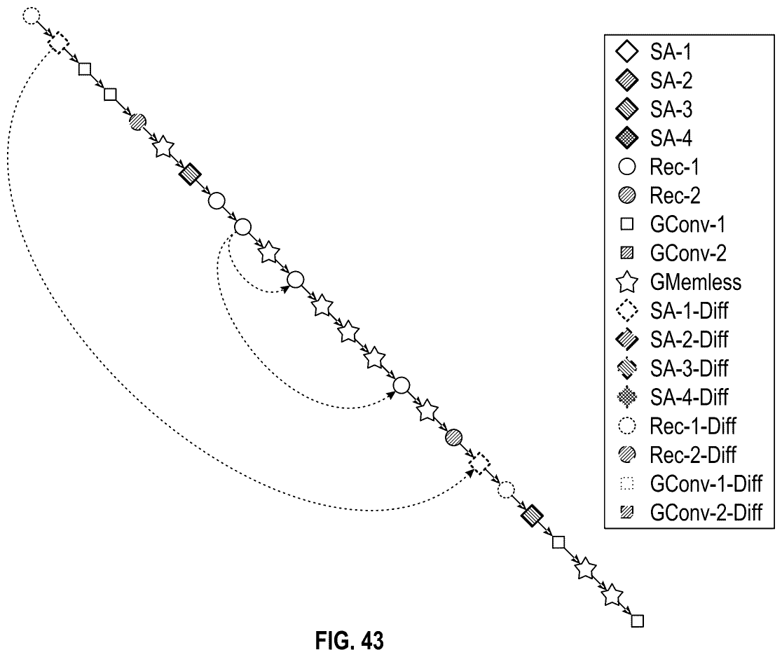

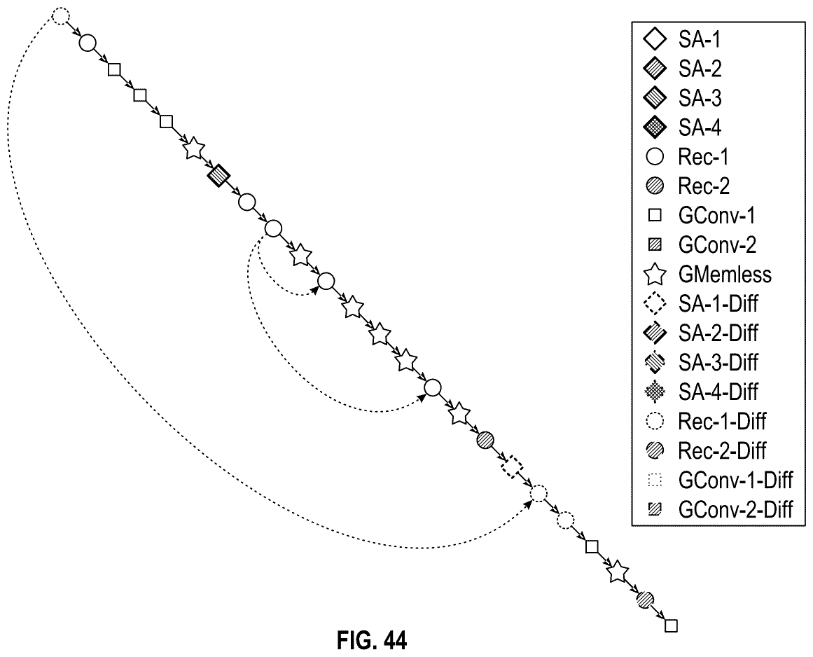

The following figures illustrate the architecture backbones presented in Tables 1, 2, and 6. In the following figures, featurizer sharing between operators is indicated as solid black arrows on the right and feature group sharing is indicated as dashed black arrows on the left. FIGS. 21-28 illustrate direct quality optimization of the architecture backbones. Specifically, FIG. 21 illustrates a representation of a model architecture referred to as Architecture-1 optimized for quality (see Table 1). FIG. 22 illustrates a representation of a model architecture referred to as Architecture-2 optimized for quality (see Table 1). FIG. 23 illustrates a representation of a model architecture referred to as Architecture-3 optimized for quality (see Table 1). FIG. 24 illustrates a representation of a model architecture referred to as Architecture-4 optimized for quality (see Table 1). FIG. 25 illustrates a representation of a model architecture referred to as Architecture-5 optimized for quality (see Table 6). FIG. 26 illustrates a representation of a model architecture referred to as Architecture-6 optimized for quality (scc Table 6). FIG. 27 illustrates a representation of a model architecture referred to as Architecture-7 optimized for quality (see Table 6). FIG. 28 illustrates a representation of a model architecture referred to as Architecture-8 optimized for quality (see Table 6). FIGS. 29-36 illustrate quality and size optimization of the architecture backbones. FIG. 29 illustrates Architecture-1 optimized for quality and size (see Table 1). FIG. 30 illustrates Architecture-2 optimized for quality and size (see Table 1). FIG. 31 illustrates Architecture-3 optimized for quality and size (see Table 1). FIG. 32 illustrates Architecture-4 optimized for quality and size (see Table 1). FIG. 33 illustrates Architecture-5 optimized for quality and size (see Table 6). FIG. 34 illustrates Architecture-6 optimized for quality and size (see Table 6). FIG. 35 illustrates Architecture-7 optimized for quality and size (see Table 6). FIG. 36 illustrates Architecture-8 optimized for quality and size (see Table 6). FIGS. 37-44 and FIG. 10 illustrate quality and cache optimization of the architecture backbones. Specifically, FIG. 37 illustrates Architecture-1 optimized for quality and cache (see Table 1). FIG. 38 illustrates Architecture-2 optimized for quality and cache (see Table 1). FIG. 39 illustrates Architecture-3 optimized for quality and cache (see Table 1). FIG. 40 illustrates Architecture-4 optimized for quality and cache (see Table 1). FIG. 41 illustrates Architecture-5 optimized for quality and cache (see Table 6). FIG. 42 illustrates Architecture-6 optimized for quality and cache (see Table 6). FIG. 43 illustrates Architecture-7 optimized for quality and cache (see Table 6). FIG. 44 illustrates Architecture-8 optimized for quality and cache (see Table 6).

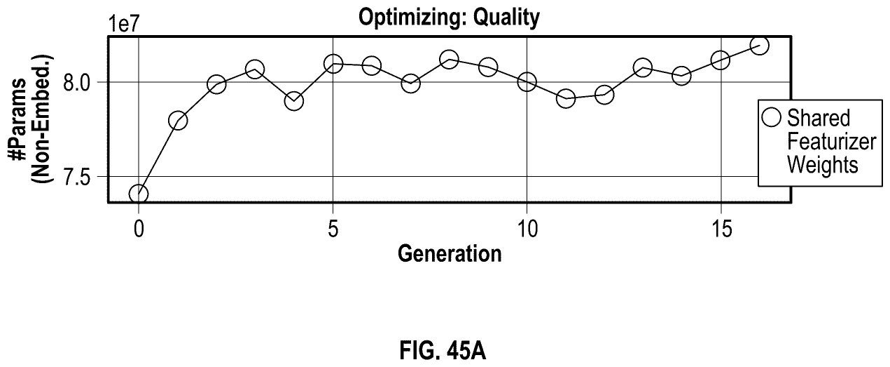

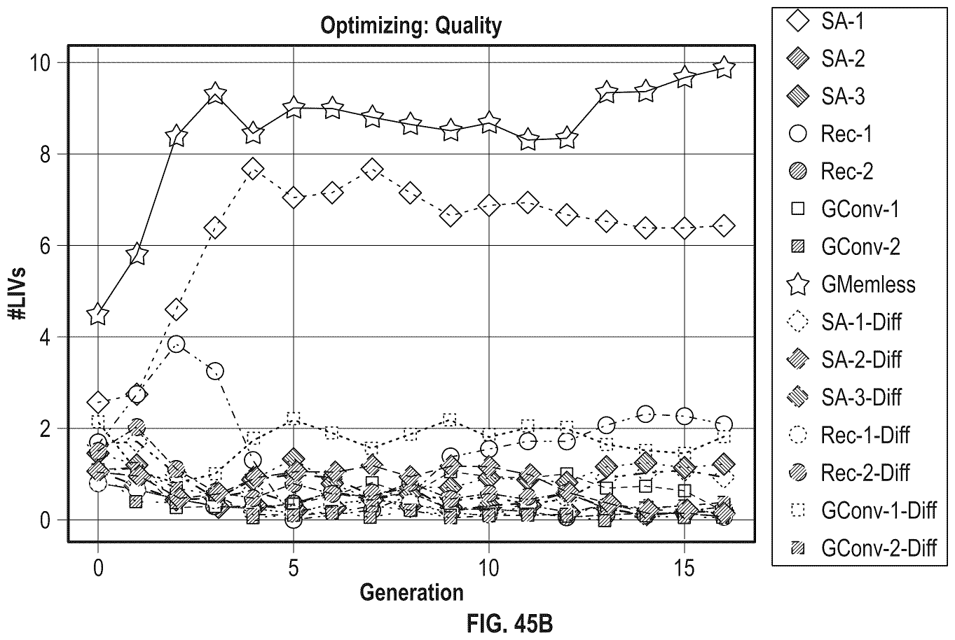

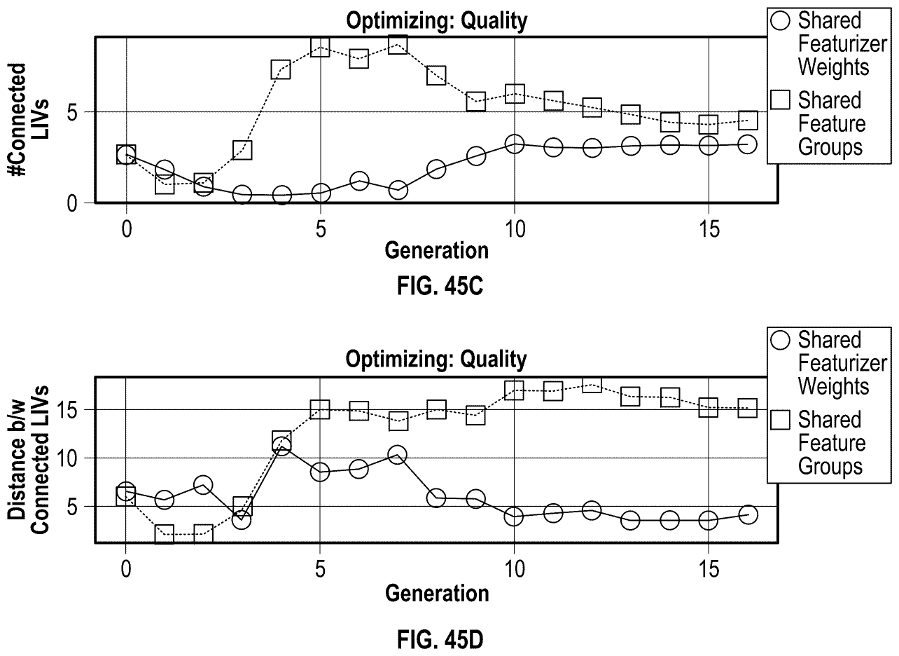

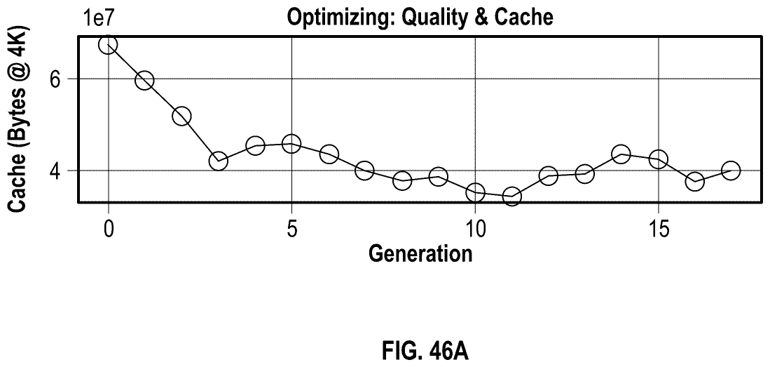

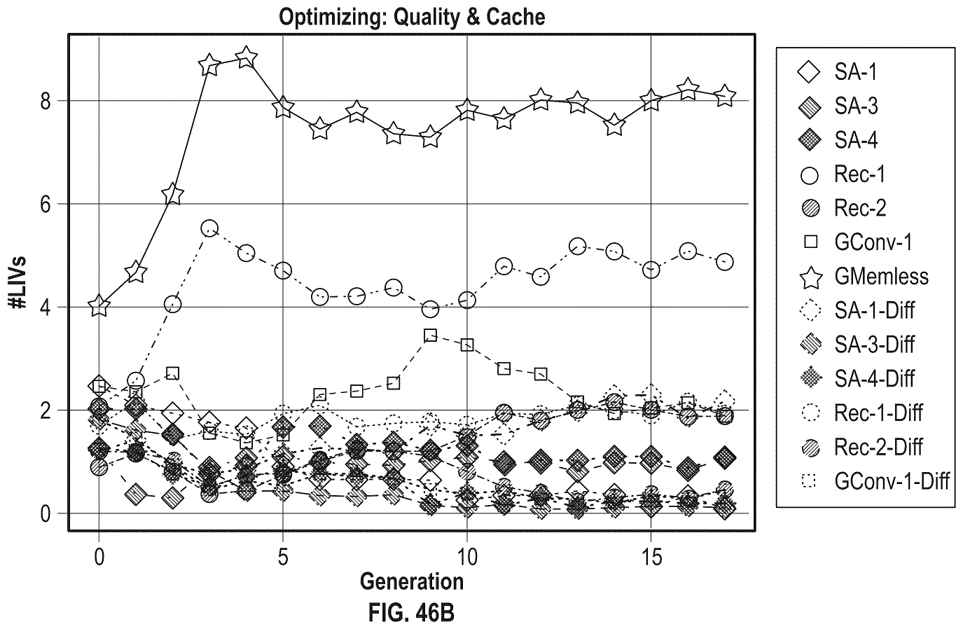

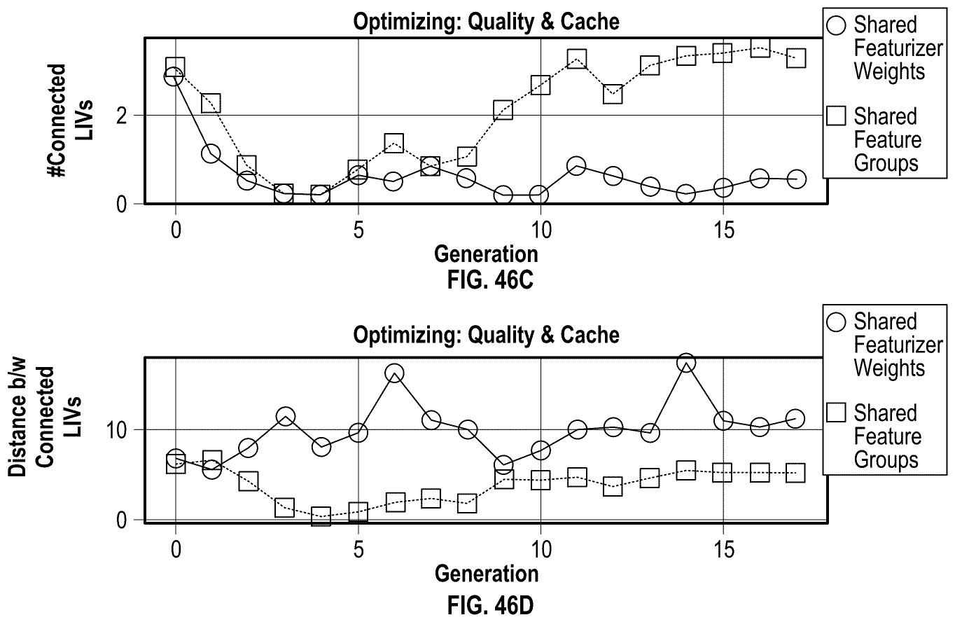

The following figures illustrate overviews of the average count at which each LIV type occurs in a population over the course of evolutionary algorithm technique optimization, the average count of LIVs that share featurizer weights or groups, and the average distance between LIVs sharing featurizer weights or feature groups. Distance may be indicated by the number of LIVs between two LIVs connected through featurizer or feature group sharing. FIGS. 45A-45D illustrate direct quality optimization, and FIGS. 46A-46D illustrate quality and cache optimization. Specifically, FIG. 45A illustrates number of parameters versus generation, FIG. 45B illustrates number of LIVs versus generation, FIG. 45C illustrates number of connected LIVs versus generation, and FIG. 45D illustrates distance between connected LIVs versus generation. FIG. 46A illustrates cache versus generation, FIG. 46B illustrates number of LIVs versus generation, FIG. 46C illustrates number of connected LIVs versus generation, and FIG. 46D illustrates distance between connected LIVs versus generation.

The evolutionary algorithm techniques described herein can evolve populations of architectures to optimize their quality (e.g., perplexity, accuracy, downstream performance), size (e.g., number of parameters), and/or efficiency (e.g., inference cache). The evolutionary algorithm techniques described herein leverage the flexibility of the LIV design space, which enables constructing computational units tailored to these various optimization objectives. The evolutionary algorithm techniques described herein may leverage evolutionary optimization methods to search the design space and converge on the solutions performing best under the given set of objectives.

For example, the evolutionary algorithm techniques described herein may reduce parameter counts by identifying which LIVs can be connected through featurizer or feature group sharing, without degrading performance. Likewise, the evolutionary algorithm techniques described herein can reduce parameter counts by purposefully placing MLPs (multilayer perceptron) only at those positions of the backbone (such as observed in FIGS. 29, 30, 31, and 32), instead of at every other depth index as is otherwise common.

The evolutionary algorithm techniques described herein can reduce cache size by deliberately placing LIVs with large cache sizes in the backbone and connecting these through featurizer or feature group sharing, while increasing the overall amount of MLPs in the backbone (such as observed in FIGS. 46A-46D, 37, and 43).

When optimizing solely for quality, a notable pattern is that the first LIV in the model may be a variant of softmax attention (SA), connected via feature group sharing to other SA-LIVs positioned toward the end of the model (see FIGS. 21, 23, 25, and 27).

Softmax attention and memoryless LIVs are foundational to the Transformer architecture. When optimizing for quality, the evolutionary algorithm techniques described herein may favor these LIV classes (see FIGS. 45A-45D). Their performance may be further enhanced by strategically placing recurrences and differential variants of short-gated convolutions (FIGS. 21, 24, and 25).

Backbones optimized for quality may often include two differential variants of short-gated convolutions connected through featurizer sharing (such as illustrated in FIGS. 22, 24, 25, 26, and 28).

Backbones synthesized by the evolutionary algorithm techniques described herein for both quality and size may exhibit significantly fewer LIVs connected through featurizer and feature group sharing compared to those optimized for quality alone (compare FIGS. 45A-45D and 11A-11D).

A recurring motif from the evolutionary process involves LIVs with a block-Toeplitz token-mixing structure (e.g., convolutions, gated convolutions). In these cases, earlier LIVs in the model may be connected through feature group sharing to later LIVs (see FIGS. 32 and 42).

### Method

Described herein are systems, methods, and non-transitory computer-readable storage media for generating AI models using the evolutionary techniques described herein. In some embodiments, as described herein, the evolutionary algorithm techniques may involve generating hierarchical numerical representations of AI models and refining the hierarchical numerical representations with evolutionary algorithms that may involve evaluation, recombination, and mutation. For instance, the evolutionary algorithm techniques described herein may encode characteristics of backbones, operator structures (e.g., grounded in LIVs), and featurizations of AI models as one or more numerical strings organized in a backbone hierarchical level, an operator structure hierarchical level, and a featurization hierarchical level, respectively (see FIG. 1), for each represented AI model. Each AI model may be assessed by scoring each AI model based on criteria like cache size, number of trainable parameters, or predictive accuracy (see FIG. 2B). Based on the scoring, hierarchical numerical representations of pairs of AI models may be combined to form offspring hierarchical numerical representations (see FIGS. 2A and 2B). The offspring hierarchical numerical representations may then be used to generate AI models (which may be referred to as offspring AI models) that may be a higher-performing AI models compared to their parent AI models.

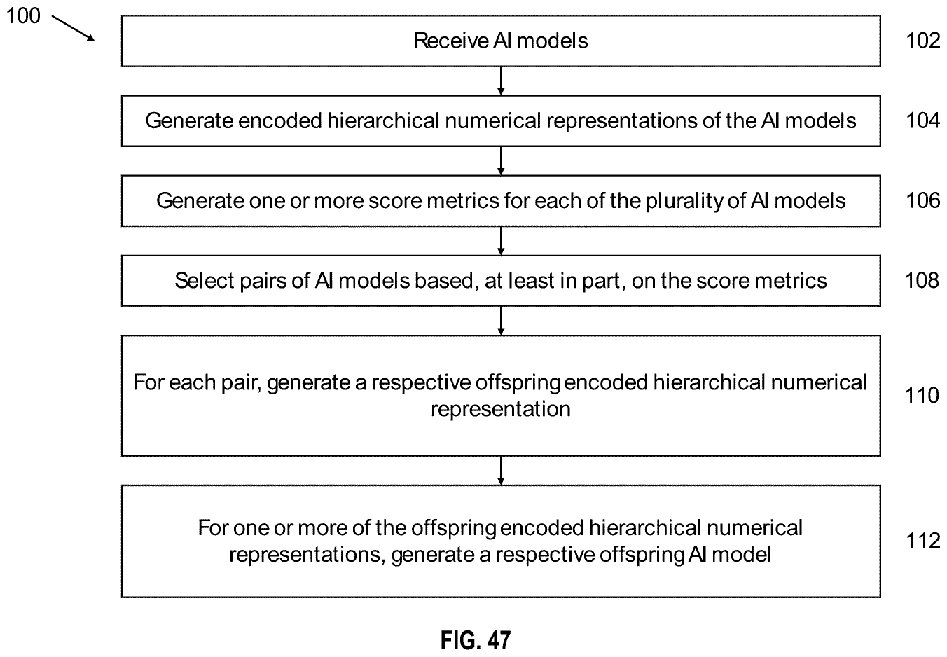

FIG. 47 illustrates an exemplary method 100 for generating AI models. Method 100 is performed, for example, using one or more electronic devices implementing a software platform. In some examples, method 100 is performed using a client-server system, and the steps of process 100 are divided up in any manner between the server and one or more client devices. In other examples, method 100 is performed using only a client device or only multiple client devices. In some embodiments, method 100 may be performed by a system comprising an AI model data store, a processing engine, and a numerical representation data store. The AI model data store and the numerical representation data store may each be any suitable data storage device and/or system (e.g., hard drive, database, etc.), and may each be communicatively coupled to the processing engine and configured to send and receive data to and from the processing engine. The AI model data store may be configured to store one or more AI models, and the numerical representation data store may be configured to store one or more hierarchical numerical representations of said AI models. (In some embodiments, the AI model data store and the numerical representation data store may be provided as a single combined data store.) Processing engine 100 may be configured to execute all or part of method 100 (and/or other methods described herein), including for example by receiving AI models from the AI model data store, generating hierarchical numerical representations of the AI models based, transmitting the hierarchical numerical representations of the AI models to the numerical representation data store for storage, receiving hierarchical numerical representations of the AI models from the numerical representation data store for analysis, executing analysis (e.g., scoring) of the AI models and/or numerical representations, executing evolution of the AI models and/or numerical representations, generating new and/or updated populations of AI models and/or numerical representations during an iterative evolution process, assessing (e.g., scoring) newly generated offspring numerical representations and/or AI models, and/or generating and/or outputting offspring AI models that have been generated (e.g., optimized) through the evolutionary processes explained herein.

In method 100, some steps may optionally be combined, and/or the order of some steps may be optionally changed, and/or one or more steps may be optionally omitted. In some examples, one or more additional steps may be performed in combination with the method 100. Accordingly, the operations as illustrated (and described in greater detail below) are exemplary by nature and, as such, should not be viewed as limiting.

At block 102, an exemplary system (e.g., one or more electronic devices) may receive a plurality of AI models. In some embodiments, the AI models may be received from an AI model data store. The AI models may be received from a user (e.g., individual, company, industry, etc.). For instance, the user may upload the AI models to a graphical user interface of the system. Alternatively, or additionally, the AI models may be received from a database of AI models that is internally (e.g., a database internally hosted by the system) or externally hosted (e.g., a database hosted by a cloud computing platform or other database storage system). For instance, the user may select one or more AI models, using the graphical user interface of the system, from a database of AI models. The system may transmit the selections to the database via a network (e.g., via any combination of wired or wireless protocols or interfaces, such as an application programming interface (API)), and the database may transmit the selected AI models to the system. The AI models may be any AI models representing or otherwise using model architectures that a user (e.g., individual, company, industry, etc.) wants to assess and/or improve, such as to improve the quality or efficiency of the model architecture. The AI models may be off-the-shelf AI models. Alternatively, or additionally, the AI models may be models that are customized, or otherwise specialized (e.g., specialized for performing specific tasks).

At block 104, the exemplary system may encode the AI models to generate a population of encoded hierarchical numerical representations of the AI models (see, e.g., FIGS. 2A and 2B). Each encoded hierarchical numerical representation may encode computational units of a respective AI model as LIVs across one or more hierarchical levels, in which each hierarchical level represents aspects of the respective AI model (e.g., by encoding as a three-tier hierarchical genome, such as described herein). For instance, an AI model may be encoded as LIVs across a backbone hierarchical level, an operator structure hierarchical level, and a featurization hierarchical level (see, e.g., FIG. 1).

The backbone hierarchical level may include a numerical string that encodes characteristics of a backbone of an AI model (see, e.g., FIG. 1). For instance, the backbone hierarchical level may encode compositions of LIVs in a backbone of an AI model via a plurality of sequences of numbers within the numerical string. Each sequence of numbers may correspond to an LIV in the backbone of the AI model. For instance, such as described herein, one or more of the sequences of numbers may include five integers, in which a first integer summarizes an LIV class, a second integer summarizes a weight-sharing structure of the LIV's featurizers, a third integer summarizes a strategy for sharing featurizer weights, a fourth integer summarizes feature group sharing structure of the LIV, and a fifth integer summarizes a strategy used for sharing feature groups.

The operator structure hierarchical level may include one or more numerical strings that encode characteristics of one or more operators of an AI model (see, e.g., FIG. 1). For instance, the operator structure hierarchical level may encode properties of an AI model, properties of an LIV of an AI model, and/or properties of an operator of an AI model. For instance, such as described herein, one or more of the numerical strings of the operator structure hierarchical level may include five integers, in which a first integer summarizes a featurizer class of an LIV, a second integer summarizes a linear token-mixing structure of an LIV, a third integer summarizes any structured sparsity masks applied to the token-mixing structure, a fourth integer summarizes any final nonlinearity applied to the token-mixing structure, and a fifth integer summarizes LIV channel mixing structure. At least a portion of each numerical string of the operator structure hierarchical level may correspond to a single number in the numerical string of the backbone hierarchical level. For instance, each numerical string of the operator structure hierarchical level may correspond to the first integer of each sequence of numbers within the numerical string of the backbone hierarchical level.

The featurization hierarchical level may include one or more numerical strings that encode characteristics of one or more of an AI model, such as one or more characteristics of a one or more featurizers of an AI model. For instance, such as described herein, one or more of the numerical string of the featurization hierarchical level may include six integers, in which a first integer summarizes a linear token-mixing structure of an LIV, a second integer summarizes any structured sparsity masks applied to the token-mixing structure, a third integer summarizes any final nonlinearity applied to the token-mixing structure, a fourth integer summarizes LIV channel mixing structure, a fifth integer summarizes an expansion factor of feature group channel dimension over input channel dimension, and a sixth integer summarizes a repeat factor for how many times feature groups are replicated across the channel dimension. At least a portion of each numerical string of the featurization hierarchical level may correspond to a single number in the numerical strings of the operator structure hierarchical level. For instance, each numerical string of the featurization hierarchical level may correspond to the first integer of each numerical string of the operator structure hierarchical level.

The population of encoded hierarchical numerical representations may be stored on a memory of the system (e.g., database of the system) or an external database. For instance, the system may transmit the population of encoded hierarchical numerical representations to the external database via the network. The population of encoded hierarchical numerical representations may be stored on an external database to conserve computing resources of the system. In some examples, a portion of the population of encoded hierarchical numerical representations may be stored on the external database. In some embodiments, the population of encoded hierarchical numerical representations may be generated in full by the system, received in full by the system, or partially generated by the system and partially received by the system.

At block 106, the exemplary system may score (e.g., assess) one or more of the AI models to generate one or more respective score metrics (see, e.g., FIGS. 2A and 2B). For instance, the system may score each AI model against objective functions of interest by training an AI model and assessing its performance, or via a static analysis for efficiency objectives (e.g., number of trainable parameters in an AI model), such as described herein. In some embodiments, for example as described herein, the score metrics may include a total number of trainable parameters (with or without embeddings), cache size, predictive accuracy, or any combination thereof. The system may generate the score metrics for each AI model. In some embodiments, the score metrics may be stored by the system in the AI model data store, the numerical representations data store, and/or in a different data store. In some embodiments, the score metric(s) may be generated by testing and/or assessing the AI model itself; in some embodiments, the score metric(s) may be generated by testing and/or assessing the associated encoded hierarchical numerical representation; in some embodiments, both techniques may be applied. Phrases such as generating a score metric “for the AI model” or “scoring the AI model” may refer to either or both techniques.

At block 108, the exemplary system may select pairs of AI models from the AI models received at block 102 that may be used to generate the next generation of encoded hierarchical numerical representations (offspring encoded hierarchical numerical representations) and the next generation of associated AI models (offspring AI models) (see, e.g., FIGS. 2A and 2B). The system may select the pairs of AI models, at least in part, based on the score metrics for the AI models. For instance, such as described herein, the system may select the pairs of AI models with tournament selection, in which the system randomly samples a portion of the AI models and selects an AI model from the portion of the AI models with the best score metrics (e.g., such as the highest-performing AI model from the portion of the AI models). Tournament selection may continue until the system selects two AI models, and the selected AI models may be a pair of AI models that may be used to generate an offspring AI model for the next generation of AI models.

At block 110, the exemplary system may, for each pair of the selected pairs of AI models, generate an offspring encoded hierarchical numerical representation from the encoded hierarchical numerical representations of each AI model in the respective pair (see, e.g., FIGS. 2A and 2B). The system may generate the offspring encoded hierarchical numerical representation by combining numerical information from the encoded hierarchical numerical representations of each AI model in a pair of AI models. For example, as described herein, combining numerical information may include applying k-point crossover, in which numerical information from k randomly chosen positions of the encoded hierarchical numerical representations of each AI model is combined to form the offspring encoded hierarchical numerical representation (see, e.g., FIG. 2A and FIG. 2B). In other examples, combining numerical information may include applying any known method for combining the numerical information from the encoded hierarchical numerical representations of each AI model in the pair of AI models.

At block 112, the exemplary system may, for one or more of the offspring encoded hierarchical representations, generate an offspring AI model based on the offspring encoded hierarchical numerical representation. For instance, the system may generate the offspring AI model by de-encoding the offspring encoded hierarchical numerical representation, such as by de-encoding each offspring hierarchical level of the offspring encoded hierarchical numerical representation. De-encoding the offspring hierarchical levels may include comparing each integer within the offspring hierarchical levels with an associated predefined set of integers to determine what model characteristics, structures, or parameters an integer value corresponds to, such as which characteristic of a backbone of an offspring AI model, one or more operators of an offspring AI model, or one or more featurizers of an offspring AI model. The system may then generate the offspring AI model to be in accordance with the characteristics determined by de-encoding the hierarchical levels.

Each integer position within the offspring hierarchical levels may be associated with a predefined set of integer values, such that the integer values in each position of the integer sets may each summarize different characteristics of an offspring AI model. For instance, a first integer (the integer in the first position of a set) of a numerical string of a backbone hierarchical level of the offspring hierarchical numerical representation may be associated with a predefined set of integer values that respectively indicate possible LIV classes, while a second integer (the integer in the second position of the set) of a numerical string of a backbone hierarchical level of the offspring hierarchical numerical representation may be associated with a predefined set of integer values that respectively indicate possible weight-sharing structures. In this manner, each integer position of the numerical strings of the hierarchical levels may correspond to its own predefined set of available integer values with associated respective meanings for the values that may vary between different integer positions and different hierarchical levels.

In some examples, method 100 may be repeated for iterations N, where N>1. Each iteration may be referred to as a generation. As such, method 100 may be used to evolve the received AI models into multiple generations of offspring AI models.

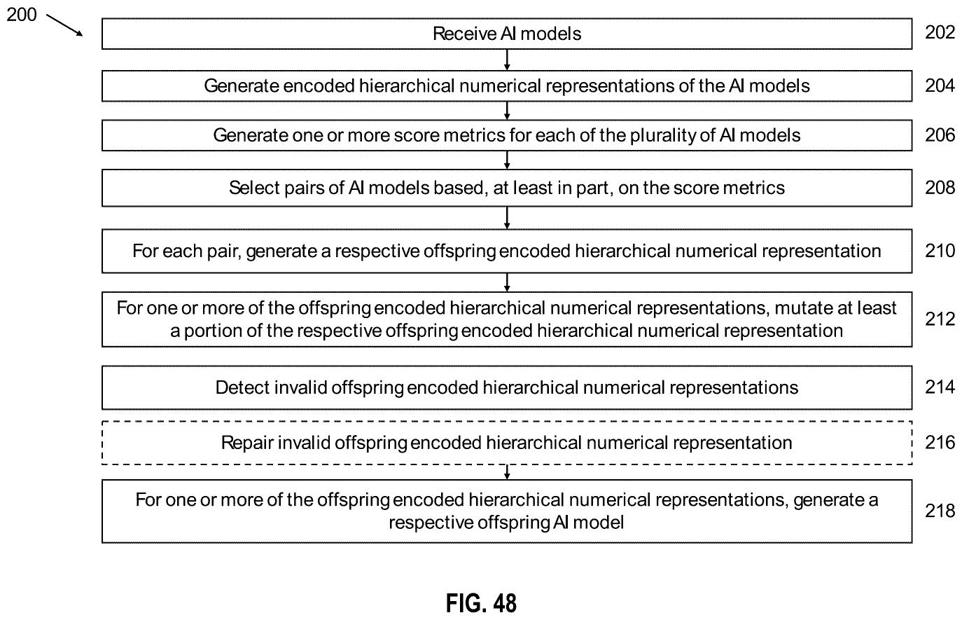

In some examples, the offspring encoded hierarchical numerical representations may be mutated in a manner configured to maintain and/or cultivate diversity while suppressing or removing errors in the evolving population of offspring AI models and associated offspring encoded hierarchical numerical representations. In some embodiments, techniques for random mutating of offspring encoded hierarchical numerical representations may be applied to help maintain and cultivate diversity in offspring populations. In some embodiments, detecting and/or repairing errors in generated offspring may help to ensure that offspring populations are error free and that valid and functional offspring AI models are generated. FIG. 48 illustrates an exemplary method 200 for generating offspring AI models based on randomly mutating at least a portion of offspring encoded hierarchical numerical representations and based on detecting and/or repairing invalid offspring. Method 200 may be performed by the same or similar system(s) above as referenced above with respect to method 100, and method 200 may share any one or more steps and/or characteristics in common, in whole or in part, with method 200. Corresponding (e.g., similarly numbered) steps of method 200 may share some or all characteristics in common with the respective steps of method 100. In some embodiments, method 200 differs from method 100 in that method 200 may include steps for detecting and/or repairing invalid generated offspring.

Blocks 202-210 of method 200 may share any one or more characteristics in common with blocks 102-110 of method 100.

At block 212, the exemplary system may, for one or more of the offspring encoded hierarchical numerical representations generated upstream in the method, mutate (e.g., randomly mutate) at least a portion of the respective offspring encoded hierarchical numerical representation. The system may mutate an offspring encoded hierarchical numerical representation by randomly replacing at least one integer value within the offspring encoded hierarchical numerical representation with another integer value. The replacement integer value may be selected from a predefined set of available integer values. As described herein, different integer positions within hierarchical genomic encodings of AI models may be associated with their own predefined set of integers values, each value having a specific associated meaning for that value at that integer position at that level of the genomic encoding. As such, the system may mutate the offspring encoded hierarchical numerical representation by randomly replacing an integer value within the offspring encoded hierarchical numerical representation with an integer value selected from the predefined set of values corresponding to the integer position of the integer value being replaced.

At block 214, the exemplary system may detect invalid offspring encoded hierarchical numerical representations (see, e.g., FIG. 2A). An invalid offspring encoded hierarchical numerical representation may, for example, include at least one integer value within the offspring encoded hierarchical numerical representation that is an incorrect or invalid value, either due to rules governing valid values at certain positions and hierarchy levels of the encoding, and/or due to rules governing valid and invalid combinations of multiple different values being simultaneously present at different positions of the same encoding. Rules governing valid and invalid integer values may protect against the generation of offspring AI model, associated with said invalid offspring encoded hierarchical numerical representations, that would not be possible to validly build or execute. For example, attempting to unencode an invalid offspring numerical representation and to thereby generate an associated offspring AI model might not be possible, or might result in an offspring AI model that does not function correctly or that does not generate valid results (or results that satisfy certain predefined criteria). The system may detect whether the offspring encoded hierarchical numerical representations generated at block 210 or mutated at block 212 are invalid offspring encoded hierarchical numerical representations. For instance, the exemplary system may assess each offspring encoded hierarchical numerical representation after generation at block 210 and/or mutation at block 212 to determine whether each offspring encoded hierarchical numerical representation is an invalid offspring encoded hierarchical numerical representation, including applying one or more predefined tests or rulesets to the numerical representations. (While the disclosure herein contemplates detecting invalid offspring numerical representations, the system may, in some embodiments, directly detect invalid offspring AI models after the offspring AI models themselves are generated.)

At block 216, the exemplary system may repair invalid offspring encoded hierarchical numerical representations if invalid offspring encoded hierarchical numerical representations were detected at block 214 (see FIG. 2A). In some embodiments, the system may repair the offspring encoded hierarchical numerical representation by randomly re-sampling from a predefined set of integers corresponding to the position of the invalid integer within the offspring encoded hierarchical numerical representation. In some embodiments, the system may repair the offspring encoded hierarchical numerical representation by randomly selecting one or more mutated integer positions and reverting the most recent mutation at those positions. In some embodiments, rather than repairing an invalid offspring numerical representation, the system may simply remove the invalid offspring representation from the evolving population. In some embodiments, if the offspring representation (or associated offspring model) meets a first set of criteria, then repair may be applied, while if the offspring representation (or associated offspring model) meets a second set of criteria, then deletion may be applied.

At block 218, the exemplary system may, following optional mutation, detection, repair, and/or deletion, generate an offspring AI model based on the offspring encoded hierarchical numerical representation, such as described at block 112 of method 100 of FIG. 47.

### Computer

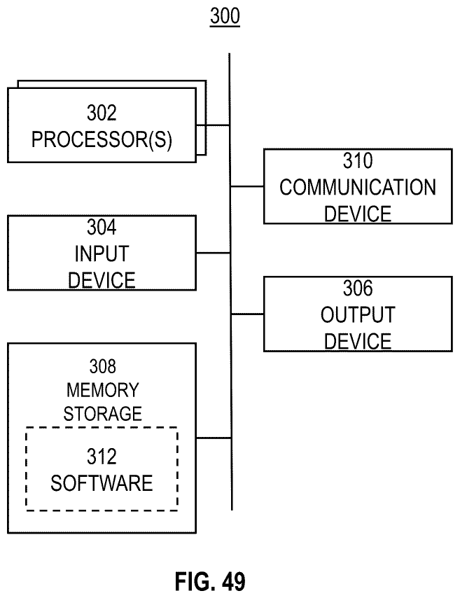

FIG. 49 illustrates an example of a computing system 300 that may be used for any one of the computing systems and devices described herein, such as the exemplary system performing method 100 of FIG. 47 or performing method 200 of FIG. 48. System 300 can be a computer connected to a network. System 300 can be a client computer, a server, a router, a hub, an access point, or any other computing device that can send and/or receive wireless signals or non-wireless signals. As shown in FIG. 4, system 300 can be any suitable type of microprocessor-based system, such as a personal computer, workstation, server, or handheld computing device (portable electronic device) such as a phone or tablet. The system can include, for example, one or more of a processor 310, input device 320, output device 330, storage 340, and communication device 360. Input device 320 and output device 330 can generally correspond to those described above and can either be connectable or integrated with the computer.

Input device 320 can be any suitable device that provides input, such as a touch screen, keyboard or keypad, mouse, gesture recognition component of a virtual/augmented reality system, or voice recognition device. Output device 330 can be or include any suitable device that provides output, such as a touch screen, haptics device, virtual/augmented reality display, or speaker.

Storage 340 can be any suitable device that provides storage, such as an electrical, magnetic, or optical memory, including a RAM, cache, hard drive, removable storage disk, or other non-transitory computer-readable medium. Communication device 360 can include any suitable device capable of transmitting and receiving signals over a network, such as a network interface chip or device. The components of the computer can be connected in any suitable manner, such as via a physical bus or wirelessly.

Software 350, which can be stored in storage 340 and executed by processor 310, can include, for example, the programming that embodies the functionality of the present disclosure (e.g., as embodied in the devices as described above). For example, software 350 can include one or more programs for performing one or more of the blocks of method 100 of FIG. 47 or performing one or more blocks of method 200 of FIG. 48.

Software 350 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 340, that can contain or store programming for use by or in connection with an instruction execution system, apparatus, or device.

Software 350 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

System 300 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 300 can implement any operating system suitable for operating on the network. Software 350 can be written in any suitable programming language, such as C, C++, Java, or Python. In various aspects, application software embodying the functionality of the present disclosure can be deployed in different configurations, such as in a client/server arrangement or through a Web browser as a Web-based application or Web service, for example.

While the disclosure herein refers to numerical encodings, alphanumerical and/or other symbolic encodings may also be used in combination or in place of numerical encodings.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for generating artificial intelligence (AI) models, the method performed by a system comprising one or more processors and memory storing instructions comprising instructions for performing the method, the method comprising:
receiving a plurality of AI models;
encoding the plurality of AI models to generate a population of respective encoded hierarchical numerical representations of the AI models, wherein each of the plurality of respective encoded hierarchical numerical representations encodes computational units of the respective AI model as linear input-varying systems (LIVs) across a backbone hierarchical level, an operator structure hierarchical level, and a featurization hierarchical level;
scoring each of the plurality of AI models to generate one or more respective score metrics for each of the plurality of AI models;
selecting a plurality of pairs of AI models from the received plurality of AI models, wherein the selection is based at least in part on the score metrics;
for each pair of the plurality of selected pairs of AI models, generating a respective offspring encoded hierarchical numerical representation, by combining numerical information from the encoded hierarchical numerical representations for each AI model in the respective pair; and
for one or more of the offspring encoded hierarchical numerical representations, generating a respective offspring AI model based on the offspring encoded hierarchical numerical representation.

2. The method of claim 1, wherein, for each AI model in the plurality of AI models:
the backbone hierarchical level of the respective hierarchical numerical representation comprises a numerical string that encodes characteristics of a backbone of the AI model;
the operator structure hierarchical level of the respective hierarchical numerical representation comprises a numerical string that encodes characteristics of one or more operators of the AI model; and
the featurization hierarchical level of the respective hierarchical numerical representation comprises a numerical string that encode characteristics of one or more featurizers of the AI model.

3. The method of claim 2, wherein some or all of the numerical string of the operator structure hierarchical level corresponds to a single number in the numerical string of the backbone hierarchical level.

4. The method of claim 2, wherein some or all of the numerical string of the featurization hierarchical level corresponds to a single number in the numerical string of the operator structure hierarchical level.

5. The method of claim 2, wherein the numerical string of the backbone hierarchical level comprises at least one sequence of numbers, wherein the sequence corresponds to an LIV of the backbone of the AI model.

6. The method of claim 2, wherein the backbone hierarchical level comprises one or more numerical sequences that encode information about the AI model using:
at a first position, an integer value representing LIV class information;
at a second position, an integer value representing featurizer sharing information;
at a third position, an integer value representing a featurizer sharing strategy;
at a fourth position, an integer value representing feature group sharing information; and
at a fifth position, an integer value representing a feature group sharing strategy.

7. The method of claim 2, wherein the operator structure hierarchical level comprises one or more numerical sequences that encode characteristic of an operator of the one or more operators using:
at a first position, an integer value representing a featurizer class;
at a second position, an integer value representing a linear token mixing structure;
at a third position, an integer value representing structured sparsity mask information;
at a fourth position, an integer value representing optional nonlinearity applied during linear token mixing; and
at a fifth position, an integer value representing a channel mixing structure.

8. The method of claim 2, wherein the featurizer hierarchical level comprises one or more numerical sequences that encode information about a featurizer of the one or more featurizers using:
at a first position, an integer value representing a linear token mixing structure;
at a second position, an integer value representing structured sparsity mask information;
at a third position, an integer value representing optional nonlinearity applied during linear token mixing;
at a fourth position, an integer value representing a channel mixing structure;
at a fifth position, an integer value representing expansion factor of the feature group channel dimension over the input channel dimension; and
at a sixth position, an integer value representing a repeat factor for how many times the feature groups are replicated across the channel dimension.

9. The method of claim 1, wherein the one or more score metrics comprise a total number of trainable parameters and/or a cache size.

10. The method of claim 1, wherein selecting the plurality of pairs of AI models from the received plurality of AI models comprises executing a tournament selection process.

11. The method of claim 1, wherein combining numerical information from encoded hierarchical numerical representations for each AI model in a pair of the selected pairs comprises applying k-point crossover to the encoded hierarchical numerical representations for each AI model in the pair.

12. The method of claim 1, further comprising, for one or more of the offspring encoded hierarchical numerical representations, mutating at least a portion of the respective offspring encoded hierarchical numerical representation, before generating the respective offspring AI model.

13. The method of claim 12, wherein the mutating comprises replacing at least one number of the respective offspring encoded hierarchical numerical representation with a number selected from a set of predefined numbers.

14. The method of claim 13, wherein the set of predefined numbers corresponds to a position of the at least one number within the respective offspring encoded hierarchical numerical representation.

15. The method of claim 1, further comprising:
detecting an invalid offspring encoded hierarchical numerical representation; and
repairing the invalid offspring encoded hierarchical numerical representation.

16. The method of claim 15, wherein repairing the invalid offspring encoded hierarchical numerical representation comprises re-sampling from a set of predefined numbers to change a number in the encoded hierarchical numerical representation.

17. The method of claim 15, wherein the invalid offspring encoded hierarchical numerical representation was generated by combining numerical information from the encoded hierarchical numerical representations for each AI model in the respective pair.

18. The method of claim 15, wherein the invalid offspring encoded hierarchical numerical representation was generated by mutating at least a portion of the respective offspring encoded hierarchical numerical representation.

19. A system for generating artificial intelligence (AI) models, the system comprising one or more processors and memory storing instructions comprising instructions which, when executed by the one or more processors of the system, cause the system to:
receive a plurality of AI models;
encode the plurality of AI models to generate a population of respective encoded hierarchical numerical representations of the AI models, wherein each of the plurality of respective encoded hierarchical numerical representations encodes computational units of the respective AI model as linear input-varying systems (LIVs) across a backbone hierarchical level, an operator structure hierarchical level, and a featurization hierarchical level;
score each of the plurality of AI models to generate one or more respective score metrics for each of the plurality of AI models;
select a plurality of pairs of AI models from the received plurality of AI models, wherein the selection is based at least in part on the score metrics;
for each pair of the plurality of selected pairs of AI models, generate a respective offspring encoded hierarchical numerical representation, by combining numerical information from the encoded hierarchical numerical representations for each AI model in the respective pair; and
for one or more of the offspring encoded hierarchical numerical representations, generate a respective offspring AI model based on the offspring encoded hierarchical numerical representation.

20. A non-transitory computer-readable storage medium storing instructions for generating artificial intelligence (AI) models, wherein the instructions, when executed by one or more processors of a system, cause the system to:
receive a plurality of AI models;
encode the plurality of AI models to generate a population of respective encoded hierarchical numerical representations of the AI models, wherein each of the plurality of respective encoded hierarchical numerical representations encodes computational units of the respective AI model as linear input-varying systems (LIVs) across a backbone hierarchical level, an operator structure hierarchical level, and a featurization hierarchical level;
score each of the plurality of AI models to generate one or more respective score metrics for each of the plurality of AI models;
select a plurality of pairs of AI models from the received plurality of AI models, wherein the selection is based at least in part on the score metrics;
for each pair of the plurality of selected pairs of AI models, generate a respective offspring encoded hierarchical numerical representation, by combining numerical information from the encoded hierarchical numerical representations for each AI model in the respective pair; and
for one or more of the offspring encoded hierarchical numerical representations, generate a respective offspring AI model based on the offspring encoded hierarchical numerical representation.
